(19) United States
(12) Patent Application Publication
(10) Pub. No.: US 2026/0080692 A1
(43) Pub. Date: Mar. 19, 2026

(54) MASK GENERATION FOR FEATURE DETECTION IN AUTONOMOUS AND SEMI-AUTONOMOUS SYSTEMS AND APPLICATIONS

(71) Applicant: NVIDIA Corporation, Santa Clara, CA (US)

(72) Inventors: Mohammad MAHDAVIAN, Coquitlam (CA); George CONG, Pleasanton, CA (US); Yu ZHANG, Cupertino, CA (US)

(21) Appl. No.: 19/176,758

(22) Filed: Apr. 11, 2025

Related U.S. Application Data
(60) Provisional application No. 63/696,671, filed on Sep. 19, 2024.

(51) Int. Cl. G06V 20/56; B60W 60/00; G06V 10/26; G06V 10/44

(52) U.S. Cl. CPC G06V 20/588; G06V 10/26; G06V 10/44; B60W 60/001; B60W 2420/403; B60W 2420/408

(57) ABSTRACT

In various examples, systems and methods are described that may be used to generate a mask of a geographic area and corresponding vector representations of one or more environmental features included in the area. In some embodiments, the method and system may generate or obtain a first tile image representing a portion of a path surface corresponding to a geographic area. One or more features may be extracted from the data where the extracted features may indicate environmental characteristics associated with the path surface—e.g., lane boundaries, medians, traffic signs, signals, etc. Additionally, the method or system may generate a mask corresponding to the tile image and vector representations of the portion of the geographic area. In some embodiments, the locations of the environmental features associated with the mask may be reconciled with one or more previously generated masks that include some of the same environmental features.

### CROSS-REFERENCE TO RELATED APPLICATIONS

This application claims the benefit of U.S. Provisional Application No. 63/696,671, filed on Sep. 19, 2024, the contents of which are hereby incorporated by reference in their entirety.

### BACKGROUND

Maps—such as high-definition (HD) maps, standard definition (SD) maps, etc.—play an important role in the functionality of systems (e.g., autonomous or semi-autonomous systems). Maps include data representations of an environment such as, for example, a geographic area. Further, maps generally focus on locations of specific areas or characteristics of interest.

In many instances, maps are generated using data captured or otherwise obtained using a variety of sensors, such as cameras, LiDAR, RADAR, and GPS to name a few. These sensors capture data associated with the environment, the captured data is processed to, among other things, extract features and create accurate map representations of the extracted data. In some instances, maps may provide a foundation for path planning, localization, and object detection, which may correspondingly allow systems to interpret their surroundings accurately and make informed decisions in real time or substantially real time.

In many instances, with respect to HD maps, HD maps are segmented into one or more subsections or tiles. Tiles typically include smaller, more manageable segments of the HD map, generated using a subset of the data used to generate the corresponding HD map. In some instances, a tile may represent a distinct portion of the larger HD map and is generated using various types of sensor data, such as images captured by cameras, LiDAR point clouds, RADAR measurements, among others. This segmentation enables the HD map to be updated or processed in parts which may improve computational efficiency and scalability in many instances. In addition, by breaking down the HD map into tiles, systems can focus on specific areas of interest or retrieve only data corresponding to the specific areas of interest which may correspondingly reduce memory and processing overheads.

In addition, HD maps are typically organized into one or more layers, with each layer representing specific types of information that make up the overall HD map. In some instances, these layers may be designed to provide an understanding of the environment, which may correspondingly aid the system in tasks such as localization, path planning, and decision-making.

One layer commonly included in the HD map is referred to as a top-down or bird's eye view (“BEV”) mask. A BEV mask represents the environment from a bird's-eye view perspective or a perspective that is orthogonal or substantially orthogonal to the plane generally corresponding to the “ground,” “road,” or the “floor” associated with the environment. In some instances, the BEV mask provides a detailed, top-down view of the environment and may highlight key features associated with the environment.

Historically, the generation of tile images and associated BEV masks relied heavily on perspective image data captured using image sensors, such as cameras mounted on autonomous or semi-autonomous vehicles. These cameras provide visual representations of the environment from the vehicle's point of view. The captured images are then processed to extract relevant features and characteristics of a particular environment and project those features and characteristics into a top-down view suitable for tiling and map construction. This approach has been favored due to the availability and affordability of camera systems associated with systems configured to perform localization operations.

However, reliance on perspective images for generating top-down tile representations and BEV masks introduces some challenges. For example, projecting perspective images into top-down views involves geometric transformations that can introduce uncertainties in the final representation. These uncertainties are often caused by inaccuracies in camera calibration, errors in depth estimation, and occlusions within the image data capturing the environment. As a result, the generated tiles may not accurately reflect the true spatial layout of the environment, leading to potential discrepancies in the HD map in general and in the corresponding BEV mask, in particular.

Another limitation of using perspective images is the propagation of errors and uncertainties across generated tile images. In some instances, as each tile is processed using perspective images, errors within a tile may affect the alignment or consistency with neighboring tiles which may amplify an overall uncertainty in the BEV masks. This cumulative effect may be particularly problematic in dynamic or complex environments where consistent accuracy is important. Furthermore, traditional methods typically lack mechanisms for self-correction, which means that once errors are introduced into the tile data, there is no inherent process to refine or validate the data for improved accuracy.

### SUMMARY

Embodiments of the present disclosure relate to mask generation for feature detection in autonomous and semi-autonomous systems and applications. According to one or more embodiments of the present disclosure, a system may be configured to perform one or more operations corresponding to generating top-down or BEV masks and associated vector predictions included in a representation of an environment. In some embodiments, the system may include one or more processors configured to perform one or more operations. In some embodiments, the operations may include generating a first tile image representing a first portion of a path surface. The first tile image may be generated based on aggregated path surface data representing a top-down view of the path surface. In some embodiments, the aggregated path surface data may be obtained based on sensor data associated with the path surface. In addition, in some embodiments, the operations may further include extracting one or more image features included in the first tile image, the one or more image features indicating one or more environmental features associated with the portion of the path surface. Further, the operations may include generating a first BEV mask based on the one or more image features and a second BEV mask generated based on a second tile image that may represent a second portion of the path surface including at least one of the one or more image features.

In contrast to conventional systems, the systems and methods of the present disclosure may help to increase accuracy and precision in generating predicted locations of environmental features included in a BEV mask. The approach uses top-down BEV images reconstructed from top-down LIDAR data and other sensor data instead of only using perspective camera images. Additionally, a robust memory mechanism may be implemented to refine and merge predictions across multiple BEV masks generated from corresponding tile images which may increase accuracy of environmental feature location predictions included in the BEV masks.

### BRIEF DESCRIPTION OF THE DRAWINGS

The present systems and methods for mask generation for feature detection in autonomous and semi-autonomous systems and applications are described in detail below with reference to the attached drawing figures, wherein:

FIG. 1 is a diagram representing an example environment related to generating an output that may include one or more masks and/or corresponding vector representations associated with a geographic area, in accordance with one or more embodiments of the present disclosure;

FIG. 2 is an example diagram representing portions of a path surface and one or more tile images that may represent the portions of the path surface, in accordance with one or more embodiments of the present disclosure;

FIG. 3 is a diagram representing an example environment related to generating a mask and corresponding vectors from a tile image, in accordance with one or more embodiments of the present disclosure;

FIG. 4 is a flow diagram showing a method for generating a mask and vector representations associated within a geographic area, in accordance with one or more embodiments of the present disclosure;

FIG. 5A is an example of sensor locations having corresponding fields of view or sensory fields for example autonomous or semi-autonomous machines, in accordance with at least some embodiments of the present disclosure;

FIG. 5B is an illustration of an example of component and sensor locations on an autonomous or semi-autonomous vehicle, in accordance with at least some embodiments of the present disclosure;

FIG. 5C is a block diagram of an example system architecture for an autonomous or semi-autonomous vehicle, robot, and/or other machine type, in accordance with at least some embodiments of the present disclosure;

FIG. 5D is a block diagram of an example architecture of a computing system—such as a system-on-a-chip (SoC)—in accordance with at least some embodiments of the present disclosure;

FIG. 5E is a system diagram for communication between cloud-based server(s) and an example autonomous or semi-autonomous vehicle, robot, and/or other machine type, in accordance with at least some embodiments of the present disclosure;

FIG. 6 is a system diagram illustrating a three computer ecosystem, including a computing system for generating or creating artificial intelligence (AI)—such as AI training and validation data, a computing system for training artificial intelligence, and a computing system deploying the AI at the edge, in accordance with at least some embodiments of the present disclosure;

FIG. 7 is a block diagram of an example computing system for generative artificial intelligence (AI), in accordance with at least some embodiments of the present disclosure; and

FIG. 8 is a block diagram of an example computing device, in accordance with at least some embodiments of the present disclosure.

### DETAILED DESCRIPTION

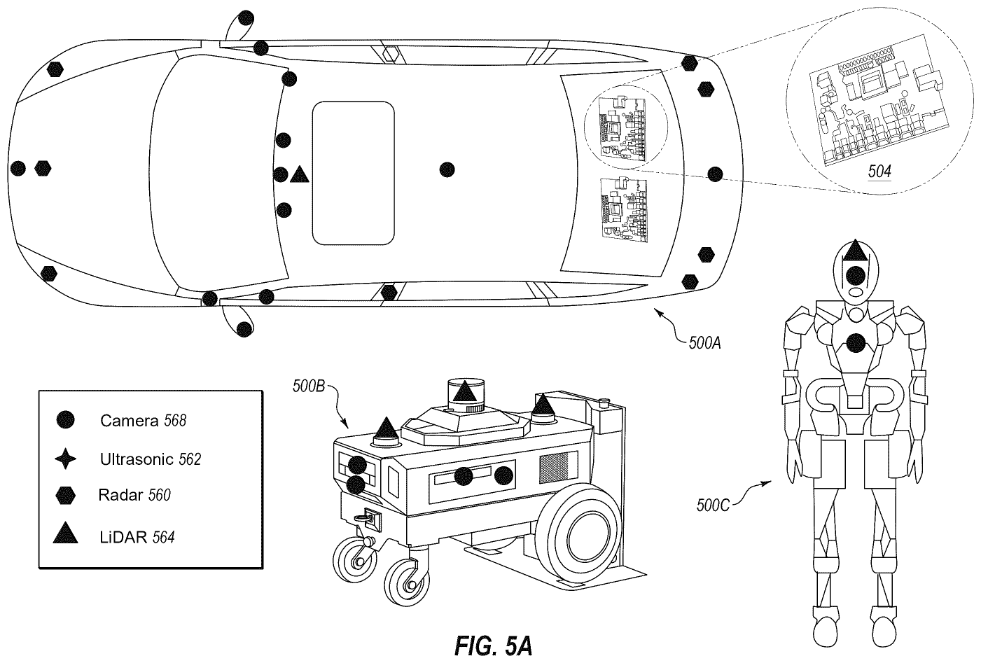

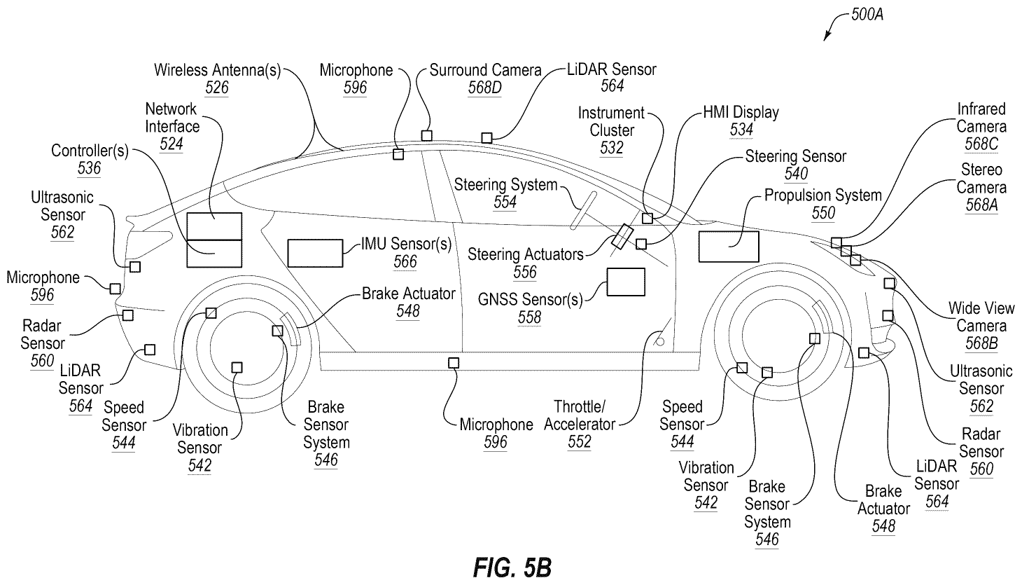

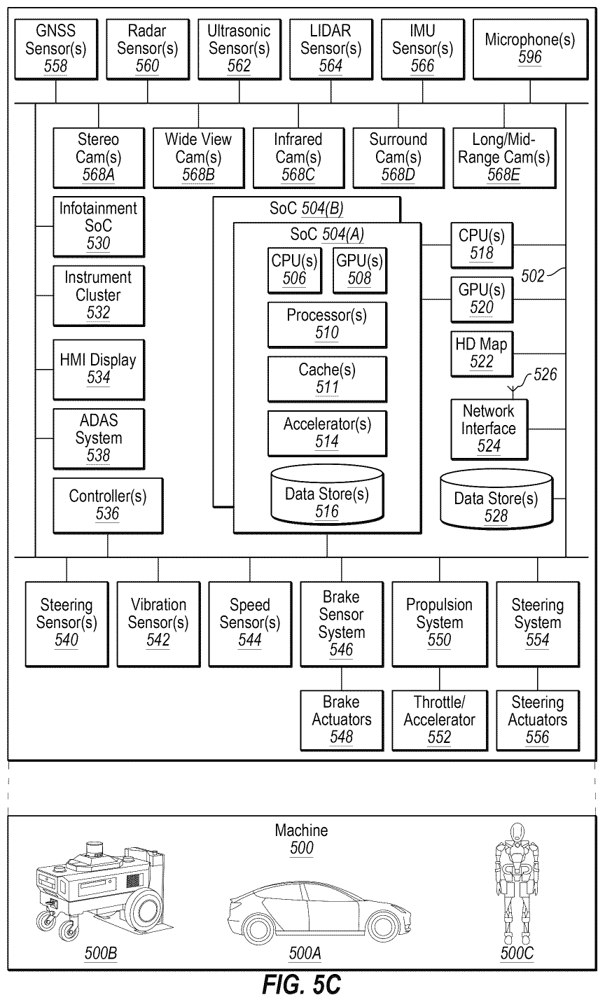

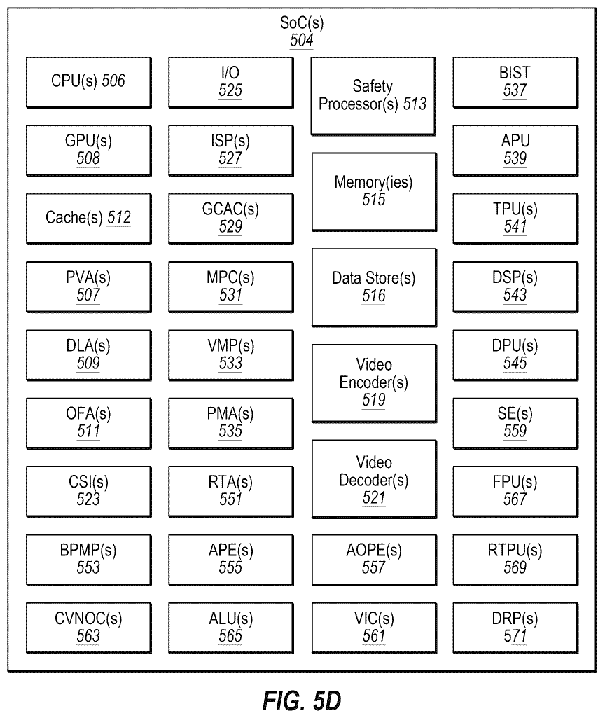

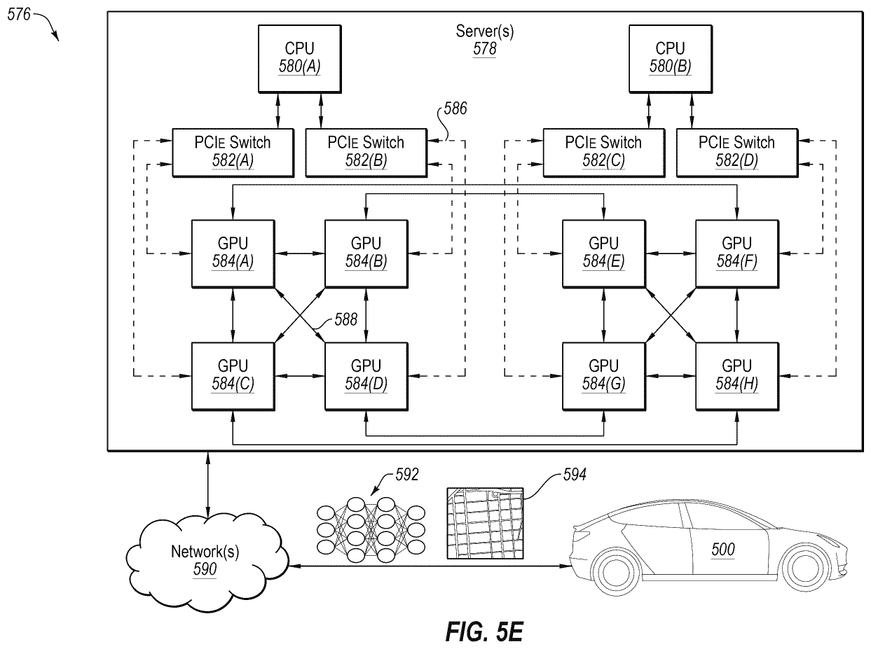

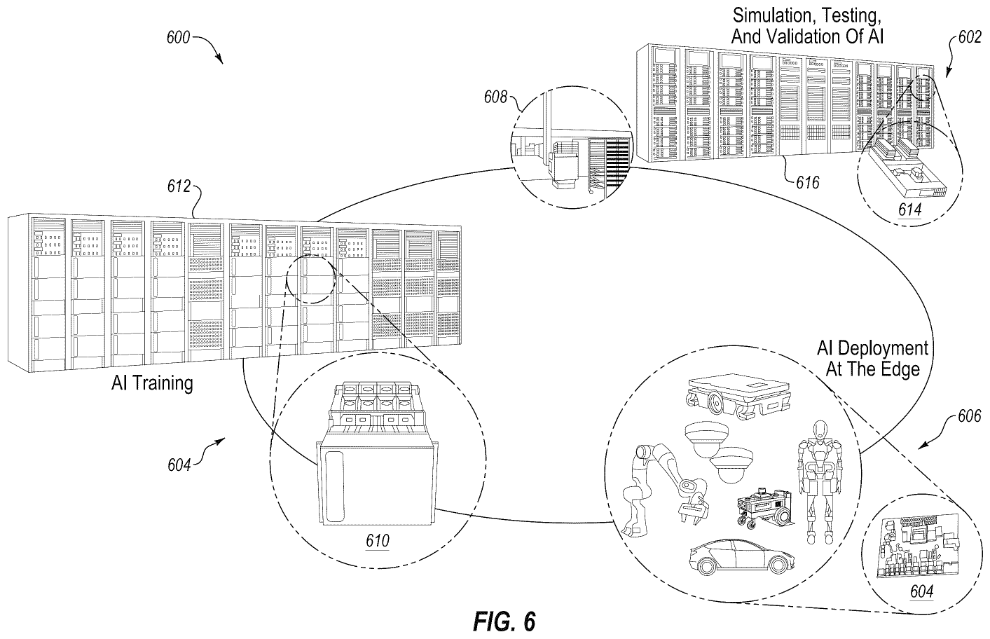

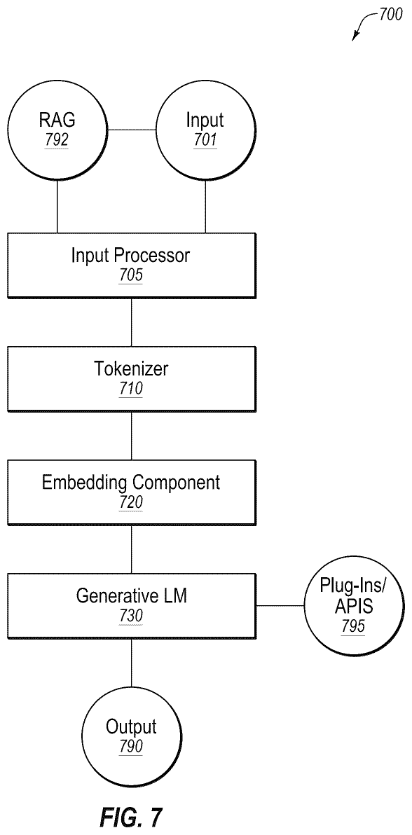

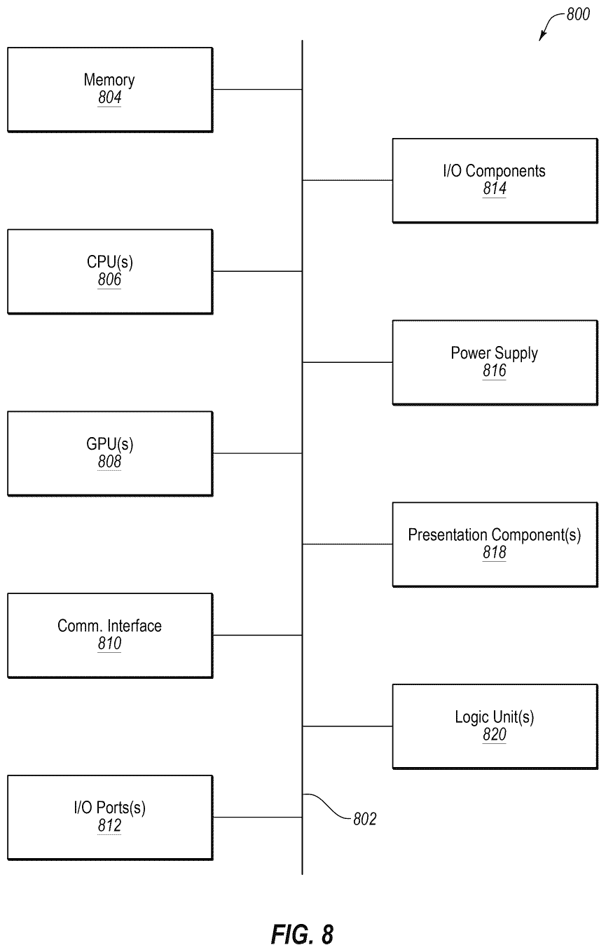

Systems and methods are disclosed related to mask generation for feature detection in autonomous and semi-autonomous systems and applications. Although the present disclosure may be described with respect to an example autonomous or semi-autonomous vehicle, robot, and/or other machine type 500 (alternatively referred to herein as “vehicle 500,” “ego-vehicle 500,” “machine 500,” “ego-machine 500,” “robot 500,” and/or “ego-robot 500,” an example of which is described with respect to FIGS. 5A-5E), this is not intended to be limiting. For example, the systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms (e.g., autonomous mobile robots (AMRs), humanoid robots, robotic arms and/or end-effectors, warehouse vehicles, off-road vehicles, vehicles coupled to one or more trailers, flying vessels, watercraft, shuttles (e.g., robotaxis), emergency response vehicles, motorcycles, electric or motorized bicycles, aircraft, construction vehicles, underwater craft (e.g., piloted or unpiloted submarines), drones, and/or other vehicle, robot, or machine types. In addition, although the present disclosure may be described with respect to generating masks and corresponding vector representations of environmental features included in a geographic area for autonomous or semi-autonomous systems, this is not intended to be limiting, and the systems and methods described herein may be used in augmented reality (AR), virtual reality (VR), mixed reality (MR), robotics, security and surveillance (e.g., smart cities), autonomous or semi-autonomous machine applications, industrial manufacturing, simulation, and/or any other technology spaces where HD mapping and localization may be used. In some embodiments, the systems, methods, and/or processes described herein may be executed using similar components, features, and/or functionality to those of example machine 500 of FIGS. 5A-5E, example computing ecosystem 600 of FIG. 6, example generative language model system 700 of FIG. 7, and/or example computing device 800 of FIG. 8.

One or more embodiments of the present disclosure may relate to methods for generating tile images and corresponding (e.g., BEV, top-down, orthogonally projected, etc.) masks associated with a map (e.g., HD map, SD map, navigation map, etc.) of an environment. In some embodiments, unlike conventional approaches that may transform sensor data from a perspective view to a top-down view of the environment, some embodiments disclosed herein may generate and/or collect sensor data directly from a top-down perspective. In some instances, such top-down sensor data may be collected using sensors that generate or collect data from a top-down perspective—e.g., data that indicates and/or represents one or more characteristics of the environment from above generally associated with the ground or the floor of the environment. In some instances, this direct capture of top-down data may reduce the computational overhead and inaccuracies that may be introduced during the transformation processes, resulting in a more precise and efficiently generated HD map, which may be generated based on data representing the environment including the top-down data.

In some embodiments, an operation in the creation of an HD map involves generating a BEV mask. In some instances, the BEV mask may be created using top-down data corresponding to a specific geographical environment or area. A subsection of this area may be selected and processed, which, in some instances, may be represented as a tile image. In some embodiments, the tile image may be labeled and pre-processed separately from any other tile images corresponding to the area. Additionally or alternatively, in some embodiments, one or more adjacent tile images corresponding to the area may include overlapping data. In some instances, the overlapping data may help to reduce potential inaccuracies in individual tile images by enhancing consistency in locations of environmental features such as lane boundaries, curbs, and obstacles that may span multiple tile images. Additionally or alternatively, overlapping data may decrease data gaps and noise by leveraging redundant information to verify or correct discrepancies between adjacent tile images.

In some embodiments, one or more image features may be extracted from individual tile images that may have been generated using the top-down data. In some embodiments, the one or more image features may indicate one or more corresponding environmental features associated with a portion of an area, environment, path surface, etc.

In some embodiments, one or more locations associated with environmental features may be predicted and/or otherwise determined. Environmental features may include boundaries like lane markers, curbs, medians, other signs, traffic lights, or other physical or visual indicators.

In some embodiments, one or more environmental feature locations may be determined, where the corresponding predicted locations may occur as instances of the environmental feature on the map. In some embodiments, the determined environmental feature location predictions may provide an initial estimate of where environmental features such as lane markings, road edges, or other environmental demarcations may be located within the scope of individual tiles as well as locations relative to a position of a machine located in the environment (e.g., an ego-machine).

In some embodiments, locations of environmental features may be determined in several overlapping tile images. Where environmental features may be the same between tile images, those locations may be fused or merged to provide a more accurate and consistent determination of their location. In some instances, environmental feature predictions in the identified overlapping regions may be compared to detect one or more discrepancies or inconsistencies between environmental feature location predictions between tile images. In some instances, one or more operations may be performed to reduce or reconcile the one or more discrepancies or inconsistencies between the environmental feature location predictions between adjacent tile images. In some embodiments, the fused results may provide smoother and more continuous predictions of environmental feature locations compared to using the individual tile predictions alone.

Embodiments of the present disclosure may help to increase accuracy and precision in generating predicted locations of environmental features included in tile images and/or in corresponding BEV masks. The approach uses top-down BEV images reconstructed using data collected from sensors positioned in a way that they may collect top-down data corresponding to the environment rather than collecting perspective camera images and transforming the perspective images into a top down BEV image. Additionally or alternatively, in some embodiments, a memory mechanism may be implemented to refine and merge predictions across sequential tile images to increase accuracy of environmental feature location predictions.

Traditional approaches typically include inconsistencies when predicting boundaries across different tiles. For example, one or more methods that rely solely on perspective camera images may introduce errors when reconstructing the BEV representation. Further, processing tile images independently without considering context associated with adjacent tile images may lead to additional inaccuracies. The present approach aims to address these issues by leveraging high-quality top-down BEV images and implementing a memory mechanism to maintain consistency across tile images. This may result in smoother, more precise boundary detections that align better with the underlying road structure.

In some embodiments, the systems and methods described herein may be performed within a simulation environment (e.g., NVIDIA's DriveSIM, NVIDIA's ISAAC GYM, NVIDIA's ISAAC SIM, etc.) using simulated data (e.g., simulated sensor data of simulated sensors of a virtual or simulated machine). For example, simulated sensor data may be used (e.g., processed using one or more machine learning models, neural networks, etc.) to identify, detect, and/or classify lane lines, road boundary lines, other lines, vertical structures/features, etc. within the simulation environment, and may use this information to perform operations (e.g., control, navigation, planning, etc. operations, map building operations, etc.) associated with the virtual machine within the environment. These simulated operations may be used to test performance of the underlying algorithms, systems, and/or processes prior to deploying them in the real-world. In some instances, the simulation may be used to generate synthetic training data—e.g., training data including regions of interest and/or sub-regions of interest from within the simulation. In some embodiments, other methods may be used in addition or alternatively from a simulation to generate synthetic training data. For example, the synthetic training data may be generated using neural rendering fields (NERFs), Gaussian splat techniques, diffusion models, electrostatic models (e.g., Poisson flow generative models (PFGMs), etc. The synthetic training data (in addition to or alternatively from real-world data) may then be processed to determine geometry, curvature, semantic information, classification information, and/or other information related to features of interest, such as lines, longitudinal features (e.g., poles), and/or other features within a driving environment, a warehouse, etc., for example. In any example, such as where a simulation environment is used for testing, validation, training, etc., the simulation environment and/or associated training data may be rendered or otherwise generated using one or more light transport algorithms—such as ray-tracing and/or path-tracing algorithms. In some embodiments, the simulation environment and/or one or more objects, features, or components thereof may be generated or managed within a three-dimensional (3D) content collaboration platform (e.g., NVIDIA's OMNIVERSE) for industrial digitalization, generative physical AI, and/or other use cases, applications, or services. For example, the content collaboration platform or system may include a system that uses universal scene descriptor (USD) (e.g., OpenUSD) data for managing objects, features, scenes, etc. within a simulated environment, digital environment, etc. The platform may include real physics simulation, such as using NVIDIA's PhysX SDK, in order to simulate real physics and physical interactions with simulations hosted by the platform. The platform may integrate OpenUSD along with ray tracing/path tracing/light transport simulation (e.g., NVIDIA's RTX rendering technologies) into software tools and simulation workflows for building, training, deploying, or testing AI systems—such as systems for testing, validating, training (e.g., machine learning models, neural networks, etc.), and/or other tasks related to automotive, robot, machine, or other applications.

In some embodiments, teleoperation or remote control of a vehicle or other machine may be performed using a remote control or teleoperation system. For example, the systems and methods described herein may be used to identify features and/or build maps using these features, etc., that may be included in a visualization or mapping of an environment to aid a remote operator in controlling—or providing waypoints or other indications of control or navigation—an autonomous or semi-autonomous machine through an environment.

In some examples, the machine learning model(s) (e.g., deep neural networks, language models, LLMs, VLMs, multi-modal language models, vision-language-action (VLA) models, perception models, tracking models, fusion models, transformer models, diffusion models, encoder-only models, decoder-only models, encoder-decoder models, neural rendering field (NERF) models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, watercraft, shuttles (e.g., robotaxis), emergency response vehicles, motorcycles, electric or motorized bicycles, aircraft, construction vehicles, underwater craft (e.g., piloted or unpiloted submarines), drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets (e.g., NVIDIA's Omniverse), cloud computing, and/or any other suitable applications.

In some embodiments, the system and methods described herein may be deployed in a robotics application. For example, a robot or robotic system may include one or more onboard processors (e.g., CPUs, GPUs, hardware-based deep learning accelerators (DLAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). The robotic system may use these processors to execute one or more machine learning models (e.g., language models, vision language models (VLMs), large language models (LLMs), vision-language-action (VLA) models, multi-modal language models (MMLMs), etc.) that allow it to perform complex tasks autonomously or semi-autonomously, such as interacting with and/or manipulating static and/or dynamic objects, or navigating environments using sensors such as cameras, LiDAR, RADAR, ultrasonic sensors, and more. The system may use sensor fusion techniques to combine data from multiple sensors (e.g., cameras, infrared, LiDAR, RADAR, accelerometers) to create a comprehensive model of the robot's surroundings. This data may be processed locally on the robot or sent to remote servers for more computationally intensive tasks, such as 3D mapping or SLAM (Simultaneous Localization and Mapping). In one or more embodiments, data from individual robots (e.g., sensor data, task status, or environmental conditions) may be uploaded to the cloud, where centralized AI models can analyze and distribute optimized commands to an entire fleet. In some embodiments, the machine learning model(s) (e.g., language models, VLMs, VLAS, LLMs, MMLMs, diffusion models, NeRF models, DNNs, etc.) described herein may be used to allow the robot to perceive and reason about the environment and/or communicate with one or more other robots and/or persons in an environment. In some embodiments, the robot may communicate (e.g., using one or more network interface cards (NICs) and/or data processing units (DPUs)) with one or more locally hosted servers/computing devices and/or with one or more remotely located servers/computing devices (e.g., in one or more data centers).

Although examples may be described herein with respect to using machine learning models, such as neural networks, this is not intended to be limiting. For example, and without limitation, any of the various machine learning models and/or neural networks described herein may include any type of machine learning model, such as a machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoder neural networks, artificial neural networks (ANNs), convolutional neural networks (CNNs), recurrent neural networks (RNNs), perceptrons, Long/Short Term Memory (LSTM) networks, multi-layer perceptron (MLP) networks, deep stacking networks (DSNs), generative pre-training (GPT) models or networks, feed forward networks, radial basis function ANNs, self-organizing maps (SOMs), Kohonen maps, Hopfield networks, Boltzmann machine, deep belief neural networks, deconvolutional neural networks, generative adversarial networks (GANs), liquid state machines, modular neural networks, liquid state machines, sequence-to-sequence models, networks using transformer architectures, state space models (SSMs) (e.g., networks using Mamba architectures (e.g., Mamba-1, Mamba 2, etc.), networks using selective state space models, networks using structured state space sequence models, etc.), diffusion models (e.g., diffusion probabilistic models, score-based generative models, etc.), neural radiance field (NeRF) models, Gaussian splat models, Kolmogorov-Arnold networks (KANs), models with encoder-only architectures, models with decoder-only architectures, models with encoder-decoder architectures, generative machine learning models, language models, large language models (LLMs), vision language models (VLMs), multi-modal language models (MMLMs), large action models (LAMs), vision-language-action (VLA) models, etc.), and/or other types of machine learning models.

Disclosed embodiments may be comprised in a variety of different systems such as automotive systems (e.g., a control system for an autonomous or semi-autonomous machine, a perception system for an autonomous or semi-autonomous machine, etc.), systems implemented using a robot, aerial systems, medial systems, boating systems, smart area monitoring systems, systems for performing deep learning operations, systems for performing simulation operations, systems for performing digital twin operations, systems implemented using an edge device, systems implementing language models—such as large language models (LLMs), vision language models (VLMs), vision-language-action (VLA) models, and/or multi-modal language models, systems using or deploying one or more inference microservices, systems that incorporate deploy one or more machine learning models in a service or microservice along with an OS-level virtualization package (e.g., a container), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

These and other embodiments of the present disclosure will be explained with reference to the accompanying figures. It is to be understood that the figures are diagrammatic and schematic representations of such example embodiments, and are not limiting, nor are they necessarily drawn to scale. In the figures, features with like numbers indicate like structure and function unless described otherwise.

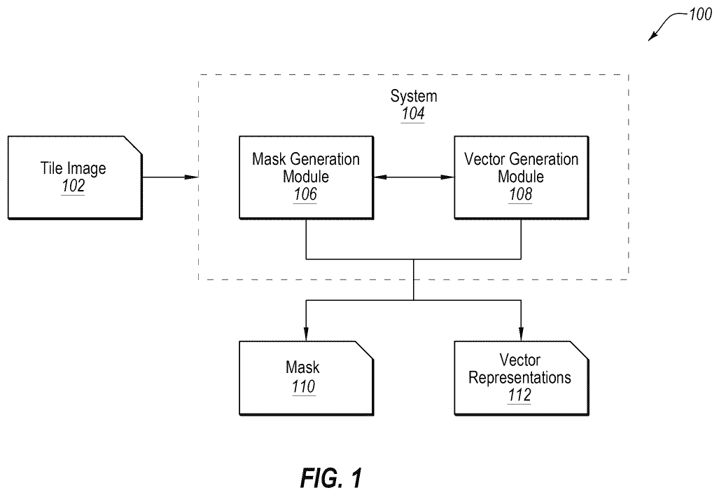

With reference to FIG. 1, FIG. 1 is a diagram representing an example environment 100 related to generating an output which may include a mask 110 (e.g., BEV mask, top-down mask, orthogonally projected mask, etc.) and/or vector representations 112 associated with a geographic area, in accordance with one or more embodiments of the present disclosure. The environment 100 may include a system 104 that may be configured to receive and/or otherwise obtain a tile image 102 and generate the mask 110 and/or the vector representations 112 based on the tile image 102.

The tile image 102 may represent a top-down view of a portion of a path surface. In these or other embodiments, a path surface may refer to a top-down view of a geographic area. In some embodiments, the path surface may include a roadway or other navigable surface that may be traversed using one or more machines such as, for example, autonomous or semi-autonomous vehicles. In some embodiments, the path surface may include features such as lane markings, road boundaries, medians, crosswalks, and other environmental elements relevant for vehicle navigation and localization.

In some embodiments, the tile image 102 may include data and/or information that may correspond to the portion of the path surface that the tile image 102 may represent. In some embodiments, the tile image 102 may include visual information associated with various environmental features associated with the portion of the path surface, such as lane markers, curbs, medians, guardrails, barriers, pedestrian crosswalks, stop lines, speed bumps, parking spaces, or other relevant environmental features. In some embodiments, the environmental features may be represented as lines, shapes, textures, color variations, intensity variations, and other like representations within the tile image 102.

In some embodiments, the tile image 102 may represent a geographic area of a predefined size, such as, for example, 30 meters by 60 meters, which may represent a fixed area of the path surface. In some embodiments, multiple overlapping tile images 102 may be generated to cover a larger geographic area. For example, in the context of the geographic area including a path surface—e.g., for one or more vehicles to traverse—the entire path surface may be covered by multiple tile images 102. Continuing the example, individual tile images may be centered at different positions along the path surface. For example, the individual tile images 102 may be centered at various locations along a trajectory of a vehicle or potential trajectory of a vehicle that may travel along the path surface.

In some embodiments, the tile image 102 may be generated based on aggregated path surface data representing a bird's eye view (BEV) of the path surface. As used in the present disclosure, the aggregated path surface data includes data corresponding to a path surface obtained using one or more of the sensors that may be oriented above a plane generally associated with the floor, road, driving surface, or ground associated with the environment—e.g., a ground plane. In some embodiments, the one or more sensors may be oriented such that they may collect sensor data in an orthogonal orientation or a substantially orthogonal orientation relative to the ground plane. For example, the sensors may be mounted on a vehicle roof or other elevated structure to provide a top-down perspective of the path surface. As an additional example, the sensors may be suspended above the ground plane (e.g., mounted to a drone or other similar machines or structures). In some instances, orienting the sensors in an orientation that is orthogonal or substantially orthogonal compared to the ground plane may allow for more direct collection of top-down view data without requiring perspective transformations associated with data collected and/or generated using sensors collecting perspective data relative to the ground plane. In some embodiments, “substantially orthogonal” may include an orientation that is +/−10 degrees from orthogonal in any angular direction with respect to the ground plane associated with the ground of the environment.

In some embodiments, the one or more sensors may include one or more different sensor types. For example, the one or more sensors may include one or more cameras configured to capture image data of the path surface. As an additional example, the sensors may include one or more LiDAR (Light Detection and Ranging) sensors that collect point cloud data representing the three-dimensional structure of the path surface and surrounding objects. In some embodiments, the LiDAR sensors may be rotated or oriented to scan the environment in multiple directions.

Additionally or alternatively, the one or more sensors may include inertial measurement units (IMUs) that may include one or more accelerometers and/or gyroscopes that may be used to track motion and/or orientation of the sensors. In some embodiments, one or more global navigation satellite system (GNSS) receivers may provide precise location data to geo-reference the collected sensor data. In some embodiments, the aggregated path surface data may be generated by fusing and processing the data from multiple sensor types to create a comprehensive representation of the path surface and surrounding environment.

In some implementations, the tile image 102 may be part of a sequence of tile images representing adjacent or overlapping portions of the path surface. In this implementation, individual tile images in the sequence may correspond to different positions along a vehicle trajectory or data collection path. In some embodiments, the tile images may have some degree of overlap to provide continuity and allow for refinement of feature detection across multiple tile images.

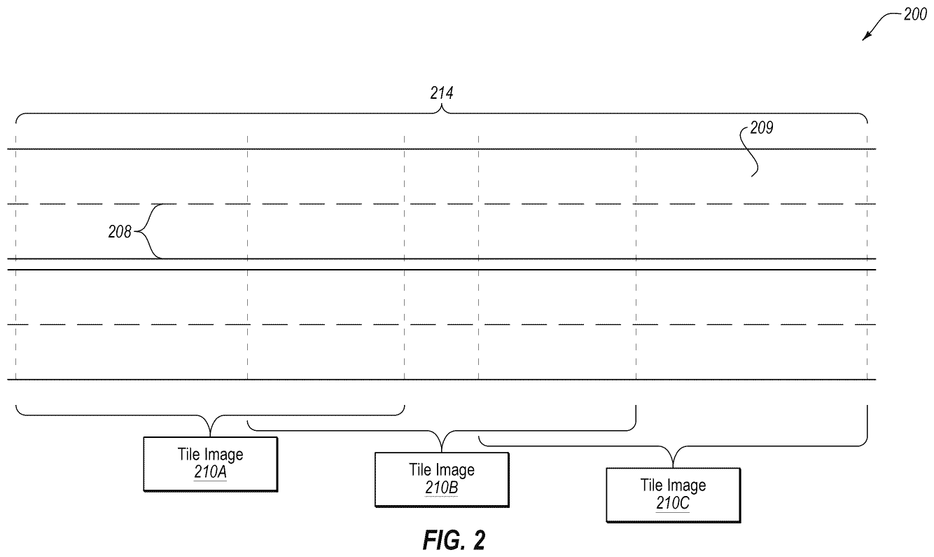

An example of a sequence of tile images representing overlapping portions of the path surface may be described and/or illustrated with respect to FIG. 2. FIG. 2 is a diagram illustrating an environment 200 that incudes a pathway 214, the pathway 214 being represented by multiple overlapping tile images 210.

The pathway 214 may include a geographic area of interest. For example, the pathway 214 may include the entirety of a vehicle's path or potential path from a starting point to a destination point. For example, the pathway 214 may include a continuous route spanning multiple intersections, highways, and/or other traversable surfaces that a vehicle may follow to reach its intended destination. Continuing the example, the pathway 214 may extend for any distance, ranging from short local trips of a few blocks to long-distance journeys across cities or states. As an additional example, the pathway 214 may not include a geographic area that may correspond with a vehicle's path but other geographic areas such as, for example, cityscapes, natural environments, etc.

In some implementations, while illustrating a road surface in FIG. 2, the pathway 214 may include additional elements beyond just the physical road surface. For instance, the pathway 214 may include one or more lane markings, traffic signs, traffic lights, road boundaries, medians, and other static infrastructure along the route. The pathway 214 may also factor in dynamic elements such as traffic conditions, construction zones, and temporary road closures on the pathway 214, among other dynamic elements.

In some embodiments pathway 214 may include a surface that may include, for example, lane markings 208 and unmarked surface areas 209. In some embodiments, the pathway 214 may be represented by aggregated path surface data such as, for example, the aggregated path surface data described, for example, with respect to FIG. 1. In some embodiments, the aggregated path surface data may be generated and/or collected by one or more sensors such as point cloud sensors, optical image sensors, and the like as the sensors move down the pathway 214.

In some embodiments, the portions of the pathway 214 may be represented by one or more tiles images 210. As shown in FIG. 2, a first portion of the pathway 214 may be represented by a first tile image 210A, a second portion of the pathway 214 may be represented by a second tile image 210B, and a third portion of the pathway 214 may be represented by a third tile image 210C. In these or other embodiments, the tile images 210 may be the same as and/or analogous to the tile image 102 described and/or illustrated further in the present disclosure such as, for example, with respect to FIG. 1.

In some embodiments, the tile images 210 may include data representations of particular geographic areas associated with the pathway 214. As shown in FIG. 2, for example, each of the tile images 210 correspond to dotted lines representing the geographic boundaries that the tile images 210 may represent. In some embodiments, the tile images 210 may represent portions of the pathway 214 that may be the same in size. For example, each of the tile images 210 may include data representations of a geographic area that is 100 m×100 m. Additionally or alternatively, each of the tile images 210 may include data representations of a geographic area that are different. For example, the first tile image 210A may represent a first portion of the pathway 214 that may be 60 m×30 m and the second tile image 210B may represent a second portion of the pathway 214 that may be 45 m×30. m.

In some embodiments, tile images 210 may be represent different geographic areas corresponding to the pathway 214 in response to the pathway 214 including more characteristics or features associated with a particular area compared with another. For example, a first portion of the pathway 214 may include a road with lane lines while a second portion of the pathway 214 may include intersections, medians, stop lights, stop signs, buildings, roundabouts, etc. Continuing the example, a tile image 210 corresponding to the second portion may be smaller to accommodate for additional data associated with the second portion of the pathway 214.

As shown in FIG. 2, the tile images 210 may represent portions of the pathway 214 that may overlap with each other. For example, the pathway 214 may include a geographic area that is 100 m in length. Continuing the example, the first tile image 210A may represent data corresponding to a first portion of the pathway from 0 m to 50 m, the second tile image 210B may represent data corresponding to a second portion of the pathway 214 from 25 m to 75 m, and the third tile image 210C may represent data corresponding to a third portion of the pathway 214 from 50 m to 100 m. In the example, each of the tile images 210 may include data representations that correspond to geographic areas associated with the pathway 214 that overlap with one or more of the other tile images 210. In some embodiments, the amount of geographic overlap between tile images 210 may increase or decrease based on the number of environmental features included in respective geographic areas. Additionally or alternatively, the amount of overlap between tile images 210 may be a predetermined amount based, for example, on processing constraints.

As illustrated in FIG. 2, the tile images 210 may include multiple attributes that may provide different types of information. In some embodiments, these attributes may include surface intensity, surface height, and surface color, each contributing to a representation of the pathway 214. For example, one or more of the pixels included in individual tile images 210 may encode one or more of these attributes, effectively describing the physical characteristics of the surface. In some embodiments, by combining intensity, height, and color data, the resulting composite image may provide a structured and detailed top-down visualization, which may improve analysis and interpretation of one or more features or characteristics that may be associated with the pathway 214.

In some embodiments, for example, surface intensity may include variations in reflectivity or texture, which may provide information on how light interacts with the surface or ground associated with the pathway 214. In some embodiments, the surface intensity attribute may be useful in identifying changes in material composition or wear patterns. For example, a concrete roadway may exhibit high intensity in dry conditions but appear darker and less reflective when wet, which may allow for assessment of surface conditions.

In these and other embodiments, surface height may include elevation or depth information, which may represent topographical changes across the pathway 214. In some embodiments, the surface height attribute may help in detecting variations such as depressions, raised edges, or uneven surfaces associated with the pathway 214.

In some embodiments, surface color retains the natural color characteristics of the surface, providing visual context for distinguishing different materials or markings. In some embodiments, the surface color attribute may help to provide information corresponding to the pathway 214 where color-based differentiation may be important. For example, in the context of the pathway 214 including a roadway, surface color data may be used to detect which lines are yellow and which lines are white, which may communicate different information about the roadway markings than a simple determination of their existence on the roadway—e.g., oncoming traffic, okay to cross, not okay to cross, and other related types of information.

Returning to FIG. 1, the tile image 102 may be sent to the mask generation system 104 for further processing and analysis. The mask generation system 104 may be configured to extract relevant features from the tile image 102 and generate the mask 110 and/or the vector representations 112. In some embodiments, the mask generation system 104 may include any suitable system, apparatus, or device configured to receive or otherwise obtain the tile image 102. In some embodiments, the mask generation system 104 may be a stand-alone system. Additionally or alternatively, the mask generation system 104 may be included in one or more other systems. Additionally or alternatively, the mask generation system 104 may direct one or more other systems to perform operations.

In some embodiments, the mask generation system 104 may include a mask generation module 106 and/or a vector generation module 108. In some embodiments, the mask generation module 106 and/or the vector generation module 108 may include code and routines configured to allow a computing system to perform one or more operations. Additionally or alternatively, the mask generation module 106 and/or the vector generation module 108 may be implemented using hardware including one or more processors, CPUs graphics processing units (GPUs), data processing units (DPUs), parallel processing units (PPUs), microprocessors (e.g., to perform or control performance of one or more operations), field-programmable gate arrays (FPGA), application-specific integrated circuits (ASICs), accelerators (e.g., deep learning accelerators (DLAs)), and/or other processor types. In some embodiments, the mask generation module 106 may be included in or implemented by any suitable AI system, model, or framework. For example, the mask generation module 106 may be implemented using one or more deep learning models, neural networks, deep neural networks (DNNs), convolutional neural networks (CNNs), transformer models, and/or any other suitable AI architecture. In these and other embodiments, the mask generation module 106 and/or the vector generation module 108 may be implemented using a combination of hardware and software. In the present disclosure, operations described as being performed by the mask generation module 106 and/or the vector generation module 108 may include operations that the mask generation module 106 and/or the vector generation module 108 may direct a corresponding computing system to perform. In these or other embodiments, the mask generation module 106 and/or the vector generation module 108 may be implemented by one or more computing devices, such as that described in further detail with respect to FIGS. 5A-E, 6, 7, and 8.

In some embodiments, the mask generation module 106 may be configured to perform one or more operations associated with the tile image 102. In some embodiments, the operations may include one or more pre-processing operations on the tile image 102 or data corresponding to the tile image 102. In some embodiments, the pre-processing operations may include resizing the tile image 102 to standardized dimensions. For example, the tile image 102 may be resized to 256×512 pixels or another suitable resolution that balances considerations such as preservation of details included in the tile image 102 and computational or processing efficiency. In some embodiments, resizing the tile image 102 may help improve consistent input sizes for the encoder system and subsequent modules, systems, subsystems, etc.

In some embodiments, the mask generation module 106 may segment the tile image 102 into one or more regions of interest. For example, the mask generation module 106 may identify and/or isolate a road surface included in the tile image 102 from other terrain or structures that may be included in the tile image 102. In some embodiments, segmenting the tile image 102 and/or focusing on regions or characteristics of interest may allow for one or more downstream processing operations to focus on particular portions of the tile image 102 for extracting one or more features such as, for example, roadway boundaries.

Additionally or alternatively, the pre-processing operations performed by the mask generation module 106 may include fusing data from multiple sensor modalities. For example, the mask generation module 106 may combine intensity data from LIDAR sensors with color information from optical cameras to create a multi-channel tile image 102. In some embodiments, fusing data from multiple sensor modalities may include combining and integrating information from different types of sensors to create a more comprehensive and accurate representation of the environment. In some embodiments, fusing data from different sensor modalities may allow for leveraging the strengths of various sensor types.

For example, the mask generation module 106 may fuse LIDAR intensity data with RGB color information from optical cameras to create a multi-channel tile image 102. The LIDAR intensity data may provide depth and surface reflectivity information, and the camera color data may include visual context and texture details. In some embodiments, a fused tile image 102 may include more detailed environmental data and/or information than either sensor modality alone may be able to provide. This may allow for a more robust and accurate detection of road features like, for example, lane markings, curbs, and other objects in one or more subsequent processing steps.

Additionally or alternatively, the mask generation module 106 may be configured to extract one or more image features included in the tile image 102. As used in the present disclosure, image features may indicate one or more environmental characteristics associated with the portion of the path surface represented in the tile image 102. For example, the image features may include representations of lane markers, curbs, medians, guardrails, barriers, pedestrian crosswalks, stop lines, speed bumps, parking spaces, or other environmental elements visible in the top-down view.

In some embodiments, extracting one or more image features may include applying one or more computer vision techniques to the tile image 102. For instance, the mask generation module 106 may use one or more edge detection algorithms which may identify linear features that may correspond to lane markings or road boundaries. Further, in some embodiments, one or more segmentation techniques may be employed to separate the road surface from surrounding areas and, in some instances, one or more color thresholding techniques may be used to isolate specific road markings or surface types.

In some embodiments, the mask generation module 106 may apply one or more machine learning models, neural networks such as CNNs or other deep learning models trained to recognize and/or localize particular road features within top-down imagery. These models may output bounding boxes, segmentation masks, or key points corresponding to detected environmental elements of interest.

In some embodiments, the image features that may be extracted may be represented as feature maps or vectors encoding the presence, location, orientation, and/or other characteristics or attributes of detected environmental characteristics. For example, a feature map may indicate a likelihood of a lane marking being present at each pixel location in the tile image 102. The extracted features may serve as inputs for subsequent processing stages to generate the mask 110.

In some embodiments, the mask generation module 106 may generate a mask corresponding to the geographic area represented by the tile image 102. The mask may be the mask 110 that may indicate locations associated with various environmental features within the geographic area. To generate the mask 110, the mask generation module 106 may apply one or more computer vision and image processing techniques to the tile image 102.

In some embodiments, for example, the mask generation module 106 may utilize edge detection algorithms to identify linear features in the tile image 102 that may correspond to lane markings, road boundaries, or other environmental elements. Various edge detection methods such as Canny edge detection, Sobel operators, or more advanced techniques may be employed. The detected edges may be used to create initial outlines of potential road features in the mask 110.

In some embodiments, the mask generation module 106 may combine outputs from multiple detection and segmentation techniques that may have been performed during the preprocessing operations to create a comprehensive mask representing the environmental features present in the tile image 102. Additionally or alternatively, the mask generation module 106 may apply post-processing steps such as morphological operations, connected component analysis, or graph-based refinement to clean up the mask 110 and improve spatial consistency of the detected features.

In some embodiments, the generated mask 110 may be represented as a multi-channel or multi-layer image or tensor, where different channels or layers correspond to different types of environmental features. For example, one channel may represent lane markings, another may represent road boundaries, and others may represent additional elements like crosswalks or traffic signs. In some embodiments, the intensity values in each channel may indicate the likelihood or confidence of a particular feature being present at each pixel location.

In some embodiments, the mask generation module 102 may compare and fuse or reconcile the generated mask 110 with one or more other BEV masks that may correspond to the same geographic area. For example, the mask generation module 106 may amend the position of certain environmental features if those features are located in different locations corresponding to adjacent tile images. The mask generation module 106 may apply consistency checks across multiple generated BEV masks to ensure continuity and accuracy of detected features across the broader geographic area. In some embodiments, the mask generation module 106 may utilize overlapping regions between adjacent tile images to refine and align feature detections.

In some embodiments, the mask generation module 106 may employ probabilistic fusion techniques to combine feature detections from multiple overlapping BEV masks, weighting detections based on confidence scores or other metrics. For example, graph-based optimization techniques may be applied to improve consistent feature locations across multiple BEV masks. In some embodiments, the mask generation module 106 may maintain a buffer or memory mechanism of recently generated BEV masks to enable refinement of past detections as new information becomes available from subsequent tile images (e.g., the tile image 102). In some embodiments, cross-mask comparison and fusion may improve the consistency and accuracy of the generated BEV mask representations.

In some embodiments, the vector generation module 108 may extract, be sent, receive, or otherwise obtain the mask 110 generated using the mask generation module 106. The vector generation module 108 may be configured to provide vectors that overlay different determined environmental features included in the mask 110. For example, the vector generation module 108 may analyze the mask 110 to identify locations and shapes of environmental features such as lane markers, road boundaries, crosswalks, stop lines, or other relevant features. Based on this analysis, the vector generation module 108 may generate vector representations 112 that trace or outline the identified features. These vector representations 112 may provide a more compact and precise encoding of the environmental features compared to the pixel-based mask 110. In some embodiments, the vectors generated by the vector generation module 108 may be used to represent and communicate locations and geometries of key environmental elements for downstream processing and decision-making by autonomous navigation systems.

In some embodiments, to generate vectors associated with the mask 110 generated using the mask generation module 106, the vector generation module 108 may analyze the mask 110 to identify locations and shapes of environmental features such as lane markers, road boundaries, crosswalks, stop lines, or other relevant features. In some embodiments, individual identified features, the vector generation module 108 may generate vector representations 112 that traces or outlines geometry associated with the environmental features depicted or represented in the mask 110.

The vector generation module 108 may employ one or more computer vision and/or image processing techniques to extract feature geometries from the pixel-based mask 110. In some embodiments, the one or more computer vision and/or image processing techniques may include edge detection, contour tracing, line fitting, and other algorithms to identify and parameterize the shapes of environmental elements.

In some embodiments, the resulting vector representations 112 provide a compact encoding of key road features, capturing their locations, extents, and geometries in an efficient format. In some embodiments, the vectors may be used to communicate detected environmental elements to downstream modules or systems for further processing, analysis, and visualization.

For example, in the context of an autonomous vehicle system, vector representations 112 derived from a mask 110 may encode spatial relationships and geometries corresponding to environmental features included in the mask 110 in a simplified and computationally efficient manner. Continuing the example, the autonomous vehicle may use the generated vector representations 112 to refine localization operations by matching them against a high-definition map, adjusting its estimated position based on detected lane markings or road boundaries. For instance, if the vehicle identifies a crosswalk and a stop line in the mask 110, it can compare their vectorized locations to the expected positions in its map, correcting any discrepancies in its localization estimate to ensure accurate navigation and compliance with traffic regulations.

In some embodiments, the vector generation module 108 and the mask generation module 106 may be configured to communicate and interoperate in various ways to generate accurate representations of environmental features. For example, the mask generation module 106 may provide the generated mask 110 to the vector generation module 108 as an input. The vector generation module 108 may analyze the BEV mask to identify and extract key features to generate the vector representations 112.

Additionally or alternatively, the mask generation module 106 may provide intermediate feature representations or confidence scores associated with detected features in the mask 110 to the vector generation module 108. This additional information may assist the vector generation module 108 in more accurately vectorizing ambiguous or low-confidence regions of the mask 110.

In some embodiments, the vector generation module 108 may provide feedback to the mask generation module 106 regarding the vectorization results. For example, in response to the vector generation module 108 detecting inconsistencies or implausible geometries in attempting to vectorize certain regions corresponding to the mask 110, the vector generation module 108 may signal the mask generation module 106 to refine or regenerate those portions of the mask 110. In some embodiments, a feedback loop between the mask generation module 106 and the vector generation module 108 may allow iterative refinement of both the mask 110 and vector representations 112.

In some embodiments, the mask generation module 106 and the vector generation module 108 may also share a common memory buffer and may exchange information about detected features across multiple frames or tile images. In some embodiments, the mask generation module 106 may update the shared memory with newly detected features, and the vector generation module 108 may read from and write to the memory to maintain consistent tracking of vectorized elements over time.

Additionally or alternatively, the vector generation module 108 and mask generation module 106 may use a common coordinate system or reference frame to ensure spatial alignment between the mask 110 and the vector representations 112. The modules may exchange calibration or registration information to maintain this alignment.

By maintaining communication and data sharing, the vector generation module 108 and mask generation module 106 may work in concert to produce accurate and consistent representations of environmental features across multiple tile images and timeframes. This integrated approach may enable more robust HD map generation compared to processing the BEV mask 110 and vector representations 112 in isolation.

The mask generation module 106, the vector generation module 108, and/or the system 104 may generate the output which may include the mask 110, the vector representations 112, and other data and/or information associated with the mask 110 and the vector representations 112. In some embodiments, the mask 110 and/or the vector representations 112 may be sent to other systems, machines, etc. For example, the mask 110 and/or the vector representations 112 may be sent to an autonomous vehicle system, a mapping system, a localization system, and/or other systems that may use the BEV mask and vector representations for navigation, localization, mapping, and/or other purposes. In some instances, receiving systems may perform one or more operations based on the mask 110 and/or the vector representations 112.

It should be understood that this and other arrangements described herein are set forth only as examples. Other arrangements, components, features, and elements (e.g., machines, interfaces, functions, orders, groupings of functions, etc.) may be used in addition to or instead of those shown, and some elements may be omitted altogether. Further, many of the arrangements, components, features, elements, etc. described herein are functional entities that may be implemented as discrete or distributed components or in conjunction with other components, and in any suitable combination and location (e.g., on a local device, vehicle, or machine at the edge, on-premises—such as locally hosted servers, remotely located—such as in one or more computing or server devices in one or more data centers in the cloud, and/or at other locations). Various functions described herein as being performed by entities may be carried out by hardware, firmware, and/or software. For instance, various functions may be carried out using one or more processors (e.g., central processing units (CPU(s)), graphics processing units (GPU(s)), microprocessors, microcontrollers, embedded processors, digital signal processors (DSPs), image signal processors (ISPs), physics processing units (PPUs), field-programmable gate arrays (FPGAs), accelerator(s) (e.g., deep learning accelerators (DLAs), deep learning accelerator cluster (XNNs), neural network accelerators (NNAs), and/or neural processing units (NPUs), programmable vision accelerators (PVAs), optical flow accelerators (OFAs), etc.), application specific integrated circuits (ASICs), data processing units (DPUs), quantum processors, etc.) executing instructions stored in memory. In some embodiments, the systems, methods, and processes described herein may be executed using similar components, features, and/or functionality to those of example machine 500 of FIGS. 5A-5E, example computing ecosystem 600 of FIG. 6, example generative language model system 700 of FIG. 7, and/or example computing device 800 of FIG. 8.

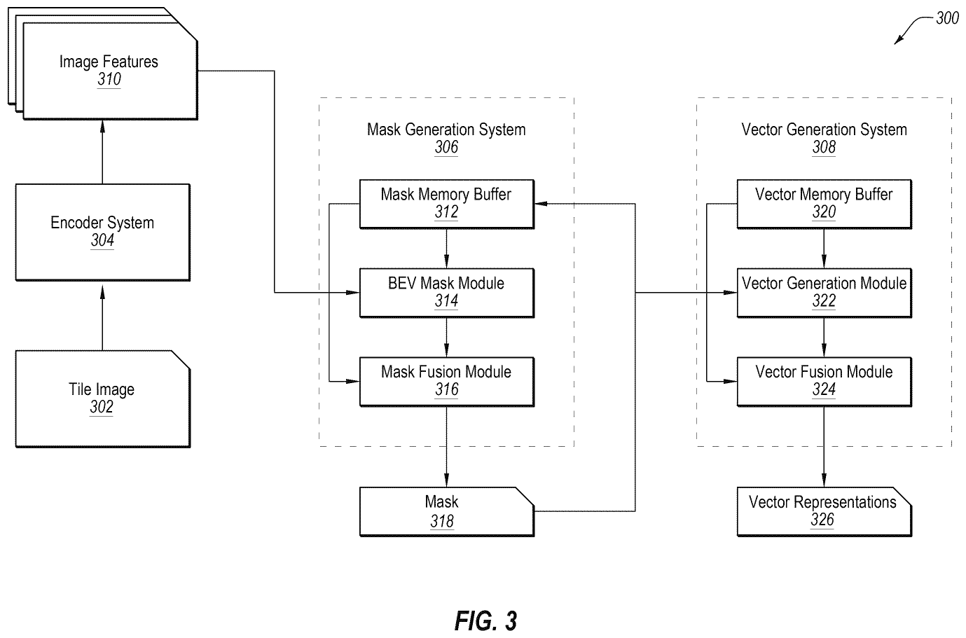

FIG. 3 is a diagram representing an example environment 300 related to generating a Mask 318 and corresponding vectors 326 from a tile image 302, in accordance with one or more embodiments of the present disclosure. In some embodiments, the environment 300 may include a mask generation system 306 and a vector generation system 308 which may generate the Mask 318 and the vectors 326, respectively.

The tile image 302 may represent a top-down view of a portion of a path surface. In some embodiments, the tile image 302 may include data and/or information that may correspond to the portion of the path surface that the tile image 302 may represent. In these or other embodiments, the tile image 302 may be the same as and/or analogous to the tile image 102 described further in the present disclosure such as, for example, with respect to FIG. 1. In some embodiments, the tile image 302 may be received or otherwise obtained by an encoder system 304.

In some embodiments, the encoder system 304 may include any suitable system, apparatus, or device configured to receive or otherwise obtain the tile image 302. In some embodiments, the encoder system 304 may be a stand-alone system. Additionally or alternatively, the encoder system 304 may be included in one or more other systems. Additionally or alternatively, the encoder system 304 may direct one or more other systems to perform operations.

In some embodiments, the encoder system 304 may be configured to perform preprocessing operations on the tile image 302. The encoder system 304 may apply various image processing techniques to enhance or normalize the tile image 302 prior to feature extraction. For example, the encoder system 304 may adjust contrast, brightness, or color balance of the tile image 302. Additionally, the encoder system 304 may perform noise reduction or image sharpening operations on the tile image 302.

In some embodiments, the encoder system 304 may resize or crop the tile image 302 to standardize the input dimensions for subsequent processing stages. The encoder system 304 may also apply data augmentation techniques such as random rotations, flips, or affine transformations to the tile image 302.

After preprocessing, the encoder system 304 may extract image features 310 from the processed tile image. The encoder system 304 may use, for example, one or more CNN architectures to automatically learn and extract relevant features from the tile image 302. In some embodiments, the encoder system 304 may employ transfer learning by using pre-trained CNN models and fine-tuning them on the specific tile image dataset. The extracted image features 310 may capture high-level semantic information as well as low-level texture and edge details present in the tile image 302.

The encoder system 304 may also apply attention mechanisms to focus on the most relevant regions of the tile image 302 for feature extraction. In some embodiments, the encoder system 304 may utilize spatial attention or channel attention modules to dynamically weight different spatial locations or feature channels of the tile image 302 during the feature extraction process.

In these or other embodiments, the encoder system 304 may be configured to perform pre-processing operations and image feature extraction operations like those described further in the present disclosure such as, for example, with respect to the system 104, the mask generation module 106, and/or the vector generation module 108 described and/or illustrated with respect to FIG. 1.

The image features 310 may indicate one or more environmental characteristics associated with the portion of the path surface represented in the tile image 302. In these or other embodiments, the image features 310 may be the same as and/or analogous to the image features described and/or illustrated further in the present disclosure such as, for example with respect to FIG. 1. In some embodiments, the image features 310 may be received and/or otherwise obtained by the mask generation system 306.

The mask generation system 306 may include any suitable system, apparatus, or device configured to receive or otherwise obtain the tile image 102. In some embodiments, the mask generation system 306 may be a stand-alone system. Additionally or alternatively, the mask generation system 306 may be included in one or more other systems. Additionally or alternatively, the mask generation system 306 may direct one or more other systems to perform operations. In these or other embodiments, the mask generation system 306 may be the same as and/or analogous to the mask generation system 104 described and/or illustrated further in the present disclosure such as, for example, with respect to FIG. 1.

In some embodiments, the mask generation system 306 may include a mask memory buffer 312, a BEV mask module 314, and/or a mask fusion module 316. In some embodiments, the BEV mask module 314, and/or the mask fusion module 316 may include code and routines configured to allow a computing system to perform one or more operations. Additionally or alternatively, the BEV mask module 314, and/or the mask fusion module 316 may be implemented using hardware including one or more processors, CPUs, GPUs, DPUs, PPUs, microprocessors (e.g., to perform or control performance of one or more operations), FPGAs, ASICs, accelerators (e.g., DLAs), and/or other processor types. In some embodiments, the BEV mask module 314 and/or the mask fusion module 316 may be included in or implemented by any suitable AI system, model, or framework. For example, the BEV mask module 314 and/or mask fusion module 316 may be implemented using one or more deep learning models, neural networks, DNNs, CNNs, transformer models, and/or any other suitable AI architecture. In these and other embodiments, the BEV mask module 314, and/or the mask fusion module 316 may be implemented using a combination of hardware and software. In the present disclosure, operations described as being performed by the BEV mask module 314, and/or the mask fusion module 316 may include operations that the BEV mask module 314, and/or the mask fusion module 316 may direct a corresponding computing system to perform. In these or other embodiments, the BEV mask module 314, and/or the mask fusion module 316 may be implemented by one or more computing devices, such as that described in further detail with respect to FIGS. 5A-E, 6, 7, and 8.

In some embodiments, the BEV mask module 314 may be configured to receive or obtain the image features 310 corresponding to the tile image 302. Additionally or alternatively, the BEV mask module 314 may obtain data and/or information that may be included in the tile image 302. In some embodiments, the BEV mask module 314 may be configured to generate a Mask 318Mask 318 corresponding to a portion of a pathway represented by the tile image 302. In some embodiments, the Mask 318Mask 318 may include one or more representations of environmental characteristics associated with the tile image 302. In some embodiments, the BEV mask module 314 may be configured to perform operations described further in the present disclosure such as, for example, with respect to the BEV mask module 106 in FIG. 1.

In some embodiments, the BEV mask module 314 may send the Mask 318Mask 318 to the mask fusion module 316. In some embodiments, the mask fusion module 316 may be configured to receive historical information corresponding to previously generated BEV masks and compare the historical information corresponding to the previously generated BEV masks to the Mask 318Mask 318 currently being generated associated with the tile image 302.

In some embodiments, the mask fusion module 316 may receive or obtain the historical information corresponding to previously generated BEV masks from a mask memory buffer 312. In some embodiments, the mask memory buffer 312 may be a storage component configured to store and/or manage data corresponding to one or more BEV masks 318. The mask memory buffer 312 may include temporary memory such as random access memory (RAM) for storing BEV mask data during processing. In some embodiments, the mask memory buffer 312 may also include more permanent memory such as read-only memory (ROM), flash memory, or other non-volatile storage for retaining BEV mask data between processing sessions. In some embodiments, the mask memory buffer 312 may be implemented using various memory technologies suitable for storing two-dimensional mask data, including but not limited to dynamic RAM (DRAM), static RAM (SRAM), or embedded memory integrated with processing components. The capacity and configuration of the mask memory buffer 312 may be selected based on the expected size and quantity of mask data to be stored during system operation.

In some embodiments, the mask memory buffer 312 may be configured to store historic BEV mask data. The mask memory buffer 312 may retain BEV mask data from previous processing iterations or time steps. In some embodiments, the historic mask data may be used to provide temporal consistency in generating new BEV masks such as, for example, generating the Mask 318Mask 318 associated with the tile image 302. In some embodiments, the mask memory buffer 312 may store a sequence of BEV masks corresponding to consecutive tile images. In response to processing a new tile image (e.g., the tile image 302), the mask fusion module 316 may access the historic mask data from the mask memory buffer 312 to inform the generation of the current Mask 318Mask 318. In some embodiments, accessing historical BEV mask data from the mask memory buffer 312 may allow the system to leverage information from previous tile images to improve accuracy and consistency of the generated masks over time.

In some embodiments, the mask memory buffer 312 may be implemented as a first-in-first-out (FIFO) buffer, which may enable the mask generation system 306 to maintain a sliding window of recent BEV mask history. In some embodiments, the FIFO approach may ensure that the most recent observations may be retained while older data may be systematically removed, allowing for efficient temporal analysis of the environment.

In some embodiments, the mask memory buffer 312 may be implemented as a last-in-first-out (LIFO) buffer, which may enable the mask generation system 306 to prioritize the most recent BEV mask data. In some embodiments, the LIFO approach may ensure that the latest observations may be processed first, potentially allowing for more efficient handling of relevant information when generating updated BEV masks.

In some embodiments, a size of the buffer may be configurable based on the target length of context needed for a given application. For example, a larger buffer size may allow for a more extended historical view, which may be beneficial for detecting long-term trends or smoothing transient noise in the BEV mask data. Additionally or alternatively, a smaller buffer size may reduce memory and computational overhead while still preserving context of one or more BEV masks associated with adjacent tile images.

In some embodiments, the mask memory buffer 312 may store supplemental metadata associated with each historical BEV mask. The metadata may include timestamps, positional information, and/or sensor-specific details that may aid in aligning past observations with current data. In some embodiments, incorporating such metadata may help to generate improved data fusion across multiple time steps, ultimately improving a robustness and reliability of downstream BEV mask generation.

In some embodiments, the mask fusion module 316 may analyze one or more overlapping regions between the historical BEV masks and the current BEV mask to identify any inconsistencies or discrepancies in detected environmental features.

In some embodiments, the mask fusion module 316 may refine the current BEV mask 318 by incorporating consistent detections from the historical BEV masks and resolving any inconsistencies. In some embodiments, these refining processes may improve continuity and accuracy of detected features across sequential tile images. In some embodiments, to reconcile differences between BEV masks, the mask fusion module 316 may perform one or more operations such as, for example, applying weighted averaging or other statistical techniques to merge detections from multiple frames, with greater weight given to more recent frames.

Additionally or alternatively, the mask fusion module 316 may employ one or more geometric alignment techniques to register overlapping regions between masks. In some embodiments, the mask fusion module 316 may use one or more feature matching algorithms to identify corresponding image features or environmental features across sequential image tiles and align the image features or environmental characteristics spatially. Further, the mask fusion module 316 may fuse the aligned features using techniques like maximum likelihood estimation or consensus voting.

In some embodiments, the mask fusion module 316 may also leverage one or more machine learning models, deep neural networks, and the like that may be trained on historical data to predict and interpolate features in regions with low confidence detections. In some embodiments, use of machine learning models may help fill in gaps or resolve ambiguities in the detections of image features associated with tile images based on learned patterns from one or more previous BEV masks associated with one or more corresponding previous tile images.

In some embodiments, the mask fusion module 316 may generate a fused mask 318 that may include any reconciled differences between the current BEV mask and one or more historical BEV masks stored in the mask memory buffer 312. In some embodiments, the fused mask 318 may provide a more robust and temporally consistent representation of environmental features compared to masks generated from individual frames in isolation. In some embodiments, the fused mask 318 may be sent to the vector generation system 308.

The vector generation system 308 may include any suitable system, apparatus, or device configured to receive or otherwise obtain the fused mask 318. In some embodiments, the vector generation system 308 may be a stand-alone system. Additionally or alternatively, the vector generation system 308 may be included in one or more other systems. Additionally or alternatively, the vector generation system 308 may direct one or more other systems to perform operations. In these or other embodiments, the vector generation system 308 may be the same as and/or analogous to the mask generation system 104 and/or the vector generation module 104 described and/or illustrated further in the present disclosure such as, for example, with respect to FIG. 1. In some embodiments, the vector generation system 308 may be included in a same system as the mask generation system 306. Additionally or alternatively, the vector generation system 308 and the mask generation system 306 may be the same system or subsystems included in the same system.

In some embodiments, the vector generation system 308 may include a mask memory buffer 320, a vector generation module 322, and/or a vector fusion module 324. In some embodiments, the vector generation module 322, and/or the vector fusion module 324 may include code and routines configured to allow a computing system to perform one or more operations. Additionally or alternatively, the vector generation module 322, and/or the vector fusion module 324 may be implemented using hardware including one or more processors, CPUs, GPUs, DPUs, PPUs, microprocessors (e.g., to perform or control performance of one or more operations), FPGAs, ASICs, accelerators (e.g., DLAs), and/or other processor types. In some embodiments, the vector generation module 322, and/or the vector fusion module 324 may be included in or implemented by any suitable AI system, model, or framework. For example, the vector generation module 322, and/or the vector fusion module 324 may be implemented using one or more deep learning models, neural networks, DNNs, CNNs, transformer models, and/or any other suitable AI architecture. In these and other embodiments, the vector generation module 322, and/or the vector fusion module 324 may be implemented using a combination of hardware and software. In the present disclosure, operations described as being performed by the vector generation module 322, and/or the vector fusion module 324 may include operations that the vector generation module 322, and/or the vector fusion module 324 may direct a corresponding computing system to perform. In these or other embodiments, the vector generation module 322, and/or the vector fusion module 324 may be implemented by one or more computing devices, such as that described in further detail with respect to FIGS. 5A-E, 6, 7, and 8.

In some embodiments, the vector generation module 322 may be configured to receive, extract, or otherwise obtain the fused mask 318. In some embodiments, the vector generation module 322 may generate one or more vector representations 326 corresponding to the environmental characteristics associated with the fused mask 318. In these or other embodiments, the vector generation module 322 may be the same as, analogous to, and/or perform the same operations as the vector generation module 108 described and/or illustrated further in the present disclosure such as, for example, with respect to FIG. 1. In some embodiments, the vector fusion module 324 may receive, extract, or otherwise obtain the resulting vectors generated using the fused mask 318 and historical vector representations corresponding to one or more previously generated BEV masks. For example, the vector fusion module 324 may receive or extract previously generated vector representations of previously generated BEV masks from the vector memory buffer 320.

In some embodiments, the vector memory buffer 320 may be a storage component configured to store and/or manage data corresponding to vector representations associated with one or more historically generated—e.g., BEV masks other than the fused mask 318. The vector memory buffer 320 may include temporary memory such as RAM for storing vector representations during processing. In some embodiments, the vector memory buffer 320 may also include more permanent memory such as ROM, flash memory, or other non-volatile storage for retaining vector representations corresponding to BEV mask data between processing sessions. In some embodiments, the vector memory buffer 320 may be implemented using various memory technologies suitable for storing two-dimensional mask data, including but not limited to DRAM, SRAM, or embedded memory integrated with processing components. The capacity and configuration of the vector memory buffer 320 may be selected based on the expected size and quantity of vector representation data that may be stored.

In some embodiments, the vector memory buffer 320 may be configured to store historic vector representations corresponding to previously generated BEV mask data. The vector memory buffer 320 may retain BEV mask information from previous processing iterations or time steps. In some embodiments, the historic vector representations may be used to provide consistency in generating new vector representations corresponding to BEV masks such as, for example, generating vector representations 326 associated with the fused mask 318. In some embodiments, the vector memory buffer 320 may store vector representations associated with a sequence of BEV masks corresponding to consecutive tile images. In response to processing a new tile image (e.g., the tile image 302), the vector fusion module 324 may access the historic vector representation data from the vector memory buffer 320 to inform the generation of the current vector representations 326. In some embodiments, accessing historical vector representation data from the vector memory buffer 320 may allow the system to leverage information from previous tile images to improve accuracy and consistency of the vector representations associated with BEV masks generated over time.

In some embodiments, the vector memory buffer 320 may be implemented as a FIFO buffer, which may enable the vector memory buffer 320 to maintain a sliding window of recent vector representation history. In some embodiments, the FIFO approach may ensure that the most recent observations may be retained while older data may be systematically removed, allowing for efficient analysis of the environment.

In some embodiments, the vector memory buffer 320 may be implemented as LIFO buffer, which may enable the vector generation system 306 to prioritize the most recent vector representation data. In some embodiments, the LIFO approach may ensure that the latest observations may be processed first, potentially allowing for more efficient handling of relevant information when generating updated vector representations 326 corresponding to one or more BEV masks—e.g., the mask 318.

In some embodiments, a size of the vector memory buffer 320 may be configurable based on the target length of context needed for a given application. For example, a larger buffer size may allow for a more extended historical view, which may be beneficial for detecting long-term trends or smoothing transient noise in the data associated with the historic vector representations. Additionally or alternatively, a smaller buffer size may reduce memory and computational overhead while still preserving context associated with vector representations corresponding to BEV masks corresponding to tile images that are adjacent to the tile image 302.

In some embodiments, the vector memory buffer 320 may store supplemental metadata associated with historical vector representations corresponding to each BEV mask. The metadata may include timestamps, positional information, and/or sensor-specific details that may aid in aligning past observations with current data. In some embodiments, incorporating such metadata, may help to generate improved data fusion across multiple time steps, ultimately improving a robustness and reliability of downstream generation of the vector representations 326 associated with the fused mask 318.

In some embodiments, the vector memory buffer 320 and the mask memory buffer 312 may be the same memory buffer. In some embodiments, for example, vector representations may be stored with the corresponding BEV mask in the shared memory buffer, which may allow for efficient storage and retrieval of associated mask and vector data.

In some embodiments, storing the vector representations 326 with the corresponding mask 318 in a shared memory buffer may enable direct access to both the mask 318 and vector representations 326 for a given tile image 302. Additionally or alternatively, the shared memory buffer may store metadata associated with each mask 318 and vector representation 326 pair. In some embodiments, the metadata may include information such as timestamps, geolocation data, or sensor configuration details. In some instances, additional context may be used by the mask fusion module 316 and vector fusion module 324 to improve the accuracy of fused results.

In some embodiments, the vector fusion module 324 may take the current vector representations 326 (e.g., the vector representations 326 associated with the fused mask 318) and historical vector representations and reconcile any differences. For example, in some embodiments, the vector fusion module 324 may apply weighted averaging to merge the current and historical vector data, with more recent frames potentially given higher weights. Additionally or alternatively, the vector fusion module 324 may analyze the consistency and continuity of vector representations across sequential frames. Any abrupt changes or discontinuities in the vector representations between frames may be smoothed or filtered by the vector fusion module 324.

In some embodiments, the vector fusion module 316 may employ machine learning techniques, such as recurrent neural networks (RNNs) or long short-term memory (LSTM) networks, to learn dependencies and patterns in the vector representations 326. In some embodiments, the machine learning models and/or neural networks may be trained to predict and reconcile differences between current and historical vector data based on learned patterns. In some embodiments, the vector fusion module 324 may also utilize confidence scores associated with each vector representation to weigh the importance of different inputs during the fusion process. Vector representations 326 with higher confidence scores may be given more weight in the reconciliation process.

In some embodiments, the vector fusion module 324 may generate vector representations 326 which may include any reconciled differences between vector representations 326 associated with the mask 318 and vector representations corresponding to one or more historical BEV masks stored in the vector memory buffer 320. In some embodiments, the vector representations 326 may provide a more robust and consistent representation of environmental features compared to vector representations 326 that may have been generated using individual BEV masks in isolation. In these or other embodiments, the vector representations 326 may be the same as and/or analogous to vector representations corresponding to the mask 110 and/or the vector representations 112 which may have been described and/or illustrated further in the present disclosure such as, for example, with respect to FIG. 1.

In some embodiments, the vector representations 326 may be overlaid on the fused mask 318. In some embodiments, a combination of the fused mask 318 and overlaid vector representations 326 may be sent to one or more other systems that may be configured to perform operations based thereon. For example, the combined fused mask 318 and vector representations 326 may be provided to an autonomous or semi-autonomous vehicle control system. In some instances, the control system may utilize the detailed environmental feature information contained in the combined mask 318 and vector representations 326 to assist with navigation, path planning, obstacle avoidance, or other autonomous driving functions. In other embodiments, the combined mask 318 and vector representations 326 may be sent to mapping systems, traffic monitoring systems, infrastructure planning systems, or other systems that may benefit from the detailed road and environmental feature information.

For example, an autonomous vehicle control system may receive the fused mask 318 and vector representations 326 to assist with localization and path planning. Continuing the example, the combination of the fused mask 318 and vector representations 326 may be used to determine the vehicle's position relative to lane markings, road boundaries, and other mapped features. In some embodiments, the localization data may then feed into the vehicle's path planning algorithms to generate safe and efficient routes.

As an additional example, a traffic monitoring system may use the fused mask and vector data to track vehicle movements and detect anomalies. The precise road geometry and feature information may allow the system to accurately monitor lane-level traffic patterns, identify vehicles crossing lane boundaries, and detect potential hazards like stopped vehicles.

Further, in yet another example, an HD mapping system may use the fused mask 318 and vector representations 326 as inputs to generate or update high-definition maps. The precise feature information may be used to create or refine map layers representing lane markings, road boundaries, traffic signs, and other key elements.

It should be understood that this and other arrangements described herein are set forth only as examples. Other arrangements, components, features, and elements (e.g., machines, interfaces, functions, orders, groupings of functions, etc.) may be used in addition to or instead of those shown, and some elements may be omitted altogether. Further, many of the arrangements, components, features, elements, etc. described herein are functional entities that may be implemented as discrete or distributed components or in conjunction with other components, and in any suitable combination and location (e.g., on a local device, vehicle, or machine at the edge, on-premises—such as locally hosted servers, remotely located—such as in one or more computing or server devices in one or more data centers in the cloud, and/or at other locations). Various functions described herein as being performed by entities may be carried out by hardware, firmware, and/or software. For instance, various functions may be carried out using one or more processors (e.g., central processing units (CPU(s)), graphics processing units (GPU(s)), microprocessors, microcontrollers, embedded processors, digital signal processors (DSPs), image signal processors (ISPs), physics processing units (PPUs), field-programmable gate arrays (FPGAs), accelerator(s) (e.g., deep learning accelerators (DLAs), deep learning accelerator cluster (XNNs), neural network accelerators (NNAs), and/or neural processing units (NPUs), programmable vision accelerators (PVAs), optical flow accelerators (OFAs), etc.), application specific integrated circuits (ASICs), data processing units (DPUs), quantum processors, etc.) executing instructions stored in memory. In some embodiments, the systems, methods, and processes described herein may be executed using similar components, features, and/or functionality to those of example machine 500 of FIGS. 5A-5E, example computing ecosystem 600 of FIG. 6, example generative language model system 700 of FIG. 7, and/or example computing device 800 of FIG. 8.

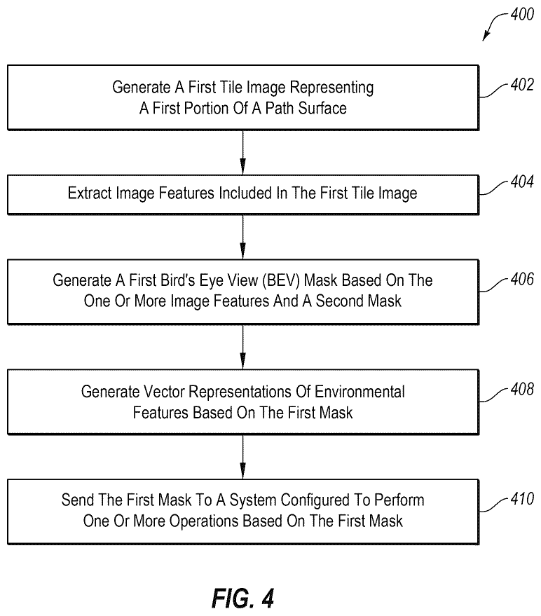

FIG. 4 is a flow diagram showing a method 400 for generating a mask and vector representations associated within a geographic area, in accordance with one or more embodiments of the present disclosure. The method 400 may be implemented by any suitable element of a machine, system, and/or collection of systems such as the mask generation system 104, the mask generation system 306, and/or the vector generation system 308, described and/or illustrated further in the present disclosure with respect to FIGS. 1 and 3. Although illustrated as discrete steps, various steps of the method 400 may be divided into additional steps, combined into fewer steps, or eliminated, depending on the desired implementation. Additionally, the order of performance of the different steps may vary depending on the desired implementation.

In some embodiments, the method 400 may include block 402. At block 402, a first tile image may be generated. In some embodiments, the first tile image may represent a first portion of a path surface corresponding to a geographic area. In some embodiments, the first tile image may be generated based on aggregated path surface data that may represent a top-down view of the path surface. In some embodiments, the aggregated path surface data may be generated or otherwise obtained based on sensor data that may be associated with the path surface corresponding to the geographic area.

In some embodiments, the aggregated path surface data may be generated using sensors positioned to capture top-down data relative to the path surface. For instance, one or more image sensors, LiDAR sensors, RADAR sensors, or other suitable sensors may be mounted or otherwise positioned above the ground plane associated with the path surface. These sensors may be arranged to collect data from an orthogonal or substantially orthogonal orientation relative to the ground plane, which may improve collection of data used to generate accurate surface mapping and decrease associated distortion that may be caused by oblique angles.

In some embodiments, the aggregated path surface data may include one or more of LiDAR depth point-cloud data, LiDAR intensity point-cloud data, or path surface color data. Other examples may include surface reflectivity data, thermal imaging data, multispectral or hyperspectral imaging data, surface texture information derived from structured light scanning, and RADAR backscatter data. In these or other embodiments, the types of data that may be included in the aggregated path surface data and the generation of such data may be described and/or illustrated further in the present disclosure such as, for example, with respect to FIGS. 1-3.

At block 404, one or more image features included in the first tile image may be extracted. In some embodiments, these image features may represent environmental characteristics associated with the portion of the path surface corresponding to the first tile image. For example, the one or more environmental features may include one or more of lane markers, curbs, medians, guardrails, barriers, pedestrian crosswalks, stop lines, speed bumps, or parking spaces. In these or other embodiments, extracting one or more image features may be performed using one or more systems such as, for example, the mask generation system 104 and/or the encoder system 304 that may be described and/or illustrated further in the present disclosure with respect to FIGS. 1 and 3.

At block 406, a first mask may be generated. In some embodiments, the first mask may be generated based on the one or more image features. Additionally or alternatively, the first mask may be generated based also on a second mask that may be generated based on a second tile image representing a second portion of the path surface. In some embodiments, the second portion of the path surface may include one or more of the image features that may also be included in the first tile image.

In some embodiments, generating the first mask may include applying a transformer decoder to the extracted image features. In some embodiments, the transformer decoder may be configured to analyze spatial relationships within the extracted features and predict one or more locations corresponding to environmental elements in the BEV representation. In these or other embodiments, generating the first mask may be performed using one or more systems such as, for example, the mask generation system 104 and/or the mask generation system 306 that may be described and/or illustrated further in the present disclosure with respect to FIGS. 1 and 3.

At block 408, one or more vector representations of environmental features may be generated. In some embodiments, the one or more vector representations may be derived, at least in part, from data and information included in the first mask. In some embodiments, the vector representations may encode structural and navigational elements of the path surface, which may enable efficient and scalable downstream processing.

For example, the one or more vector representations may indicate a position, orientation, curvature, or continuity of lane boundaries, road edges, crosswalks, or other path-related features. In some embodiments, rather than directly representing the features as raw pixel data, the vectors may abstract key characteristics, such as the directionality of lane dividers or the geometric properties of a road edge. This structured representation may allow for more efficient integration with HD maps and facilitate downstream tasks such as path planning, localization, and scene reconstruction in autonomous navigation systems. In these or other embodiments, the one or more vector representations may be generated using one or more systems described further in the present disclosure such as, for example, the mask generation system 104 and/or the vector generation system 308 described with respect to FIGS. 1 and 3.

At block 410, the first mask may be sent to one or more systems that may be configured to perform one or more operations based on the first mask. For example, the first mask may be sent to an autonomous vehicle's navigation system, which may use the first mask to update an understanding of the vehicle's surroundings and assist with real-time path planning and obstacle avoidance. In some embodiments, the first mask may also be used by mapping systems to refine HD maps or to detect changes in the environment, such as roadwork or new obstacles, that could affect navigation. Additionally or alternatively, the first mask may be transmitted to one or more monitoring systems for infrastructure maintenance, enabling automated detection of wear, damage, or other changes to road features.

Modifications, additions, or omissions may be made to the method 400 without departing from the scope of the present disclosure. For example, the outlined steps and operations are only provided as examples, and some of the steps and operations may be optional, combined into fewer steps and operations, or expanded into additional steps and operations without detracting from the essence of the disclosed embodiments.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, watercraft, shuttles (e.g., robotaxis), emergency response vehicles, motorcycles, electric or motorized bicycles, aircraft, construction vehicles, underwater craft (e.g., piloted or unpiloted submarines), drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets (e.g., NVIDIA's Omniverse), cloud computing, and/or any other suitable applications.

Disclosed embodiments may be comprised in a variety of different systems such as automotive systems (e.g., a control system for an autonomous or semi-autonomous machine, a perception system for an autonomous or semi-autonomous machine, etc.), systems implemented using a robot, aerial systems, medial systems, boating systems, smart area monitoring systems, systems for performing deep learning operations, systems for performing simulation operations, systems for performing digital twin operations, systems implemented using an edge device, systems implementing language models—such as large language models (LLMs), vision language models (VLMs), and/or multi-modal language models, systems using or deploying one or more inference microservices, systems that incorporate deploy one or more machine learning models in a service or microservice along with an OS-level virtualization package (e.g., a container), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

### Example Autonomous or Semi-Autonomous Machine

FIG. 5A is an example of sensor locations having corresponding fields of view or sensory fields for an autonomous or semi-autonomous vehicle 500a, an autonomous mobile robot (AMR) 500b, and a humanoid robot 500c, in accordance with some embodiments of the present disclosure. Although three types of machines 500 are illustrated, this is not intended to be limiting, and the machine(s) 500 described herein may include a vehicle, a car, a truck, a bus, a first responder vehicle, a shuttle, an electric or motorized bicycle, a motorcycle, a fire truck, a police or emergency vehicle, an ambulance, a watercraft, a construction vehicle, an underwater craft, a robot (e.g., AMR, humanoid, robotic arm, end-effector, forklift, etc.), a drone, an aircraft, a vehicle coupled to a trailer (e.g., a semi-tractor-trailer truck used for hauling cargo), and/or another type of vehicle or machine (e.g., that is unmanned and/or that accommodates one or more passengers). The vehicle 500a, AMR 500b, humanoid robot 500c, and/or other machine types may be referred to herein collectively as machine 500, in some instances.

With respect to vehicles 500A, autonomous and semi-autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The machine 500 may be capable of functionality in accordance with one or more of Level 3-Level 5 of the autonomous driving levels. The machine 500 may be capable of functionality in accordance with one or more of Level 1-Level 5 of the autonomous driving levels. For example, the machine 500 may be capable of driver assistance (Level 1), partial automation (Level 2, Level 2+, Level 2++), conditional automation (Level 3), high automation (Level 4), and/or full automation (Level 5), depending on the embodiment. The term “autonomous,” as used herein, may include any and/or all types of autonomy for the machine 500 or other machine, such as being fully autonomous, being highly autonomous, being conditionally autonomous, being partially autonomous, providing assistive autonomy, being semi-autonomous, being primarily autonomous, or other designation.

With respect to FIG. 5A, the sensors and their respective fields of view (not illustrated for clarity purposes) or sensory fields (not illustrated for clarity purposes) are one example embodiment and are not intended to be limiting. Although not illustrated, each sensor may have a corresponding field of view (e.g., a 360 degree field of view of a surround camera 568D, a 180 degree field of view of a wide-view camera 570, a 360 degree sensory field of a LiDAR sensor 564, etc.). For example, only a subset of the sensors illustrated may be included, additional sensors may be included, alternative sensors may be included, the number of each sensor modality may differ, the sensor modalities may differ (e.g., may not include LiDAR or RADAR, may include SONAR, thermal sensors, etc.), the sensor locations may be different from those illustrated on the vehicle 500a, AMR 500b, and/or humanoid robot 500c, etc. For example, with respect to the vehicle 500a, depending on the type (e.g., SUV, truck, sedan, robot, motorcycle, etc.), size (e.g., 18-wheeler, moving van, small sedan, etc.), and related functionality (e.g., L2 vs. L5), the locations, numbers, modalities, and/or other sensor information may differ. Similarly, for the AMR 500b and/or humanoid robot 500c, the shape, size, purpose, implementation, model, etc. may dictate the number and types of sensors used.

As illustrated in FIG. 1A, the autonomous or semi-autonomous vehicle 500A, the AMR 500B, and the humanoid robot 500C may include different sensor types, number, and locations. For a non-limiting example, the vehicle 500A may include twelve cameras 564, such as a front wide camera (e.g., 120 degree field of view (FOV)), a front telephoto camera (e.g., 30 degree fOV), a side rear left camera (e.g., 70 degree fOV), a side rear right camera (e.g., 70 degree fOV), a front fisheye camera (e.g., 200 degree fOV), a rear fisheye camera (e.g., 200 degree FOV), a left fisheye camera (e.g., 200 degree fOV), a right fisheye camera (e.g., 200 degree fOV), a front telephoto satellite camera (e.g., 30 degree fOV), a rear telephoto camera (e.g., 30 degree fOV), a cross left camera (e.g., 120 degree fOV), and a cross right camera (e.g., 120 degree fOV). The camera(s) 564 may use, in embodiments, a gigabit multimedia serial link (GMSL) interface—such as GMSL2—as input/output (I/O).

In some embodiments, although not illustrated in FIG. 5A, the vehicle 500A may include an in-cabin occupant and/or driver monitoring system, that may include various different sensors. For example, the in-cabin sensors may include various cameras 568, such as a driver monitoring camera (e.g., 55 degree fOV positioned forward of and facing toward the driver seat), a front occupant monitoring camera (e.g., 190 degree fOV positioned forward of and facing the front occupant(s) seat(s)), and a rear occupant monitoring camera (e.g., 190 degrees positioned forward of and facing the rear occupant(s) seat(s)). Similar to the external facing camera(s) 568, the internal camera(s) 568 may, in embodiments, use a GMSL (such as GMSL2) interface for I/O.

As another non-limiting example, the vehicle 500A may further include nine RADAR sensors 560. For example, the vehicle 500A may include a front center imaging RADAR sensor (e.g., 120 degree fOV or sensory field), a corner front left RADAR sensor (e.g., 160 degree fOV or sensory field), a corner front right RADAR sensor (e.g., 160 degree fOV or sensory field), a corner rear right RADAR sensor (e.g., 160 degree fOV or sensory field), a side left RADAR sensor (e.g., 160 degree fOV or sensory field), a side right RADAR sensor (e.g., 160 degree fOV or sensory field), a rear left RADAR sensor (e.g., 50 degree fOV or sensory field), and rear right RADAR sensor (e.g., 50 degree fOV or sensory field). The RADAR sensor(s) 560 may use, in embodiments, an Ethernet interface as I/O.

The vehicle(s) 500A may further include, as a non-limiting example, twelve ultrasonic sensors 562. As illustrated in FIG. 5A, the ultrasonic sensors may be positioned along the front and rear bumpers of the vehicle 500A, and along the side of the vehicle 500A, and may be used to detect objects (static and dynamic) in close proximity to the vehicle 500A. In some embodiments, the ultrasonic sensor(s) 562 may use a DS13 interface as I/O.

The vehicle(s) 500A may further include, as a non-limiting example, a LiDAR sensor 564, such as a front center LiDAR sensor (e.g., 120 degree horizontal FOV or sensory field and 30 degree vertical FOV or sensor field). In some embodiments, such as where additional or alternative LiDAR sensors are used, the LiDAR sensor may have differing horizontal and vertical fields of view or sensory fields. For example, a LiDAR sensor 564 may include a 360 degree horizontal FOV or sensory field (such as in a spinning LiDAR sensor) and a 90 degree vertical FOV or sensory field. In some embodiment, the LiDAR sensor(s) 564 may use an Ethernet interface as I/O.

The autonomous mobile robot (AMR) 500B may include, as a non-limiting example, three LiDAR sensors 564. For example, the top-most illustrated LiDAR sensor 564 may include a beam or 3D LiDAR sensor (e.g., 360 degree horizontal and 90 degree vertical FOV or sensory field), and the front and rear LiDAR sensors may include planar or 2D LiDAR sensors (e.g., 180 degree horizontal FOV or sensory field).

The AMR 500B may further include, as a non-limiting embodiment, eight cameras 568, such as a front stereo camera (e.g., 120 degree fOV), a rear stereo camera (e.g., 120 degree fOV), a left stereo camera (e.g., 120 degree fOV), a right stereo camera (e.g., 120 degree fOV), a front fisheye camera (e.g., 202 degree+−3 degree fOV), a rear fisheye camera (e.g., 202 degree+−3 degree fOV), a left fisheye camera (e.g., 202 degree+−3 degree fOV), and a right fisheye camera (e.g., 202 degree+−3 degree fOV).

The AMR 500B may further include a charging port, charging port contacts, a status indicator light, one or more (e.g., four) RGB LEDs, one or more IMU sensors 566, a magnetometer, and a barometer. The AMR 500B is capable of high-precision time synchronization between sensors using hardware time stamping, and PTP over Ethernet with less than 10 microseconds for sensor acquisition time. The AMR 500B provides simultaneous camera capture across all cameras 568 within 100 microseconds from a single hardware trigger, in embodiments, and can write to disk at 4 GB/second for sensor capture to bag writing (e.g., writing to ROSbags for the robot operation system (ROS)). As such, the AMR 500B is capable of running the ROS (such as NVIDIA's Isaac ROS), can be teleoperated (as described herein), can map an environment, and can navigate within an environment using visual cameras 568, LiDARs 564, and/or other sensor types or modalities.

The humanoid robot 500C may include, as a non-limiting example, one LiDAR sensor 564. For example, the LiDAR sensor 564 may include a beam or 3D LiDAR sensor (e.g., 360 degree horizontal and 90 degree vertical FOV or sensory field), or may include a planar or 2D LiDAR sensor (e.g., 180 degree horizontal FOV or sensory field).

The humanoid robot 500C may further include, as a non-limiting embodiment, four cameras 568, such as a front stereo camera (e.g., 120 degree fOV), a rear stereo camera (e.g., 120 degree fOV), a front fisheye camera (e.g., 202 degree+−3 degree fOV), and a rear fisheye camera (e.g., 202 degree+−3 degree fOV).

The humanoid robot 500C may further include, as a non-limiting embodiment, four ultrasonic sensors 562, such as a left arm ultrasonic sensor, a right arm ultrasonic sensor, a left leg ultrasonic sensor, and right leg ultrasonic sensor.

The humanoid robot 500C may further include any number of actuators—such as to allow control and maneuverability of joints. For example, the humanoid robot 500C may include actuators that allow for various degrees of freedom (DoF) depending on the design. In a non-limiting embodiment, the humanoid robot 500C may have 40 total degrees of freedom (DoF) (e.g., 6 DoF×2 for the arms, 6 DoF×2 for the hands, 6 DoF×2 for the legs, 2 DoF for the torso, and 2 DoF for the neck). The actuators may convert energy into physical motion, allowing for actions such as joint movements, locomotion, and gripping/manipulation. For example, joint movements may be performed using motors and servos to control the rotation of joints in an arm or manipulator, and to allow for reaching, grabbing, and manipulating objects. Locomotion may be accomplished using wheels, tracks, or other locomotion devices (robotic legs) to move around the environment. Gripping and manipulation may be performed using end-effectors or hands/fingers, which may be equipped with actuators to grip objects, apply force, and perform specific tasks. In some examples, the humanoid robot 500C may include position and orientation sensors, such as encoders, gyroscopes, and the like, to determine the position of the robot 500C in space, allowing for location determination and movement tracking. The humanoid robot 500C may include force and pressure sensors, in embodiments, to detect environment interactions, allowing the robot 500C to grasp objects with the right force and to avoid obstacles along the way. The perception sensors (e.g., cameras, LiDARs, RADARs, ultrasonic, SONAR, etc.) may be used along with tactile sensors to allow the robot 500C to perceive objects, shapes, and textures, and to understand when touch is initiated and stopped (along with force sensors that regulate the force used during touch). As a non-limiting example, the humanoid robot 500C may have a height of about 1-2 meters (e.g., 1.7 meters or 5′ 6″), a weight of 50-70 kg, be capable of moving at a speed of 8 or more km/h, and be able to carry payloads anywhere from 20-100 kg, depending on the design and requirements of the system.

The humanoid robot 500C, in embodiments, may include a conversational system—such as a conversational system powered by language models (e.g., LLMs, VLMs, MMLMs, VLAs, etc.)—in order to help understand the environment, reason, and communicate with humans, animals, devices, and/or other robots, and/or make planning, control, and navigation decisions. As such, in addition to performing various tasks, the humanoid robot 500C may use onboard sensors, microphones, and speakers to understanding speech, audio and visual cues, etc., while also being able to communicate back to the environment.

With reference to cameras 568 of the machine(s) 500, the camera types for the cameras 568 may include, but are not limited to, digital cameras that may be adapted for use with the components and/or systems of the machine 500. For a vehicle 500a implementation, the camera(s) 568 may operate at automotive safety integrity level (ASIL) B and/or at another ASIL. The camera types may be capable of any image capture rate, such as 30 frames per second (fps), 60 fps, 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

Cameras with a field of view that include portions of the environment in front of the machine 500 (e.g., front-facing cameras) may be used for surround view, to help identify forward facing paths and obstacles, as well aid in, with the help of one or more controllers 536 and/or control SoCs, providing information critical to generating an occupancy grid and/or determining the preferred machine movements, trajectories, and/or paths. Front-facing cameras may be used to perform many of the same ADAS functions as LiDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 568B that may be used to perceive objects coming into view from the periphery (e.g., pedestrians, warehouse vehicles, other robots, crossing traffic, or bicycles). In addition, any number of long-range camera(s) 568E (e.g., a long-view stereo camera pair) may be used for depth-based object detection, especially for objects for which a neural network has not yet been trained. The long-range camera(s) 568E may also be used for object detection and classification, as well as basic object tracking.

Any number of stereo cameras 568A may also be included in a front-facing and/or other (e.g., rear-facing) configuration. In at least one embodiment, one or more of stereo camera(s) 568A may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the machine's 500 environment, including a distance estimate for points in the image (e.g., a disparity or depth image). An alternative stereo camera(s) 568A may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 568A may be used in addition to, or alternatively from, those described herein. For example, in some embodiments, stereo depth estimation may be performed using other than stereo cameras, such as two monocular cameras having at least partially overlapping fields of view.

Cameras with a field of view that include portions of the environment to the side of the machine 500 (e.g., side-view cameras) may be used, for example, for surround view, providing information used to create and update the occupancy grid, as well as to generate side impact collision warnings and/or to indicate to an AMR 500B or humanoid robot 500C, for example, that there are objects, features, and/or persons present to the side. For example, surround camera(s) 568D may be positioned on the machine 500. The surround camera(s) 568D may include wide-view camera(s) 568B, fisheye camera(s), 360 degree camera(s), and/or the like. For example, four fisheye cameras may be positioned on the machine's 500 front, rear, and sides. In an alternative arrangement, the machine 500 may use three surround camera(s) 568D (e.g., left, right, and rear), and may leverage one or more other camera(s) (e.g., a forward-facing camera) as a fourth surround view camera.

Cameras 568 with a field of view that include portions of the environment to the rear of the machine 500 (e.g., rear-view cameras) may be used for gaining an understanding of objects, features, persons, and/or other information to the rear of the machine 500, such as for park assistance, surround view, rear collision warnings, planning, control, and navigation determinations, and/or creating and updating an occupancy grid, BEV image representing the environment, height map, etc. A wide variety of cameras 568 may be used including, but not limited to, cameras 568 that are also suitable as a front-facing camera(s) (e.g., long-range and/or mid-range camera(s) 568E, stereo camera(s) 568A), infrared camera(s) 568C, etc.), rear-facing camera(s), side-facing camera(s), downward facing camera(s), upward facing camera(s), and/or the like, as described herein.

Similarly, for LiDAR sensors 564, RADAR sensors 560, ultrasonic sensors 562, and/or other sensor modalities or types, the location and placement of the sensors, and their corresponding fields of view or sensory fields may be determined based on the use case, implementation, or design of the particular machine 500.

For example, the machine(s) 500 include RADAR sensor(s) 560 that may be used by the machine 500 for long-range object detection, even in darkness and/or severe weather conditions. RADAR functional safety levels may be ASIL B, in embodiments. The RADAR sensor(s) 560 may use the CAN and/or the bus 502 (e.g., to transmit data generated by the RADAR sensor(s) 560) for control and to access object tracking data, with access to Ethernet to access raw data in some examples. A wide variety of RADAR sensor types may be used. For example, and without limitation, the RADAR sensor(s) 560 may be suitable for front, rear, and side RADAR use. In some example, Pulse Doppler RADAR sensor(s) are used.

The RADAR sensor(s) 560 may include different configurations, such as long range with narrow field of view, short range with wide field of view, short range side coverage, etc. In some examples, long-range RADAR may be used for adaptive cruise control (ACC) functionality. The long-range RADAR systems may provide a broad field of view realized by two or more independent scans, such as within a 250 m range. The RADAR sensor(s) 560 may help in distinguishing between static and moving objects, and may be used by ADAS systems for emergency brake assist and forward collision warning, by robots for detecting dynamic objects in various environments—such as those with lower or no lighting. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the machine's 500 surroundings at higher speeds with minimal interference from the periphery (e.g., from traffic in adjacent lanes). The other two antennae may expand the field of view, making it possible to quickly detect objects entering or leaving the machine's immediate path (e.g., lane).

Mid-range RADAR systems may include, as an example, a range of up to 560 m (front) or 80 m (rear), and a field of view of up to 42 degrees (front) or 150 degrees (rear). Short-range RADAR systems may include, without limitation, RADAR sensors designed to be installed at both ends of a lateral surface (e.g., a rear bumper) such that two beams may be used to constantly monitor the blind spot in the rear and next to the machine 500 (e.g., vehicle, robot, etc.). As such, short-range RADAR systems may be used in an ADAS system for blind spot detection and/or lane change assist.

The machine 500 may further include ultrasonic sensor(s) 562. The ultrasonic sensor(s) 562, which may be positioned at the front, back, and/or the sides of the machine 500, may be used for assisting with near-field perception, such as for park assist, collision avoidance (e.g., for robotic parts), and/or to create and update an occupancy grid, evidence grid map (EGM), height map, BEV image, and/or other representation of objects and features in an environment of the machine 500. A wide variety of ultrasonic sensor(s) 562 may be used, and different ultrasonic sensor(s) 562 may be used for different ranges of detection (e.g., 2.5 m, 4 m). The ultrasonic sensor(s) 562 may operate at functional safety levels of ASIL B, as an example.

The machine 500 may include LiDAR sensor(s) 564. The LiDAR sensor(s) 564 may be used for object and feature detection, pedestrian and other robot detection, emergency braking, collision avoidance, simultaneous localization and mapping (SLAM), free-space detection, and/or other functions. The LiDAR sensor(s) 564 may be functional safety level ASIL B, in embodiments. In some examples, the machine 500 may include multiple LiDAR sensors 564 (e.g., two, four, six, etc.) that may use Ethernet (e.g., to provide data to a Gigabit Ethernet switch).

In some examples, the LiDAR sensor(s) 564 may be capable of providing a list of objects and their distances for a 360-degree field of view. Commercially available LiDAR sensor(s) 564 may have an advertised range of approximately 500 m, with an accuracy of 2 cm-3 cm, and with support for a 500 Mbps Ethernet connection, for example. In some examples, one or more non-protruding LiDAR sensors 564 may be used. In such examples, the LiDAR sensor(s) 564 may be implemented as a small device that may be embedded into the front, rear, sides, top, and/or corners of the machine 500. The LiDAR sensor(s) 564, in such examples, may provide up to a 120-degree horizontal and 35-degree vertical field-of-view, with a 200 m range even for low-reflectivity objects. Front-mounted LiDAR sensor(s) 564 may be configured for a horizontal field of view between 45 degrees and 135 degrees.

In some examples, LiDAR technologies, such as 3D flash LiDAR, may also be used. 3D Flash LiDAR uses a flash of a laser as a transmission source, to illuminate vehicle surroundings up to approximately 200 m. A flash LiDAR unit includes a receptor, which records the laser pulse transit time and the reflected light on each pixel, which in turn corresponds to the range from the vehicle to the objects. Flash LiDAR may allow for highly accurate and distortion-free images of the surroundings to be generated with every laser flash. In some examples, four flash LiDAR sensors may be deployed, one at each side of the machine 500. Available 3D flash LiDAR systems include a solid-state 3D staring array LiDAR camera with no moving parts other than a fan (e.g., a non-scanning LiDAR device). The flash LiDAR device may use a 5 nanosecond class I (eye-safe) laser pulse per frame and may capture the reflected laser light in the form of 3D range point clouds and co-registered intensity data. By using flash LiDAR, and because flash LiDAR is a solid-state device with no moving parts, the LiDAR sensor(s) 564 may be less susceptible to motion blur, vibration, and/or shock.

FIG. 5B is an illustration of sensor and component locations of an example autonomous or semi-autonomous vehicle 500A (alternatively referred to herein as “vehicle 500,” “ego-vehicle 500,” “ego-machine 500,” or “machine 500,”), in accordance with some embodiments of the present disclosure. Although the vehicle 500A is illustrated, this is not intended to be limiting, and similar components and/or sensors may be included on any other machine type without departing from the scope of the present disclosure. For example, similar sensors and/or components may be used for a vehicle, a car, a truck, a bus, a first responder vehicle, a shuttle, an electric or motorized bicycle, a motorcycle, a fire truck, a police vehicle, an ambulance, a watercraft, a construction vehicle, an underwater craft, a robot (e.g., AMR, humanoid, robotic arm, end-effector, forklift, etc.), a drone, an aircraft, a vehicle coupled to a trailer (e.g., a semi-tractor-trailer truck used for hauling cargo), and/or another type of vehicle or machine (e.g., that is unmanned and/or that accommodates one or more passengers).

FIG. 5C is a block diagram of an example system architecture for a machine 500, such as autonomous or semi-autonomous vehicle 500A, autonomous mobile robot (AMR) 500B, humanoid robot 500C, and/or other types of machines, in accordance with some embodiments of the present disclosure. It should be understood that this and other arrangements described herein are set forth only as examples. Other arrangements, components, features, and elements (e.g., machines, interfaces, functions, orders, groupings of functions, etc.) may be used in addition to or instead of those shown, and some elements may be omitted altogether. Further, many of the arrangements, components, features, elements, etc. described herein are functional entities that may be implemented as discrete or distributed components or in conjunction with other components, and in any suitable combination and location (e.g., on a local device, vehicle, or machine at the edge, on-premises—such as locally hosted servers, remotely located—such as in one or more computing or server devices in one or more data centers in the cloud, and/or at other locations). Various functions described herein as being performed by entities may be carried out by hardware, firmware, and/or software. For instance, various functions may be carried out using one or more processors (e.g., central processing units (CPU(s)), graphics processing units (GPU(s)), microprocessors, microcontrollers, embedded processors, digital signal processors (DSPs), image signal processors (ISPs), physics processing units (PPUs), field-programmable gate arrays (FPGAs), accelerator(s) (e.g., deep learning accelerators (DLAs, deep learning accelerator cluster (XNNs), neural network accelerators (NNAs), and/or neural processing units (NPUs), programmable vision accelerators (PVAs), optical flow accelerators (OFAs), etc.), application-specific integrated circuits (ASICs), data processing units (DPUs), quantum processors, etc.) executing instructions stored in memory. In some embodiments, the systems, methods, and processes described herein may be executed using similar components, features, and/or functionality to those of example machine 500 of FIGS. 5A-5E, example computing ecosystem 600 of FIG. 6, example generative language model system 700 of FIG. 7, and/or example computing device 800 of FIG. 8.

Each of the components, features, and systems of the machine 500 in FIG. 5C are illustrated as being connected via bus 502 (alternatively referred to as a “machine communications network 502,” or just “communications network 502”). The bus 502 may include a Controller Arca Network (CAN) data interface (alternatively referred to herein as a “CAN bus”). A CAN may be a network inside the machine 500 used to aid in control of various features and functionality of the machine 500, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant. In some embodiments, in addition to or alternatively from a CAN bus, the bus 502 may include FlexRay, an embedded bus (e.g., SPI, 12 C), local interconnect link (LIN), NVIDIA's NVLink, USB (2.0, 3.0, onward), radio frequency (RF), Ethernet (e.g., 10BASE/100BASE, 1000BASE, 10G, etc.), and/or another communication protocol or functionality. Additionally, although a single line is used to represent the bus 502, this is not intended to be limiting. For example, there may be any number of busses 502, which may include one or more CAN busses, one or more FlexRay busses, one or more Ethernet busses, and/or one or more other types of busses using a different protocol. In some examples, two or more busses 502 may be used to perform different functions, and/or may be used for redundancy. For example, a first bus 502 may be used for collision avoidance functionality and a second bus 502 may be used for actuation control. In any example, each bus 502 may communicate with any of the components of the machine 500, and two or more busses 502 may communicate with the same components. In some examples, each SoC 504, each controller 536, and/or each computer or compute engine within the machine 500 may have access to the same input data (e.g., inputs from sensors of the machine 500), and may be connected to a common bus, such as a CAN bus.

The machine 500 may include components such as a chassis, a vehicle body, wheels (e.g., 2, 4, 6, 8, 18, etc.), tires, axles, batteries, side-view mirrors, and/or other components of a vehicle or machine. The machine 500 may include a propulsion system 550, such as an internal combustion engine, hybrid electric power plant, an all-electric engine, a hydrogen-fueled engine, and/or another propulsion system type. The propulsion system 550 may be connected to a drive train of the machine 500, which may include a transmission, to enable the propulsion of the machine 500. The propulsion system 550 may be controlled in response to receiving signals from the throttle/accelerator 552.

A steering system 554, which may include a steering wheel and/or other steering device (e.g., remote steering and/or local steering), may be used to steer the machine 500 (e.g., along a desired path or route) when the propulsion system 550 is operating (e.g., when the vehicle is in motion). The steering system 554 may receive signals from a steering actuator 556. In some embodiments, a steering wheel or other steering mechanism may not be included, such as for a machine 500 capable of full automation (e.g., Level 5) functionality.

The brake sensor system 546 may be used to operate the vehicle brakes in response to receiving signals from the brake actuators 548 and/or brake sensors.

The machine 500 may include one or more controller(s) 536, such as those described herein with respect to FIG. 5A. The controller(s) 536 may be used for a variety of functions, and may be coupled to any of the various other components and systems of the machine 500. For example, the controllers 536 may be used for control of the machine 500, artificial intelligence executing on the machine 500, infotainment for the machine 500, and/or the like. For example, one controller 536 may be used for some or all of the functionality, or different controllers 536 may be used for different functionalities—e.g., to ensure availability and a safety separation between various controllers for different tasks. For example, the controller(s) 536 may use plans computed by the system—e.g., paths or trajectories for vehicles 500A or AMRs 500B, or movements, components trajectories, movement locations or displacements, etc. for joints or components (e.g., of manipulators, end effectors, limbs, hands, fingers, legs, fect, etc.), of a humanoid robot 500C—to control the machine(s) 500 in the environment. In some instances, the controller(s) 536 may include a proportional-integral-derivative (PID) controller, a fuzzy logic controller, a neural controller (e.g., a controller embodied as one or more neural networks), a force control controller, a programmable logic controller (PLC), and/or another type of controller. In a humanoid robot 500C, for example, the controller(s) 536 may act as the brain, responsible for analyzing sensor data, making decisions, and sending commands to the actuators. The controller(s) 536 may include a low-level controller that handles basic motor control, ensuring accurate and precise movements of individual joints and actuators. The controller(s) 536 may include a high-level controller to coordinate multiple actuators and sensors, planning complex motions and adapting to changing environments.

The controller(s) 536 may include an artificial intelligence controller, in embodiments, that may use AI algorithms (e.g., DNNs, MLMs, etc.) to learn, make decisions, and autonomously perform tasks for the machine 500. In some embodiments, the controller(s) 536 may use an open-loop control algorithm that is fixed and does not adjust actions to the environment. In other embodiments, closed-loop control may be used that incorporates feedback mechanisms to monitor the robot's performance and make necessary adjustments. In examples, the controller(s) 536 may implement reactive control in order to respond directly to sensory inputs, allowing for quick reflexes and real-time changes. Further, deliberative control may be implemented in some examples, using internal models and planning algorithms to generate high-level actions, which may be suited for complex tasks that require reasoning, decision making, and long-term planning.

Controller(s) 536, which may include one or more systems on chip (SoCs) 504 (FIGS. 5C and 5D), CPUs, GPU(s), accelerator(s), etc., may provide signals (e.g., representative of commands or messages) to one or more components and/or systems of the machine 500. Although the controller(s) 536 is listed separately from the SoC(s) 504, this is not intended to be limiting, and in some embodiments one or more components of the SoC(s) 504 may perform the operations of the controller(s) 536. For example, the controller(s) may send signals to operate the machine brakes via one or more brake actuators 548, to operate the steering system 554 via one or more steering actuators 556, to operate the propulsion system 550 via one or more throttle/accelerators 552, ctc. The controller(s) 536 may include one or more onboard (e.g., integrated) computing devices (e.g., supercomputers) that process sensor signals, and output operation commands (e.g., signals representing commands) to enable autonomous or semi-autonomous navigation and movement and/or to assist a human operator using the machine 500. The controller(s) 536 may include a first controller 536 for autonomous control and navigation functions, a second controller 536 for functional safety functions, a third controller 536 for artificial intelligence functionality (e.g., computer vision), a fourth controller 536 for infotainment functionality, a fifth controller 536 for redundancy in emergency conditions, and/or other controllers. For example, the hardware used for safety monitoring and other safety functions (such as a functional safety island) may be discrete or partitioned (physically or via separation of processing) with respect to hardware used for processing sensor data for perception and making vehicle control decisions. Similarly, hardware (e.g., a controller, an SOC, etc.) for controlling in-vehicle infotainment and/or in-cabin monitoring may be discrete or separate from the hardware used for vehicle perception and control. In some examples, a single controller 536 may handle two or more of the above functionalities, two or more controllers 536 may handle a single functionality, and/or any combination thereof.

The controller(s) 536 may provide the signals for controlling one or more components and/or systems of the machine 500 in response to sensor data received from one or more sensors (e.g., sensor inputs). The sensor data may be received from, for example and without limitation, global navigation satellite systems (“GNSS”) sensor(s) 558 (e.g., Global Positioning System sensor(s)), RADAR sensor(s) 560, ultrasonic sensor(s) 562, LiDAR sensor(s) 564, inertial measurement unit (IMU) sensor(s) 566 (e.g., accelerometer(s), gyroscope(s), magnetic compass(es), magnetometer(s), etc.), microphone(s) 596, camera(s) 568 (e.g., stereo camera(s) 568A, wide-view camera(s) 568B (e.g., fisheye cameras), infrared camera(s) 568C, surround camera(s) 568D (e.g., 360 degree cameras), long-range and/or mid-range camera(s) 568E, and/or other camera types), speed sensor(s) 544 (e.g., for measuring the speed of the machine 500), vibration sensor(s) 542, steering sensor(s) 540, brake sensor(s) (e.g., as part of the brake sensor system 546), actuators, and/or other sensor types.

One or more of the controller(s) 536 may receive inputs (e.g., represented by input data) from an instrument cluster 532 of the machine 500 and provide outputs (e.g., represented by output data, display data, etc.) via a human-machine interface (HMI) display 534 (e.g., screen, heads-up display, mirror display, facial display, robotic display, etc.), an audible annunciator, a loudspeaker, a speaker, and/or via other components of the machine 500. The outputs may include information such as machine velocity, speed, time, map data corresponding to a map(s) 522 of FIG. 5C (e.g., from a navigation map, a Standard Definition (SD) map, a High Definition (“HD”) map, etc.), location data (e.g., the machine's 500 location, such as on a map 522), direction, location of other vehicles (e.g., an occupancy map, height map, bird's eye view (BEV) image, grid, etc.), information about objects and status of objects as perceived by the system, system status information, etc. For example, the HMI display(s) 534 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The machine 500 may include one or more systems on a chip (SoCs) 504 (described in more detail in FIG. 5D). The SoC(s) 504 may include CPU(s) 506, GPU(s) 508, processor(s) 510, cache(s) 512, accelerator(s) 514, data store(s) 516, and/or other components and features. The SoC(s) 504 may be used to process and provide data for various operations, such as navigation, planning, reasoning, inference, perception, control, and/or actuation operations of the machine 500 in a variety of platforms and systems. For example, the SoC(s) 504 may process live perception data (e.g., from camera, LiDAR, RADAR, ultrasonic, etc.) in addition to map data corresponding to one or more maps 522 (e.g., HD map, SD map, navigational map, occupancy map, etc.) in order to make or aid in performing various operations of the machine 500. Where a map and/or AI is used, map and/or AI (e.g., model parameter updates, fine-tuning, etc.) refreshes and/or updates via a network interface 524 from one or more servers (e.g., server(s) 578 of FIG. 5E)—such as one or more servers of a cloud-based data center.

Although an SoC(s) 504 is illustrated throughout FIGS. 5A-5E, additional or alternative components and/or architectures may be used—such as multi-chip modules (MCMs), application-specific integrated circuits (ASICs), system-in-packages (SiPs), field programmable gate arrays (FPGAs), heterogeneous integration (HI), single-board computers (SBCs)—without departing from the scope of the present disclosure. For example, depending on the type of machine 500, use of the machine 500, model of the machine 500, and required capabilities of the machine 500, one or more SoCs 504 and/or alternative architectures and/or components may be used to satisfy the particular implementation.

The machine 500 may include a CPU(s) 518 (e.g., discrete CPU(s), or dCPU(s)), that may be coupled to the SoC(s) 504 via a high-speed interconnect (e.g., PCIe). The CPU(s) 518 may include an X86 processor, for example. The CPU(s) 518 may be used to perform any of a variety of functions, including arbitrating potentially inconsistent results between ADAS sensors and the SoC(s) 504, and/or monitoring the status and health of the controller(s) 536 and/or infotainment SoC 530, for example.

The machine 500 may include a GPU(s) 520 (e.g., discrete GPU(s), or dGPU(s)), that may be coupled to the SoC(s) 504 via a high-speed interconnect (e.g., NVIDIA's NVLink). The GPU(s) 520 may provide additional artificial intelligence functionality, such as by executing redundant and/or different neural networks, and may be used to train and/or update neural networks based on input (e.g., sensor data) from sensors of the machine 500.

The machine 500 may further include the network interface 524 which may include one or more wireless antennas 526 and/or modems (e.g., one or more wireless antennas for different communication protocols, such as a cellular antenna, a Bluetooth antenna, etc.). The network interface 524 may be used to enable wireless connectivity over the Internet with the cloud (e.g., with the server(s) 578 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the machine 500 information about vehicles in proximity to the machine 500 (e.g., vehicles in front of, on the side of, and/or behind the machine 500). This functionality may be part of a cooperative adaptive cruise control functionality of the machine 500.

The network interface 524 may include a SoC that provides modulation and demodulation functionality and enables the controller(s) 536 to communicate over wireless networks. The network interface 524 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. For example, the network interface 524 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), fifth generation of mobile communications technology (5G), sixth generation of mobile communications technology (6G), and/or other cellular and/or wireless communication standards. The wireless antenna(s) 526 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

The machine 500 may further include data store(s) 528 which may include off-chip (e.g., off the SoC(s) 504) storage. The data store(s) 528 may include one or more storage elements including RAM, SRAM, DRAM, VRAM, Flash, hard disks, and/or other components and/or devices that may store at least one bit of data.

The machine 500 may further include GNSS sensor(s) 558. The GNSS sensor(s) 558 (e.g., GPS, assisted GPS sensors, differential GPS (DGPS) sensors, etc.), to assist in mapping, perception, occupancy grid generation, and/or path planning functions. Any number of GNSS sensor(s) 558 may be used, including, for example and without limitation, a GPS using a USB connector with an Ethernet to Serial (RS-232) bridge.

The machine 500 may further include IMU sensor(s) 566. The IMU sensor(s) 566 may be located at a center of the rear axle of the machine 500, in some examples. The IMU sensor(s) 566 may include, for example and without limitation, an accelerometer(s), a magnetometer(s), a gyroscope(s), a magnetic compass(es), and/or other sensor types. In some examples, such as in six-axis applications, the IMU sensor(s) 566 may include accelerometers and gyroscopes, while in nine-axis applications, the IMU sensor(s) 566 may include accelerometers, gyroscopes, and magnetometers.

In some embodiments, the IMU sensor(s) 566 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 566 may enable the machine 500 to estimate heading without requiring input from a magnetic sensor by directly observing and correlating the changes in velocity from GPS to the IMU sensor(s) 566. In some examples, the IMU sensor(s) 566 and the GNSS sensor(s) 558 may be combined in a single integrated unit.

The vehicle may include one or more microphone 596 placed in and/or around the machine 500. The microphone(s) 596 may be used for emergency vehicle detection and identification, among other things.

The machine 500 may further include vibration sensor(s) 542. The vibration sensor(s) 542 may measure vibrations of components of the machine, such as the arms or legs of a humanoid robot 500C, or the axle(s) of a vehicle 500A or AMR 500B. For example, changes in vibrations may indicate a change in road, walking, or traversable surfaces. In another example, when two or more vibration sensors 542 are used, the differences between the vibrations may be used to determine friction or slippage of the surface (e.g., when the difference in vibration is between a power-driven axle and a freely rotating axle).

The machine 500 may include an ADAS system 538—such as when the machine 500 is a vehicle 500A. The ADAS system 538 may include a dedicated SoC(s), in some examples. The ADAS system 538 may include autonomous/adaptive/automatic cruise control (ACC), cooperative adaptive cruise control (CACC), forward crash or collision warning (FCW), automatic emergency braking (AEB), lane departure warning (LDW), lane keep assist (LKA), blind spot warning (BSW), blind spot monitoring (BSM), rear cross-traffic warning (RCTW), pedestrian detection, driver monitoring, collision warning systems (CWS), traffic sign recognition, speed limit detection, automatic parking, lane centering (LC), high beam safety system, and/or other features and functionality.

The machine 500 may further include the infotainment SoC 530 (e.g., an in-vehicle infotainment system (IVI)). Although illustrated and described as a SoC, the infotainment system may not be an SoC, and may include one or more discrete components, such as multi-chip modules (MCMs), application-specific integrated circuits (ASICs), system-in-packages (SiPs), heterogeneous integration (HI), single-board computers (SBCs), etc. The infotainment SoC 530 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., wireless, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the machine 500. For example, the infotainment SoC 530 may radios, disk players, navigation systems, video players, USB and Bluetooth connectivity, carputers, in-car entertainment, Wi-Fi, steering wheel audio controls, hands free voice control, a heads-up display (HUD), an HMI display 534, a telematics device, a control panel (e.g., for controlling and/or interacting with various components, features, and/or systems), and/or other components. The infotainment SoC 530 may further be used to provide information (e.g., visual and/or audible) to a user(s) of the vehicle, such as information from the ADAS system 538, autonomous driving information such as planned vehicle maneuvers, trajectories, surrounding environment information (e.g., intersection information, vehicle information, road information, etc.), and/or other information.

The infotainment SoC 530 may include GPU functionality. The infotainment SoC 530 may communicate over the bus 502 (e.g., CAN bus, Ethernet, etc.) with other devices, systems, and/or components of the machine 500. In some examples, the infotainment SoC 530 may be coupled to a supervisory MCU such that the GPU of the infotainment system may perform some self-driving functions in the event that the primary controller(s) 536 (e.g., the primary and/or backup computers of the machine 500) fail. In such an example, the infotainment SoC 530 may put the machine 500 into a chauffeur to safe stop mode, as described herein.

In some embodiments, the infotainment system may provide a digital or virtual assistant, that may be voice only, or may have a visual component (e.g., in the form of a digital human or digital avatar). The assistant may provide basic functions, like texting, adjusting vehicle settings, music or video control, navigation features, etc., and/or may provide more advanced features such as those supported by one or more language models—such as large language models (LLMs), vision language models (VLMs), multi-modal language models (MMLMs), etc. For example, the driver and/or occupants may be able to interact with the assistant similar to how a user may interact with a language model, such as to ask general questions, specific questions, to request restaurant, gas station, and/or other recommendations and/or locations, to learn about the vehicle functionality or troubleshooting (e.g., to ask tire pressure information, oil change information, battery exchange information, etc.). As such, the machine 500—whether a vehicle 500A, AMR 500B, humanoid robot 500C, and/or other type of machine—may include a locally stored language model(s) and/or communicate to a remotely hosted language model (e.g., via one or more APIs) to provide more detailed and in-depth communication features to the users of the machine(s) 500.

In some examples, an infotainment SoC 530, the SoC(s) 104, and/or another SoC or computing/processing system may perform in-cabin driver and/or occupant monitoring. For example, the computing system may perform facial recognition and vehicle owner identification may use data from camera and/or other sensors to identify the presence of an authorized driver and/or owner of the machine 500. The always on sensor processing engine may be used to unlock the vehicle when the owner approaches the driver door and turn on the lights, and, in security mode, to disable the vehicle when the owner leaves the vehicle. In this way, the SoC(s) 504 provide for security against theft and/or carjacking.

In some embodiments, an in-cabin monitoring camera sensor may be monitored using one or more neural networks running on another or dedicated SoC—such as an in-vehicle infotainment or in-vehicle monitoring SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. The in-cabin system may further include one or more in-cabin AI agents or assistants, which may use one or more APIs or plug-ins to interact with one or more LLMs, VLMs, MMLMs, etc. in the cloud. For example, the in-cabin AI agents or assistants may provide directions, vehicle or machine feedback information, answer general questions, handle music/video and/or other requests, activate windows, doors, and/or other vehicle components, etc. As such, one or more dedicated SoCs and/or sets of processors may be used to perform the in-cabin infotainment and/or in-cabin monitoring (e.g., as an occupant monitoring system (OMS)) for the machine 500.

The machine 500 may further include an instrument cluster 532 (e.g., a digital dash, an electronic instrument cluster, a digital instrument panel, etc.). The instrument cluster 532 may include a controller and/or supercomputer (e.g., a discrete controller or supercomputer). The instrument cluster 532 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 530 and the instrument cluster 532. In other words, the instrument cluster 532 may be included as part of the infotainment SoC 530, or vice versa.

FIG. 5D is a block diagram of an example architecture of a computing system (a subset of the system described with respect to FIG. 5C), in accordance with at least some embodiments of the present disclosure. Although illustrated as an SoC(s) 504, this is not intended to be limiting, and the computing system may additionally or instead include multi-chip modules (MCMs), application-specific integrated circuits (ASICs), system-in-packages (SiPs), heterogeneous integration (HI), single-board computers (SBCs), and/or other components and/or architectures, without departing from the scope of the present disclosure.

The SoC(s) 504 may be an end-to-end platform with a flexible architecture that spans automation levels 2-5, or the SoC(s) 504 may be specifically designed for a specific automation level (e.g., a first SoC 504 for level 2 to level 2++, a second SoC 504 for level 3, a third SoC 504 for level 4, etc.), thereby providing a comprehensive functional safety architecture that leverages and makes efficient use of computer vision, neural network inferencing, robotic planning, control, and navigation, ADAS techniques, and the like, with diversity and redundancy, to provide a platform for a flexible, reliable driving or robotic control software stack, along with deep learning tools. The SoC(s) 504 may be faster, more reliable, and even more energy-efficient and space-efficient than conventional systems. For example, the accelerator(s) 514, when combined with the CPU(s) 506, the GPU(s) 508, and the data store(s) 516, may provide for a fast, efficient platform for level 2-5 autonomous vehicles as well as for safe planning, navigation, and control of AMRs 500B, humanoid robots 500C, and/or other robot or machine types.

In some embodiments, such as where the SoC(s) 504 include a GPU 508 with 2000 or more cores (e.g., 2048 cores), 60 or more tensor cores (e.g., 64 tensor cores), and a GPU max frequency of over 1 GHZ (e.g., 1.3 GHZ), a CPU 506 including 10 or more cores (e.g., 12 cores), with 64 bits, 3 MB L2 and 6 MB L3 cache memory, and a max frequency of 2 or more GHz (e.g., 2.2 GHZ), one or more deep learning accelerators (DLAs), deep learning accelerator clusters (XNNs), neural network accelerators (NNAs), or neural processing units (NPUs) 509 (e.g., 2 DLAs/XNNs/NNAs/NPUs 509), and a vision accelerator—such as a programmable vision accelerator (PVA) 507, a single SoC 504) may be capable of 275 tera operations per second (TOPS) of AI performance. For example, NVIDIA's Jetson AGX Orin 64 GB SoC satisfies these criteria, and achieves this performance.

Similarly, in embodiments where the SoC(s) 504 include a GPU 508 with 1700 or more cores (e.g., 1792 cores), 50 or more tensor cores (e.g., 56 tensor cores), and a GPU max frequency of over 900 MHz (e.g., 930 MHz), a CPU 506 including 8 or more cores (e.g., 8 cores), with 64 bits, 2 MB L2 and 4 MB L3 cache memory, and a max frequency of 2 or more GHz (e.g., 2.2 GHZ), one or more deep learning accelerators (DLAs), deep learning accelerator clusters (XNNs), neural network accelerators (NNAs), or neural processing units (NPUs) 509 (e.g., 2 DLAs/XNNs/NNAs/NPUs 509), and a vision accelerator—such as a programmable vision accelerator (PVA) 507, a single SoC 504) may be capable of 200 tera operations per second (TOPS) of AI performance. For example, NVIDIA's Jetson AGX Orin 32 GB SoC satisfies these criteria, and achieves this performance.

In some embodiments, such as where the SoC(s) 504 include a GPU 508 with 1000 or more cores (e.g., 1024 cores), 28 or more tensor cores (e.g., 32 tensor cores), and a GPU max frequency of over 900 MHz (e.g., 1173 MHz), a CPU 506 including 8 or more cores (e.g., 8 cores), with 64 bits, 2 MB L2 and 4 MB L3 cache memory, and a max frequency of 2 or more GHz (e.g., 2 GHZ), one or more deep learning accelerators (DLAs), deep learning accelerator clusters (XNNs), neural network accelerators (NNAs), or neural processing units (NPUs) 509 (e.g., 1 DLA/XNN/NNA/NPU 509), and a vision accelerator—such as a programmable vision accelerator (PVA) 507, a single SoC 504) may be capable of 157 tera operations per second (TOPS) of AI performance. For example, NVIDIA's Jetson AGX Orin NX 16 GB SoC satisfies these criteria, and achieves this performance.

In various embodiments, such as where the SoC(s) 504 include a GPU 508 with 1000 or more cores (e.g., 1024 cores), 28 or more tensor cores (e.g., 32 tensor cores), and a GPU max frequency of over 900 MHz (e.g., 1020 MHz), a CPU 506 including 6 or more cores (e.g., 6 cores), with 64 bits, 1.5 MB L2 and 4 MB L3 cache memory, and a max frequency of 1.5 or more GHz (e.g., 1.7 GHZ), a single SoC 504) may be capable of 67 tera operations per second (TOPS) of AI performance. For example, NVIDIA's Jetson Orin Nano 8 GB SoC satisfies these criteria, and achieves this performance.

The SoC(s) 504 may include one or more CPUs 506. The CPU(s) 506 may include a CPU cluster or CPU complex (alternatively referred to herein as a “CCPLEX”), in embodiments. The CPU(s) 506 may include multiple cores and/or (e.g., L2, L3) caches. For example, in some embodiments, the CPU(s) 506 may include twelve cores in a coherent multi-processor configuration. In some embodiments, the CPU(s) 506 may include four dual-core clusters where each cluster has a dedicated L2 cache (e.g., a 3 MB L2 cache). The CPU(s) 506 (e.g., the CCPLEX) may be configured to support simultaneous cluster operation enabling any combination of the clusters of the CPU(s) 506 to be active at any given time.

The SoC(s) 504 may include any type and number of GPUs 508. For example, an integrated GPU(s) (alternatively referred to herein as an “iGPU(s)”) may be used in some embodiments. The GPU(s) 508 may be programmable and may be efficient for parallel workloads. The GPU(s) 508, in some examples, may use an enhanced tensor instruction set. The GPU(s) 508 may include one or more streaming microprocessors, where each streaming microprocessor may include a cache (e.g., an L1 cache with at least 96 KB storage capacity), and two or more of the streaming microprocessors may share an L2 cache (e.g., an L2 cache with a 512 KB storage capacity). In some embodiments, the GPU(s) 508 may include at least eight streaming microprocessors. The GPU(s) 508 may use compute application programming interface(s) (API(s)). In addition, the GPU(s) 508 may use one or more parallel computing platforms and/or programming models (e.g., NVIDIA's CUDA).

The GPU(s) 508 may be power-optimized for best performance in automotive, robotics, and/or other embedded use cases. For example, the GPU(s) 508 may be fabricated on a Fin field-effect transistor (FinFET). However, this is not intended to be limiting and the GPU(s) 508 may be fabricated using other semiconductor manufacturing or fabrication processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an (e.g., L0) instruction cache, a warp scheduler, a dispatch unit, and/or a (e.g., 64 KB) register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 508 may include a high bandwidth memory (HBM) and/or a (e.g., 16 GB) HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 508 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 508 to access the CPU(s) 506 page tables directly. In such examples, when the GPU(s) 508 memory management unit (MMU) experiences a miss, an address translation request may be transmitted to the CPU(s) 506. In response, the CPU(s) 506 may look in its page tables for the virtual-to-physical mapping for the address and transmits the translation back to the GPU(s) 508. As such, unified memory technology may allow a single unified virtual address space for memory of both the CPU(s) 506 and the GPU(s) 508, thereby simplifying the GPU(s) 508 programming and porting of applications to the GPU(s) 508.

The SoC(s) 504 may include any number of cache(s) 512, including those described herein. For example, the cache(s) 512 may include L0 caches, L1 caches, L2 caches, L3 caches (e.g., that are available to both the CPU(s) 506 and the GPU(s) 508 (e.g., that is connected both the CPU(s) 506 and the GPU(s) 508)), etc. The cache(s) 512 may include a write-back cache that may keep track of states of lines, such as by using one or more cache coherence protocol (e.g., MEI, MESI, MSI, etc.). The (e.g., L3) cache may include 4 MB or more, depending on the embodiment, although smaller or larger cache sizes may be used.

The SoC(s) 504 may include one or more arithmetic logic units (ALUs) 565 which may be leveraged in performing processing with respect to any of the variety of tasks or operations of the machine 500—such as computer vision, machine learning or deep learning processing, world model management, etc. In addition, the SoC(s) 504 may include a floating point unit(s) (FPU(s)) 567—or other math coprocessor or numeric coprocessor types—for performing mathematical operations within the system. For example, the SoC(s) 104 may include one or more FPUs 567 integrated as execution units within a CPU(s) 506 and/or GPU(s) 508.

The SoC(s) 504 may include one or more accelerators 514 (e.g., hardware accelerators, software accelerators, or a combination thereof). For example, the SoC(s) 504 may include a hardware acceleration cluster that may include optimized hardware accelerators and/or large on-chip memory. The large on-chip memory 515 (e.g., 4 MB of SRAM, 32 GB and/or 64 GB 256-bit LPDDR5 at 204.8 GB/s, 8 GB and/or 16 GB 128-bit LPDDR5 at 102.4 GB/s, and/or other memory types and sizes), may enable the hardware acceleration cluster to accelerate neural network processing, transformer processing, optical flow processing, vision processing, and/or other calculations or processing. The hardware acceleration cluster may be used to complement the GPU(s) 508 and to off-load some of the tasks of the GPU(s) 508 (e.g., to free up more cycles of the GPU(s) 508 for performing other tasks). As an example, the accelerator(s) 514 may be used for targeted workloads (e.g., perception, convolutional neural networks (CNNs), deep neural networks (DNNs), language models (LLMs, VLMs, MMLMs, VLAs, etc.), transformer models, diffusion models, encoder-only models, encoder-decoder models, etc. that are stable enough to be amenable to acceleration.

The accelerator(s) 514 (e.g., the hardware acceleration cluster) may include a deep learning accelerator(s) (DLA) 509 (alternatively referred to herein as “a deep learning accelerator cluster (XNN) 509,” “neural network accelerator (NNA) 509,” or “neural processing unit (NPU) 509”). The DLA(s) 509 may include one or more Tensor processing units (TPUs) 541 that may be configured to provide an additional, e.g., ten trillion operations per second for deep learning applications and inferencing. The TPUs 541 may be accelerators configured to, and optimized for, performing image processing functions (e.g., for CNNs, RCNNs, DNNs, etc.). The DLA(s) 509 may further be optimized for a specific set of neural network types and floating point operations, as well as inferencing. The design of the DLA(s) may provide more performance per millimeter than a general-purpose GPU, and vastly exceeds the performance of a CPU. The TPU(s) 541 may perform several functions, including a single-instance convolution function, supporting, for example, INT8, INT16, and FP16 data types for both features and weights, as well as post-processor functions. Although the TPU(s) 541 are described as being included as part of the DLA(s) 509, this is not intended to be limiting, and the TPU(s) 541 may be included in additional or alternative accelerator(s) 514 and/or other components, and/or may be included as a discrete processing component(s).

The DLA(s) 509 may quickly and efficiently execute neural networks on processed or unprocessed data for any of a variety of functions, including, for example and without limitation: for object and feature identification and detection (e.g., vehicles, pedestrians, other robots, lane lines, road boundary lines, debris, potholes, boxes, warehouse items, etc.) using data from one or more sensor modalities; for distance estimation using data from one or more sensor modalities; for emergency vehicle detection and identification and detection using data from microphones and/or vision-based sensors; for facial recognition; for pick and place operations; for manipulation operations; for occupant monitoring; for vehicle owner identification; and/or other in-cabin operations using data from in-cabin cameras and/or other sensor types; and/or a for security and/or safety related events, to name a few.

The DLA(s) 509 may perform any function of the GPU(s) 508, and by using an inference accelerator, for example, a designer may target either the DLA(s) 509 or the GPU(s) 508 for any function. For example, the designer may focus processing of DNNs and floating point operations on the DLA(s) 509 and leave other functions to the GPU(s) 508 and/or other accelerator(s) 514. The DLA(s) 509 may be used to run any type of network to enhance control and safety, including for example, a neural network that outputs a measure of confidence for each object detection.

The accelerator(s) 514 (e.g., the hardware acceleration cluster) may include a programmable vision accelerator(s) (PVA) 507, which may alternatively be referred to herein as a computer vision accelerator or generally a vision accelerator. The PVA(s) 507 may be designed and configured to accelerate computer vision algorithms for the advanced driver assistance systems (ADAS), semi-autonomous driving, autonomous driving, robotics applications, security and surveillance applications, augmented reality (AR), virtual reality (VR), and/or mixed reality (MR) applications, etc. The PVA(s) 507 may provide a balance between performance and flexibility. For example, each PVA(s) 507 may include, for example and without limitation, any number of reduced instruction set computer (RISC) cores, direct memory access (DMA) systems, pixel processing engines (PPEs), vector processors or vector processing units (VPUs), and/or other components. The PVA engine may include an advanced very long instruction word (VLIW), single instruction multiple data (SIMD) digital signal processor. The PVA(s) 507 may be optimized for the tasks of image processing and computer vision algorithm acceleration. For example, the PVA(s) 507 provides excellent performance with extremely low power consumption, and can be used asynchronously and concurrently with the CPU(s) 506, GPU(s) 508, and/or other accelerators in the system (e.g., vehicle, robot, etc.) as part of a heterogeneous compute pipeline.

The PVA(s) 507 may include one or more (e.g., two) vector processing subsystems (VPS), where each VPS may include one or more vector processing unit (VPU) cores, one or more decoupled look-up units (DLUTs), one or more shared or vector memories (VMEMs), and one or more instruction caches (I-caches). The VPU core(s) may be the main processing unit, and may include a vector SIMD VLIW DSP 543 optimized for computer vision. The VPU core(s) may fetch instructions through the I-cache(s), and may access data through the VMEM(s). The DLUT(s) may include a specialized hardware component that enhances the efficiency of parallel lookup operations. For example, the DLUT(s) allow parallel lookups using a single copy of the lookup table by executing these lookups in a decoupled pipeline, independent of the primary processor pipeline. By doing so, the DLUT(s) minimize or reduce memory usage and enhance throughput while avoiding data-dependent memory bank conflicts-ultimately leading to improved overall system performance. The VPU VMEM(s) may provide local data storage for the VPU, allowing efficient implementation of various image processing and computer vision algorithms. The VPU VMEM(s) may support access from outside-VPS hosts such as direct memory access (DMA) and the CPU(s) 506 (e.g., ARM Cortex-R5 processor), facilitating data exchange with the CPU(s) 506 and other system-level components. The VPU I-cache may supply instruction data to the VPU(s) when requested, may request missing instruction data from system memory, and/or may maintain temporary instruction storage for the VPU. For each VPU task, the CPU(s) 506 may configures the DMA system, optionally prefetch the VPU program into VPU I-cache, and/or kick off each VPU-DMA pair to process a task. The PVA(s) 507 may also include an L2 SRAM memory to be shared between the one or more (e.g., two) sets of VPS and DMA. In some embodiments, one or more (e.g., two) DMA devices are used to move data among external memory, PVA L2 memory, the VMEMs (e.g., one in each VPS), CPU(s) tightly coupled memory (TCM), DMA descriptor memory, and/or PVA-level config registers. In a lightly loaded system, two parallel DMA accesses to DRAM can achieve a read/write bandwidth of up to 15 GB/s each and, in a heavily loaded system, this bandwidth can reach up to 10 GB/s each. With respect to compute compacity, the INT8 Giga Multiply-Accumulate Operations per Second (GMACs) may be 2048 or greater, excluding the DLUT. The FP32 GMACs may include 32 per PVA instance.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA system may enable components of the PVA(s) 507 to access the system memory independently of the CPU(s) 506. The DMA may support any number of features used to provide optimization to the PVA(s) 507 including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors or VPUs may be programmable processors that may be designed to efficiently and flexibly execute programming for computer vision algorithms and provide signal processing capabilities. In some examples, the PVA(s) 507 may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA(s) 507, and may include one or more vector processing units (VPUs), one or more pixel processing engines (PPEs)—which may include a 2D layout of interconnected (e.g., for north, south, east, west intercommunication) processing elements, one or more instruction caches, and/or one or more shared or vector memories (e.g., VMEMs). A VPU core may include a digital signal processor such as, for example, a single instruction, multiple data (SIMD), very long instruction word (VLIW) digital signal processor. The combination of the SIMD and VLIW may enhance throughput and speed.

In some embodiments, each of the vector processors may include an instruction cache and may be coupled to dedicated memory. As a result, in some examples, each of the vector processors may be configured to execute independently of the other vector processors. In other examples, the vector processors that are included in a particular PVA(s) 507 may be configured to employ data parallelism. For example, in some embodiments, the plurality of vector processors included in a single PVA(s) 507 may execute the same computer vision algorithm, but on different regions of an image. In other examples, the vector processors included in a particular PVA(s) 507 may simultaneously execute different computer vision algorithms, on the same image, or even execute different algorithms on sequential images or portions of an image. Among other things, any number of PVAs 507 may be included in the hardware acceleration cluster and any number of vector processors may be included in each of the PVAs. In addition, the PVA(s) 507 may include additional error correcting code (ECC) memory, to enhance overall system safety.

The accelerator(s) 514 (e.g., the hardware accelerator cluster) have a wide array of uses for autonomous and semi-autonomous machine control. The PVA(s) 507 may be a programmable vision accelerator that may be used for key processing stages in perception, robotics understanding and reasoning, ADAS, semi-autonomous, and autonomous vehicles, etc. The PVA's 507 capabilities are a good match for algorithmic domains needing predictable processing, at low power and low latency. In other words, the PVA(s) 507 performs well on semi-dense or dense regular computation, even on small data sets, which need predictable run-times with low latency and low power. Thus, in the context of platforms for autonomous vehicles and robotics, the PVAs 507 are designed to run classic computer vision algorithms, as they are efficient at object detection and operating on integer math.

For example, according to one embodiment of the technology, the PVA 507 is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA(s) 507 may perform computer stereo vision function on inputs from two monocular cameras.

In some examples, the PVA(s) 507 may be used to perform dense optical flow. According to process raw RADAR data (e.g., using a 4D Fast Fourier Transform) to provide Processed RADAR. In other examples, the PVA(s) 507 is used for time-of-flight depth processing, by processing raw time of flight data to provide processed time of flight data, for example.

Although the VPU(s), DMA(s), RISC Corc(s), VMEM(s), and decoupled co-processors (e.g., the DLUT(s)) are described as being included within the PVA(s) 507, this is not intended to be limiting. In some embodiments, these components may be included in alternative or additional processing components and/or accelerator(s) 514, and/or may be included as discrete components of the SoC(s) 504 and/or other computing system architecture(s).

In some examples, the SoC(s) 504 may include a real-time ray-tracing hardware accelerator (RTA) 551 that may be used to quickly and efficiently determine the positions and extents of objects (e.g., within a world model), to generate real-time or near-real time visualization simulations, for RADAR signal interpretation, for sound propagation synthesis and/or analysis, for simulation of SONAR, RADAR, LiDAR, camera, and/or other sensor modalities within a simulation, for general wave propagation simulation, for comparison to LiDAR data for purposes of localization, to generate realistic training data for training neural networks, and/or other functions and uses. In some embodiments, one or more tree traversal units (TTUs) may be used for executing one or more ray-tracing related operations. For example, the machine 500 (or another machine or device) may be simulated within a simulation environment, and the simulation environment may be generated using one or more light transport simulation algorithms (e.g., ray-tracing, path-tracing, etc.). These ray-tracing algorithms may thus be accelerated using a ray-tracing accelerator 551 and/or a ray-tracing optimized GPU 506—such as NVIDIA's RTX GPU.

The accelerator(s) 514 (e.g., in the hardware acceleration cluster) may include one or more optical flow accelerators (OFAs) 511. For example, the OFA(s) 511 may be used for computing optical flow and stereo disparity between frames of sensor data (e.g., images). Optical flow may be accelerated on the OFA(s) 511 for uses such as object detection and tracking, and/or for stereo depth estimation where used for computing stereo disparity between stereo image frames (e.g., two or more frames captured using two or more image sensors with at least partially overlapping fields of view).

The SoC(s) 504 may include one or more camera serial interfaces (CSIs) 523. For example, the CSI(s) 523 may include a mobile industry processor interface (MIPI) camera serial interface (CSI) for receiving video and input from cameras, a high-speed interface, and/or a video input block that may be used for camera and related pixel input functions. The SoC(s) 504 may further include an input/output controller(s) that may be controlled by software and may be used for receiving I/O signals that are uncommitted to a specific role. For example, the CSI 523 may include a MIPI CSI-2 connector—e.g., a 16 lane MIPI CSI-2 connector, D-PHY 2.1 (up to 40 Gbps), and C-PHY 2.0 (up to 164 Gbps) for supporting 16 virtual channels and six or more cameras, an 8 lane MIPI CSI-2 connector, D-PHY 2.1 (up to 20 Gbps for supporting 8 virtual channels and 4 or more cameras, and/or a 2×MIPI CSI-2, 22 pin camera connector, depending on the embodiment and implementation.

The accelerator(s) 514 (e.g., the hardware acceleration cluster) may include a computer vision network on-chip (CVNOC) 563 and SRAM, for providing a high-bandwidth, low latency SRAM for the accelerator(s) 514. In some examples, the on-chip memory may include at least 4 MB SRAM, consisting of, for example and without limitation, eight field-configurable memory blocks, that may be accessible by the PVA 507, OFA 511, DLA 509, and/or other accelerator(s) 514. Each pair of memory blocks may include an advanced peripheral bus (APB) interface, configuration circuitry, a controller, and a multiplexer. Any type of memory 515 may be used. The PVA 507, OFA 511, DLA 509, and/or other accelerator(s) 514 may access the memory via a backbone that provides the accelerator(s) 514 with high-speed access to memory. The backbone may include a computer vision network on-chip that interconnects the accelerator(s) 514 to the memory (e.g., using the APB).

The CVNOC 563 may include an interface that determines, before transmission of any control signal/address/data, that the accelerator(s) 514 provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

The SoC(s) 504 may include data store(s) 516 and/or memory 515. The data store(s) 516 may be on-chip memory 515 of the SoC(s) 504, which may store neural networks and/or other algorithms to be executed on the CPU(s) 506, the GPU(s) 508, and/or one or more of the accelerator(s) 514. In some examples, the data store(s) 516 may be large enough in capacity to store multiple instances of neural networks for redundancy and safety. The data store(s) 512 may comprise L2 and/or L3 cache(s) 512, for example. The memory (ies) 515 may include SRAM, LPDDR5, and/or other memory types. For example, the memory (ies) 515 may include 4 MB of SRAM, 32 GB and/or 64 GB 256-bit LPDDR5 at 204.8 GB/s, 8 GB and/or 16 GB 128-bit LPDDR5 at 102.4 GB/s, and/or other memory types and sizes. Reference to the data store(s) 516 may include reference to the memory associated with the PVA 507, OFA 511, DLA 509, and/or other accelerator(s) 514, as described herein.

The data store(s) 116 may include various storage types, such as eMMC, NVMe, etc. For example, the SoC(s) 504 may include storage in the form of an embedded multimedia card (cMMC) (e.g., 64 GB eMMC 5.1) and/or an SD card slot, with external NVM express (NVMe) capability, e.g., via M.2 Key M. For example, the data store(s) 516 and/or other storage may be accessed via, e.g., NVMe, using PCI Express (PCIe), RDMA, TCP, and/or other protocols.

The SoC(s) 504 may include one or more processor(s) 510 (e.g., embedded processors). The processor(s) 510 may include a boot and power management processor (BPMP) 553, that may be a dedicated processor and subsystem to handle boot power and management functions and related security enforcement. The BPMP 553 may be a part of the SoC(s) 504 boot sequence and may provide runtime power management services. The BPMP 553 may provide clock and voltage programming, assistance in system low power state transitions, management of SoC(s) 504 thermals and temperature sensors, and/or management of the SoC(s) 504 power states. Each temperature sensor may be implemented as a ring-oscillator whose output frequency is proportional to temperature, and the SoC(s) 504 may use the ring-oscillators to detect temperatures of the CPU(s) 506, GPU(s) 508, accelerator(s) 514, and/or other components. If temperatures are determined to exceed a threshold, BPMP 553 may enter a temperature fault routine and put the SoC(s) 504 into a lower power state and/or put the machine 500 into a chauffeur to safe stop mode (e.g., bring the machine 500 to a safe stop).

The processor(s) 510 may further include a set of embedded processors that may serve as an audio processing engine (APE) 555. The APE 555 may be an audio subsystem that enables full hardware support for multi-channel audio over multiple interfaces, and a broad and flexible range of audio I/O interfaces. In some examples, the APE 555 is a dedicated processor core with a digital signal processor with dedicated RAM.

The processor(s) 510 may further include an always on processor engine (AOPE) 557 that may provide necessary hardware features to support low power sensor management and wake use cases. The AOPE 557 may include a processor core, a tightly coupled RAM, supporting peripherals (e.g., timers and interrupt controllers), various I/O controller peripherals, and routing logic.

The processor(s) 510 may further include a safety processor(s) 513 (alternatively referred to as “safety island 513”), which may include a safety cluster engine that includes a dedicated processor or processor subsystem to handle safety management for automotive, robotics, and/or other applications. The safety processor(s) 513—and/or safety cluster engine—may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations. In some embodiments, the safety processor(s) 513 may include a discrete processor(s), such that fault of other system components may not impact the performance and availability of the safety processor 513.

The processor(s) 510 may further include a real-time or near real-time sensor engine (SE) 559 that may include a dedicated processor subsystem for handling real-time or near real-time camera, LiDAR, RADAR, and/or other sensor modality management.

The processor(s) 510 may further include one or more image signal processors (ISPs) 527, which may include a high-dynamic range signal processor and/or a hardware engine that is part of one or more sensor processing pipelines.

The processor(s) 510 may include a video image compositor (VIC) 561 that may be a processing block (e.g., implemented on a microprocessor) that implements video post-processing functions needed by a video playback application to produce the final image for the player window. The VIC 561 may perform lens distortion correction on wide-view camera(s) 568B, surround camera(s) 568D, in-cabin monitoring camera sensors, and/or other camera sensors with distorted fields of view.

A VIC 561 may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

A VIC 561 may also be configured to perform stereo rectification on input stereo lens frames. The video image compositor may further be used for user interface composition when the operating system desktop is in use, and the GPU(s) 508 is not required to continuously render new surfaces. Even when the GPU(s) 508 is powered on and active doing 3D rendering, the video image compositor may be used to offload the GPU(s) 508 to improve performance and responsiveness.

The SoC(s) 504 may further include a broad range of peripheral interfaces for input/output (I/O) 525, such as to enable communication with peripherals, audio codecs, power management, and/or other devices. The SoC(s) 504 may be used to process data from cameras (e.g., connected over Gigabit Multimedia Serial Link and/or Ethernet), sensors (e.g., LiDAR sensor(s) 564, RADAR sensor(s) 560, etc. that may be connected over Ethernet), data from bus 502 (e.g., speed of machine 500, steering wheel position, etc.), data from GNSS sensor(s) 558 (e.g., connected over Ethernet or CAN bus). The SoC(s) 504 may further include dedicated high-performance mass storage controllers that may include their own DMA engines, and that may be used to free the CPU(s) 506 from routine data management tasks. In some embodiments, the SoC(s) 504 I/O 525 may include a header (e.g., a 40 pin header, or 40 pin expansion header) with support for universal asynchronous receiver/transmitter (UART), serial peripheral interface (SPI), inter-integrated circuit sound (12S), inter-integrated circuit (I2C), controller area network (CAN), pulse width modulation (PWM), digital microphone interface (DMIC), digital speaker station (DSPK), general purpose I/O (GPIO), etc., an automation header (e.g., 12 pin automation header), an audio panel header (e.g., a 10 pin audio panel header), a joint test action group (JTAG) header (e.g., a 10 pin JTAG header), a fan header (e.g., a 4 pin fan header), an RTC battery backup connector (e.g., a 2 pin battery backup connector), a microSD slot, a DC power jack, power, force, recovery, and reset buttons, one or more display connectors (e.g., DisplayPort (DP), such as a DP 1.4 A (+MST), an eDP 1.41, an HDMI 2.1, and/or a 4K30 multi-model DP 1.2 (+MST) connector), and/or other I/O 525 elements, components, or features.

The SoC(s) 504 may include in-machine networking capability using, for example, Ethernet (e.g., automotive Ethernet), SERDES, controller area network (CAN), FlexRay, local interconnect network (LIN), low voltage differential signaling (LVDS), media oriented system transport (MOST), another networking type, and/or a combination thereof. For example, the SoC(s) 504 may include an RJ45 connector with up to 10 GbE, a 1 GbE connector, and/or other networking connector types.

The SoC(s) 104 may include one or more digital signal processors (DSPs) 543. For example, the DSP(s) 543 may include a dedicated or specialized microprocessor chip optimized for digital signal processing—such as in audio signal processing, telecommunications, digital image processing, RADAR, SONAR, LIDAR, and/or other sensor processing, speech recognition, and/or other applications.

The SoC(s) 504 may include one or more video encoders 519 and/or one or more video decoders 521. For example, the video encoder(s) 519 may include a hardware-based (e.g., as part of the GPU(s) 508) video encoder (e.g., supporting H.264, H.265, etc., and being HEVC compliant, such as NVIDIA's NVENC) that may process image inputs (e.g., as YUV, RGB, etc.) to generate a video bit stream. The video decoder(s) 521 may include a video decoder engine that may provide fully-accelerated hardware video decoding capabilities (e.g., supporting decoding of bitstreams in various formats, such as AV1, H.264, H.265, VP8, VP9, MPEG-1, MPEG-2, MPEG-4, VC-1, etc, and being HEVC compliant, such as NVIDIA's NVDEC). In some examples, the video decoder(s) 521 may be hardware-based (e.g., as part of the GPU(s) 508).

The SoC(s) 504 may include one or more general compute acceleration clusters (GCAC(s)) 529. For example, the GCAC(s) 529 may include various processor types that may be used to accelerate compute, such as one or more vector microcode processors (VMPs) 533, one or more multi-threaded processing clusters (MPCs) 531, one or more programmable macro arrays (PMA(s)) 535, and/or one or more other processor types. For example, the GCAC(s) 529 may include a PMA 535, two VMPs 533, and 2 MPCs 531.

The SoC(s) 504 may include one or more vector microcode processors (VMPs) 533. The VMP(s) 533, in embodiments, may include a wide vector (very long instruction word (VLIW) and single instruction multiple data (SIMD)) machine with performing various operations, such as short integral type operations common in computer vision and deep learning algorithms.

The SoC(s) 504 may include one or more multi-threaded processing clusters (MPCs) 531. The MPC(s) 531 may include a processing cluster that be, in embodiments, more versatile than a GPU, and with higher efficiency than a CPU. For example, the MPC(s) 531 may include a multi-threaded processor that allows multiple threads to share resources and execute instructions concurrently.

The SoC(s) 504 may include one or more programmable macro arrays (PMA(s)) 535. The PMA(s) 535 may include a coarse-grained reconfigurable architecture (CGRA) dataflow machine, having a unique architecture that delivers strong performance on dense computer vision and deep learning algorithms that may be unachievable in classic digital signal processing (DSP) architectures.

The SoC(s) 504 may include one or more display processing units (DPUs) 545 for performing hardware-accelerated image processing. For example, the DPU(s) 545 may retrieve pixel data from memory 515 and send it to a display peripheral through standard interfaces. As such, the DPU(s) 545 may handle display processing and rendering for in-machine and/or on-machine displays.

The SoC(s) 504 may include one or more application processing units (APUs) 539. For example, the APU(s) 539 may include a quad or dual-core processor with 48 KB/32 KB L1 cache with parity and ECC, along with a 1 MB L2 cache with ECC. The APU(s) 539 may support NEON instructions and single and double precision floating point operations.

The SoC(s) 504 may include one or more real-time processing units (RTPUs) 569. The RTPU(s) 569 may include a dual-core processor with 32 KB/32 KB L1 cache, and 256 KB TCM with ECC. The RTPU(s) 569 may support single and double precision floating point operations.

The SoC(s) 504 may include one or more built-in self-test (BIST) components 537. For example, the BIST component(s) 537 may include memory BIST (MBIST) to test memories of the system and/or logic BIST (LBIST) to test logic of the system. The BIST components 537 may include embedded logic for directly testing logic and/or memory of the system.

The SoC(s) 504 may include one or more dynamically reconfigurable processors (DRPs) 571. For example, the DRP(s) 571 may be used for accelerating various computing operations. For example, the DRP(s) 571 may be combined, in embodiments, with a MAC unit for use as an AI accelerator. In embodiments, the DRP(s) 571 may execute applications while dynamically switching the circuit connection configuration of the arithmetic units (e.g., ALUs) on the chip at each operating clock according to the content to be processed. Since only the necessary arithmetic circuits are used, the DRP(s) 571 may consume less power than with CPU processing and can achieve higher speed. Furthermore, compared to CPUs, where frequent external memory accesses due to cache misses and other causes will degrade performance, the DRP(s) 571 can build the necessary data paths in hardware ahead of time, resulting in less performance degradation and less variation in operating speed (jitter) due to memory accesses. The DRP(s) 571 may include a dynamic loading function that switches the circuit connection information each time the algorithm changes, enabling processing with limited hardware resources, even in robotic/automotive applications that require processing of multiple algorithms.

In some embodiments, the accelerator(s) 514 may include an OpenCV accelerator for speeding up processing of OpenCV, an open-source industry standard library for computer vision processing. In some embodiments, the combination of one or more DRP(s) 571 deployed as an AI accelerator along with an OpenCV accelerator(s) may enhance AI computing and image processing algorithms, enabling complex and compute-heavy operations such as Visual simultaneous localization and mapping (SLAM).

In contrast to conventional systems, by providing a CPU complex, GPU complex, and a hardware acceleration cluster, the technology described herein allows for multiple neural networks to be performed simultaneously (e.g., at least partially in parallel) and/or sequentially, and for the results to be combined together to enable Level 2-5 autonomous driving functionality and/or autonomous robotics movement, control, planning, and/or navigation operations. In addition, because the SoC(s) 504 may include various compute engines (e.g., processors 510, CPUs 506, GPU(s) 508, accelerator(s) 514, etc.), tasks may be distributed between and among the compute engines, in some instances without common cause failures due to the discrete footprint of the compute engines. Further, because the SoC(s) 504 may include a dedicated safety processor(s) 513 (or safety island 513), critical safety or redundant operations may be performed without common cause failures from the main processing components or compute engines of the SoC(s) 514. Due to these features, the SoC(s) 504 and/or the underlying systems of the machine 500 may be capable of satisfying higher levels of safety—such as automotive safety integrity level (ASIL) D from the ISO 26262 standard.

FIG. 5E is a system diagram for communication between a cloud-based server(s) (e.g., in a data center, such as those described herein) and the example autonomous or semi-autonomous vehicle or machine 500 of FIG. 5A, in accordance with some embodiments of the present disclosure. The system 576 may include a server(s) 578, a network(s) 590, and a machine(s) 500. The server(s) 578 may include a plurality of GPUs 584(A)-584(H) (collectively referred to herein as GPUs 584), switches 582(A)-582(H) (such as PCIe 4.0/5.0/etc switches, M.2 slots, thunderbolt, USB4, NVIDIA's NVLink, NVIDIA's NVSwitch, GPUDirect RDMA, GPUDirect Storage, etc.), CPUs 580(A)-580(B) (collectively referred to herein as CPUs 580), accelerators, and/or other processor types. The GPUs 584, the CPUs 580, and the PCIe switches may be interconnected with high-speed interconnects such as, for example and without limitation, NVLink interfaces 588 developed by NVIDIA and/or PCIe connections 586. In some examples, the GPUs 584 are connected via NVLink and/or NVSwitch SoC and the GPUs 584 and the PCIe switches 582 are connected via PCIe interconnects. Although eight GPUs 584, two CPUs 580, and two PCIe switches are illustrated, this is not intended to be limiting. Depending on the embodiment, each of the server(s) 578 may include any number of GPUs 584, CPUs 580, and/or PCIe switches. For example, the server(s) 578 may each include eight, sixteen, thirty-two, and/or more GPUs 584.

The server(s) 578 may receive, over the network(s) 590 and from the machine(s) 500, sensor data indicating information about new or previously unexplored locations, and/or sensor data indicating changes to previously seen/stored locations (e.g., unexpected or changed road conditions, such as recently commenced road-work). The server(s) 578 may transmit, over the network(s) 590 and to the machine(s) 500, neural networks 592, updated neural networks 592, map information 594, etc., including information regarding traffic and road conditions. The updates to the map information 594 may include updates for the HD map 522, SD map, navigation map, etc., such as information regarding construction sites, potholes, detours, flooding, and/or other obstructions. In some examples, the neural networks 592, the updated neural networks 592, the map information 594, and/or the other information may have resulted from new training and/or experiences represented in data received from any number of machine(s) 500 in the environment, and/or based on training performed at a datacenter (e.g., using the server(s) 578 and/or other servers).

The server(s) 578 may be used to train machine learning models (e.g., neural networks) based on training data. The training data may be generated by the machine(s) 500, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the machine(s) 500 (e.g., transmitted to the machine(s) 500 over the network(s) 590, and/or the machine learning models may be used by the server(s) 578 to remotely monitor and/or control the machine(s) 500.

In some examples, the server(s) 578 may receive data from the machine(s) 500 and apply the data to up-to-date real-time neural networks for real-time intelligent inferencing. The server(s) 578 may include deep-learning supercomputers and/or dedicated AI computers powered by GPU(s) 584, such as a DGX and DGX Station machines developed by NVIDIA. However, in some examples, the server(s) 578 may include deep learning infrastructure that use only CPU-powered datacenters.

The deep-learning infrastructure of the server(s) 578 may be capable of fast, real-time inferencing, and may use that capability to evaluate and verify the health of the processors, software, and/or associated hardware in the machine 500. For example, the deep-learning infrastructure may receive periodic updates from the machine 500, such as a sequence of images and/or objects that the machine 500 has located in that sequence of images (e.g., via computer vision and/or other machine learning object classification techniques). The deep-learning infrastructure may run its own neural network to identify the objects and compare them with the objects identified by the machine 500 and, if the results do not match and the infrastructure concludes that the AI in the machine 500 is malfunctioning, the server(s) 578 may transmit a signal to the machine 500 instructing a fail-safe computer of the machine 500 to assume control, notify the passengers, and complete a safety maneuver or operation—such as to slow down, hand control back to a driver, come to a stop, and/or pull over/shut down.

For inferencing, the server(s) 578 may include the GPU(s) 584 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Computing Ecosystem for Generating, Training, and Deploying AI

FIG. 6 is a system diagram illustrating a three computer ecosystem 600, including a first computing system 602 for generating or creating artificial intelligence (AI)—such as AI training and validation data, a second computing system 604 for training artificial intelligence, and a third computing system 606 (which may include or correspond to the SoC(s) 504 of FIGS. 5A-5E) deploying the AI at the edge, in accordance with at least some embodiments of the present disclosure. For example, to develop and deploy embodied or physical AI, the three computer ccosystem 600 may be used, including three accelerated computer systems to handle physical AI training, simulation, and runtime (e.g., edge deployment). These systems may generate training data for and train multimodal foundation models (and/or other model types) using scalable, physically based simulations of the machine(s) 500 and their worlds. By doing so, simulation of machine(s) 500 may be performed at scale, allowing for refinement, testing, and optimization of skills (e.g., robot skills) in a virtual world (e.g., using NVIDIA's OMNIVERSE) that mimics the laws of physics—helping to reduce real-world data acquisition costs and ensuring the machine(s) 500 can perform safely in controlled settings.

The computing system 604 (e.g., NVIDIA's DGX Platform) may be used to train and fine-tune powerful foundation and generative AI models. Models, such as general purpose foundation models (e.g., NVIDIA's Project GROOT), may be used to enable robots and other machine(s) 500 to understand natural language and emulate movements by observing human actions. The computing system 604 may include a platform that incorporates software, infrastructure, and expertise in a modern, unified AI development and training solution. The computing system 604 may include individual computing devices 610 (e.g., NVIDIA's DGX B200, H200, etc.) and/or any number of computing devices 610 in a data center infrastructure 612 (e.g., NVIDIA's DGX SuperPOD).

For example, the individual computing devices 610 may include GPUs (e.g., 8 GPUs with 1,440 GB total GPU memory) and CPUs (e.g., 2 CPUs with 112 cores total, 2.1 GHZ, or 4 GHz (with boost)) that provide upwards of 72 petaFLOPS for training and 144 petaFLOPS for inference. The computing devices 610 may include memory (e.g., 4 TB memory, and storage (e.g., OS storage of 2×1.9 TB NVMe M.2, and internal storage of 8×3.84 TB NVMe U.2). The computing devices 610 may include various networking and network management components, such as OSFP ports (e.g., 4 OSFP ports) serving single-port smart host channel adapters (e.g., 8 single port ConnextX-7 virtual protocol interconnects (VPIs)), providing up to 400 GB/s Infiniband/Ethernet. The computing devices 610 may further include, e.g., dual port quad small form-factor pluggable (QSFFP) data processing units (DPUs) (e.g., 2 dual-port QSFP112 DPUs—such as NVIDIA's BlueField-3 DPUs), providing up to 400 Gb/s InfiniBand/Ethernet. The computing device(s) 610 may include an onboard network interface card (NIC) (e.g., 10 Gb/s onboard NIC with RJ45), a dual-port Ethernet NIC (e.g., 100 GB/s dual-port Ethernet NIC), and/or a host baseboard management controller (MBC) (e.g., with RJ45). In some embodiments, the NICs used for the computing device(s) 610 may include SuperNICs (e.g., NVIDIA's ConnectX-8 SuperNIC) to provide up to 800 Gb/s of data throughput for in-network computing acceleration engines to deliver the performance and robust feature set needed to power trillion-parameter scale AI factories and scientific computing workloads. In other embodiments, the computing device(s) 610 may include a smart host channel adapter (HCA) (e.g., NVIDIA's ConnectX-7) to provide ultra-low latency, 400 Gb/s throughput for in-network computing acceleration engines.

The data center infrastructure 612 may include any number of the computing devices 610, along with an operating system (OS) (e.g., DGX OS extensions for Linux distributions) to maximize system uptime, security, and reliability, network/storage acceleration libraries and management to accelerate end-to-end infrastructure performance, cluster management to scale and manage one node (e.g., one computing device 610) to thousands, job scheduling and orchestration to ensure hassle-free execution of every developer's job, AI workflow management and machine learning operations (MLOps) to move more models from prototype to production, and enterprise software to speed developer success.

The computing system 602 (e.g., NVIDIA's OVX servers) may provide a development and simulation platform for testing and optimizing physical AI with APIs and frameworks for simulation (e.g., NVIDIA's DriveSIM, ISAAC Sim, ISAAC Gym, ISAAC Labetc.). The computing system 602 allows developers to use simulation frameworks to simulate and validate robot models, and/or to generate massive amounts of physically-based synthetic data to bootstrap model training. The computing system 602 may support learning frameworks that power robot reinforcement learning and imitation learning, to accelerate robot policy training and refinement. For example, the computing system 602 may be used to generate any number of simulations 608—such as within NVIDIA's OMNIVERSE. The computing system 602 may be used optimized for accelerating an entire software stack, from training, fine-tuning, and deploying generative AI to powering industrial digitalization within a content collaboration platform of APIs, software developer kits (SDKs), and services that allow for integration of OpenUSD, ray-tracing rendering technologies (e.g., NVIDIA's RTX), and generative physical AI into existing software tools and simulation workflows for, e.g., industrial and robotics use cases (e.g., NVIDIA's OMNIVERSE). As such, the computing system 602 may host or support a native OpenUSD software platform enabling enterprises to connect 3D pipelines and develop advanced, real-time 3D applications for industrial digitalization. With powerful ray-tracing-accelerated AI and graphics capabilities, the computing system 602 delivers powerful performance for workloads like extended reality (XR), multi-user design collaboration, and digital twins. This allows creation of physically accurate models with high-fidelity ray-traced and path-traced rendering of materials, operation of large-scale, AI-enabled simulations, and generation of photorealistic 3D synthetic data for training. The computing system 602 may include individual computing devices 614 (e.g., NVIDIA's OVX L40S Server) and/or any number of computing devices 614 in a data center infrastructure 616 (e.g., NVIDIA's OVX Systems).

The computing device(s) 614 (which may include a server) may include CPUs (e.g., 2 CPUs with 32 cores each), and GPUs (e.g., 4 or 8 GPUs, each including 48 GB GDDR6 with ECC memory, 864 GB/s memory bandwidth, PCIe Gen4×16:64 GB/s bidirectional interconnect interface, 18,176 CUDA cores, 142 ray tracing (RT) cores, and 568 tensor cores). The computing devices 614 may include various networking and network management components, such as smart host channel adapters (HCA) (e.g., 2 or 4 single port ConnextX-7 at 200 Gb/s each, providing up to 800 Gb/s Infiniband/Ethernet), one or more DPUs (e.g., a dual-port QSFP112 DPUs—such as an NVIDIA BlueField-3 DPU), providing up to 400 Gb/s InfiniBand/Ethernet. In some embodiments, the NICs used for the computing device(s) 614 may include SuperNICs (e.g., NVIDIA's ConnectX-8 SuperNIC) to provide up to 800 Gb/s of data throughput for in-network computing acceleration engines to deliver the performance and robust feature set needed to power trillion-parameter scale AI factories and scientific computing workloads. In other embodiments, the computing device(s) 614 may include a smart host channel adapter (HCA) (e.g., NVIDIA's ConnectX-7) to provide ultra-low latency, 400 Gb/s throughput for in-network computing acceleration engines. The computing device(s) 614 may include a host memory (e.g., 384 Gb DDR5 ECC for 4 GPUs, or 768 Gb DDR5 ECC for 8 GPUs), and may include a dual in-line memory module (DIMM) slot(s), a host boot drive (e.g., 1 TB NVMe), and/or a host storage (e.g., 2 4 TB NVMe).

Similar to the data center infrastructure 612, the data center infrastructure 616 may allow for any number of computing device(s) 614 to be combined in cluster configuration according to a reference architecture.

The computing system 606 may be used to deploy trained AI models on a runtime computer—such as the SoC(s) 504 described herein. For example, these computing systems 606 may be designed for compact, on-board computing needs, including an ensemble of models for control policy, vision and language models, etc., deployed on a power-efficient on-board edge computing system 606. Details of components, features, and capabilities of the computing system 606 may be described in more detail herein with respect to FIGS. 5A-5E.

### Example Generative Models

In at least some embodiments, language models, such as large language models (LLMs), vision language models (VLMs), multi-modal language models (MMLMs), vision-language-action (VLA) models, and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases)—such as millions or billions of parameters. The LLMs/VLMs/MMLMs/etc. may be implemented for summarizing textual data, analyzing and extracting insights from data (e.g., textual, image, video, etc.), and generating new text/image/video/etc. in user specified styles, tones, and/or formats. The LLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio (sounds, synthetic speech, etc.), 2D and/or 3D data (e.g., in USD formats), and/or video. For example, vision language models (VLMs), or more generally multi-modal language models (MMLMs), may be implemented to accept image, video, sensor, audio, textual, 3D design (e.g., CAD), and/or other inputs data types and/or to generate or output image, video, audio, textual, 3D design, and/or other output data types.

Various types of LLMs/VLMs/MMLMs/etc. architectures may be implemented in various embodiments. For example, different architectures may be implemented that use different techniques for understanding and generating outputs—such as text, audio, video, image, 2D and/or 3D design or asset data, etc. In some embodiments, LLMs/VLMs/MMLMs/etc. architectures such as recurrent neural networks (RNNs) or long short-term memory networks (LSTMs) may be used, while in other embodiments transformer architectures—such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/VLMs/MMLMs/etc. may also include one or more diffusion block(s) (e.g., denoisers). The LLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/VLMs/MMLMs/etc. that include both encoder and decoder components like T5 (Text-to-Text Transformer) may be implemented to understand and generate content, such as for translation and summarization. These examples are not intended to be limiting, and any architecture type-including but not limited to those described herein—may be implemented depending on the particular embodiment and the task(s) being performed using the LLMs/VLMs/MMLMs/etc.

In various embodiments, the LLMs/VLMs/MMLMs/etc. may be trained using unsupervised learning, in which an LLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to cither prevent a particular undesired input from being processed using the LLMs/VLMs/MMLMs/etc., and/or preventing the output or presentation (e.g., display, audio output, etc.) of information generating using the LLMs/VLMs/MMLMs/etc. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3rd party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources—such as APIs, plug-ins, and/or the like.

In some embodiments, multiple language models (e.g., LLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model or version, instance, or agent—may be be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

FIG. 7 is a block diagram of an example generative language model system 700 suitable for use in implementing at least some embodiments of the present disclosure. In the example illustrated in FIG. 7, the generative language model system 700 includes a retrieval augmented generation (RAG) component 792, an input processor 705, a tokenizer 710, an embedding component 720, plug-ins/APIs 795, and a generative language model (LM) 730 (which may include an LLM, a VLM, a MMLM, a VLA model, etc.).

At a high level, the input processor 705 may receive an input 701 comprising text and/or other types of input data (e.g., audio data, video data, image data, sensor data (e.g., LiDAR, RADAR, ultrasonic, etc.), 3D design data, CAD data, universal scene descriptor (USD) data-such as OpenUSD, etc.), depending on the architecture of the generative LM 730 (e.g., LLM/VLM/MMLM/etc.). In some embodiments, the input 701 includes plain text in the form of one or more sentences, paragraphs, and/or documents. Additionally or alternatively, the input 701 may include numerical sequences, precomputed embeddings (e.g., word or sentence embeddings), and/or structured data (e.g., in tabular formats, JSON, or XML). In some implementations in which the generative LM 730 is capable of processing multi-modal inputs, the input 701 may combine text (or may omit text) with image data, audio data, video data, design data, USD data, and/or other types of input data, such as but not limited to those described herein. Taking raw input text as an example, the input processor 705 may prepare raw input text in various ways. For example, the input processor 705 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 705 may remove stopwords to reduce noise and focus the generative LM 730 on more meaningful content. The input processor 705 may apply text normalization (TN), for example, by converting all characters to lowercase, removing accents, and/or or handling special cases like contractions or abbreviations to ensure consistency (e.g., converting ¼ to one quarter). Similarly, the input processor 705 and/or a post-processor may perform inverse text normalization (ITN) in order to convert plain language back to canonical or other forms (e.g., to convert one quarter to ¼). These are just a few examples, and other types of input and/or output processing may be applied.

In some embodiments, a RAG component 792 (which may include one or more RAG models, and/or may be performed using the generative LM 730 itself) may be used to retrieve additional information to be used as part of the input 701 or prompt. RAG may be used to enhance the input to the LLM/VLM/MMLM/etc. with external knowledge, so that answers to specific questions or queries or requests are more relevant—such as in a case where specific knowledge is required. The RAG component 792 may fetch this additional information (e.g., grounding information, such as grounding text/image/video/audio/USD/CAD/etc.) from one or more external sources, which can then be fed to the LLM/VLM/MMLM/etc. along with the prompt to improve accuracy of the responses or outputs of the model.

For example, in some embodiments, the input 701 may be generated using the query or input to the model (e.g., a question, a request, etc.) in addition to data retrieved using the RAG component 792. In some embodiments, the input processor 705 may analyze the input 701 and communicate with the RAG component 792 (or the RAG component 792 may be part of the input processor 705, in embodiments) in order to identify relevant text and/or other data to provide to the generative LM 730 as additional context or sources of information from which to identify the response, answer, or output 790, generally. For example, where the input indicates that the user is interested in a desired tire pressure for a particular make and model of vehicle, the RAG component 792 may retrieve-using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 792 may retrieve a prior stored conversation history—or at least a summary thereof—and include the prior conversation history along with the current ask/request as part of the input 701 to the generative LM 730.

The RAG component 792 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 792 and the embeddings of the chunks along with the embeddings of the query may be compared to identify the most similar/related embeddings to the query, which may be supplied to the generative LM 730 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/VLM/MMLM/etc. Rather than (or in addition to) providing the model with chunks of data extracted from larger sized documents-which may result in a lack of context, factual correctness, language accuracy, etc.—graph RAG may also provide structured entity information to the LLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/VLM/MMLM/etc. may summarize the results. In such an example, the graph may store relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 792 may implement a plugin, API, user interface, and/or other functionality to perform RAG. For example, a graph RAG plug-in may be used by the LLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 710 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 730 to understand morphological variations and handle out-of-vocabulary words more effectively. Character-based tokenization represents each character as a separate token, enabling the generative LM 730 to process text at a fine-grained level. The choice of tokenization strategy may depend on factors such as the language being processed, the task at hand, and/or characteristics of the training dataset. As such, the tokenizer 710 may convert the (e.g., processed) text into a structured format according to tokenization schema being implemented in the particular embodiment.

The embedding component 720 may use any known embedding technique to transform discrete tokens into (e.g., dense, continuous vector) representations of semantic meaning. For example, the embedding component 720 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 701 includes image data/video data/etc., the input processor 701 may resize the data to a standard size compatible with format of a corresponding input channel and/or may normalize pixel values to a common range (e.g., 0 to 1) to ensure a consistent representation, and the embedding component 720 may encode the image data using any known technique (e.g., using one or more convolutional neural networks (CNNs) to extract visual features). In some implementations in which the input 701 includes audio data, the input processor 701 may resample an audio file to a consistent sampling rate for uniform processing, and the embedding component 720 may use any known technique to extract and encode audio features—such as in the form of a spectrogram (e.g., a mel-spectrogram). In some implementations in which the input 701 includes video data, the input processor 701 may extract frames or apply resizing to extracted frames, and the embedding component 720 may extract features such as optical flow embeddings or video embeddings and/or may encode temporal information or sequences of frames. In some implementations in which the input 701 includes multi-modal data, the embedding component 720 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 730 and/or other components of the generative LM system 700 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, linear-time sequence modeling with selective state space modeling (SSM) architectures (e.g., Mamba LLM architectures), and/or others. As such, depending on the implementation and architecture, the embedding component 720 may apply an encoded representation of the input 701 to the generative LM 730, and the generative LM 730 may process the encoded representation of the input 701 to generate an output 790, which may include responsive text and/or other types of data.

As described herein, in some embodiments, the generative LM 730 may be configured to access or use—or capable of accessing or using—plug-ins/APIs 795 (which may include one or more plug-ins, application programming interfaces (APIs), databases, data stores, repositories, etc.). For example, for certain tasks or operations that the generative LM 730 is not ideally suited for, the model may have instructions (e.g., as a result of training, and/or based on instructions in a given prompt, such as those retrieved using the RAG component 792) to access one or more plug-ins/APIs 795 (e.g., 3^{rd} party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 795 to the plug-in/API 795, the plug-in/API 795 may process the information and return an answer to the generative LM 730, and the generative LM 730 may use the response to generate the output 790. This process may be repeated e.g., recursively—for any number of iterations and using any number of plug-ins/APIs 795 until an output 790 that addresses each ask/question/request/process/operation/etc. from the input 701 can be generated. As such, the model(s) may not only rely on its own knowledge from training on a large dataset(s) and/or from data retrieved using the RAG component 792, but also on the expertise or optimized nature of one or more external resources—such as the plug-ins/APIs 795.

In some embodiments, one or more transformer engines (TEs) may be implemented. The transformer engine may use micro-tensor scaling to optimize performance and accuracy—such as to enable 16-bit floating point (FP16), 8-bit floating point (FP8), and/or 4-bit floating point (FP4) artificial intelligence processing. For example, the transformer engine may use 16-bit or 8-bit floating point precision and an 8-bit or 4-bit floating point data format combined with software algorithms for increasing AI performance and capabilities. By reducing math operations to 8-bits or 4-bits, the TE allows for training larger networks faster without compromising accuracy. For example, the TEs may include a library for accelerating transformer models on processing devices—such as GPUs—to provide better performance with lower memory utilization in both training and inference. When the TE is combined with other technologies, such as high-speed interconnects between nodes (e.g., using switches—such as NVLink Switches) and tensor cores (which enable mixed-precision computing, such as micro-scaling precision support), server clusters may be more capable of training enormous networks (e.g., billions of parameters) at high speeds. As such, tensor core precisions of FP64, TF32, BF16, FP16, FP8, INT8, FP6, and FP4 may be supported, as well as CUDA core precisions of FP64, FP32, FP16, and BF16.

These and other architectures for LLMs/VLMs/MMLMs/VLAs/etc. described herein are meant simply as examples, and other suitable architectures may be implemented within the scope of the present disclosure.

### Example Computing Device

FIG. 8 is a block diagram of an example computing device(s) 800 suitable for use in implementing some embodiments of the present disclosure. Computing device 800 may include an interconnect system 802 that directly or indirectly couples the following devices: memory 804, one or more central processing units (CPUs) 806, one or more graphics processing units (GPUs) 808, a communication interface 810, input/output (I/O) ports 812, input/output components 814, a power supply 816, one or more presentation components 818 (e.g., display(s), speaker(s), etc.), and one or more logic units 820. In at least one embodiment, the computing device(s) 800 may comprise one or more virtual machines (VMs), and/or any of the components thereof may comprise virtual components (e.g., virtual hardware components). For non-limiting examples, one or more of the GPUs 808 may comprise one or more vGPUs, one or more of the CPUs 806 may comprise one or more vCPUs, and/or one or more of the logic units 820 may comprise one or more virtual logic units. As such, a computing device(s) 800 may include discrete components (e.g., a full GPU dedicated to the computing device 800), virtual components (e.g., a portion of a GPU dedicated to the computing device 800), or a combination thereof.

Although the various blocks of FIG. 8 are shown as connected via the interconnect system 802 with lines, this is not intended to be limiting and is for clarity only. For example, in some embodiments, a presentation component 818, such as a display device, may be considered an I/O component 814 (e.g., if the display is a touch screen). As another example, the CPUs 806 and/or GPUs 808 may include memory (e.g., the memory 804 may be representative of a storage device in addition to the memory of the GPUs 808, the CPUs 806, and/or other components). As such, the computing device of FIG. 8 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 8.

The interconnect system 802 may represent one or more links or busses, such as an address bus, a data bus, a control bus, or a combination thereof. The interconnect system 802 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 806 may be directly connected to the memory 804. Further, the CPU 806 may be directly connected to the GPU 808. Where there is direct, or point-to-point connection between components, the interconnect system 802 may include a PCIe link to carry out the connection. In these examples, a PCI bus need not be included in the computing device 800.

The memory 804 may include any of a variety of computer-readable media. The computer-readable media may be any available media that may be accessed by the computing device 800. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 804 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 800. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 806 may be configured to execute at least some of the computer-readable instructions to control one or more components of the computing device 800 to perform one or more of the methods and/or processes described herein. The CPU(s) 806 may each include one or more cores (e.g., one, two, four, eight, twenty-eight, seventy-two, etc.) that are capable of handling a multitude of software threads simultaneously. The CPU(s) 806 may include any type of processor, and may include different types of processors depending on the type of computing device 800 implemented (e.g., processors with fewer cores for mobile devices and processors with more cores for servers). For example, depending on the type of computing device 800, the processor may be an Advanced RISC Machines (ARM) processor implemented using Reduced Instruction Set Computing (RISC) or an x86 processor implemented using Complex Instruction Set Computing (CISC). The computing device 800 may include one or more CPUs 806 in addition to one or more microprocessors or supplementary co-processors, such as math co-processors.

In addition to or alternatively from the CPU(s) 806, the GPU(s) 808 may be configured to execute at least some of the computer-readable instructions to control one or more components of the computing device 800 to perform one or more of the methods and/or processes described herein. One or more of the GPU(s) 808 may be an integrated GPU (e.g., with one or more of the CPU(s) 806 and/or one or more of the GPU(s) 808 may be a discrete GPU. In embodiments, one or more of the GPU(s) 808 may be a coprocessor of one or more of the CPU(s) 806. The GPU(s) 808 may be used by the computing device 800 to render graphics (e.g., 3D graphics) or perform general purpose computations. For example, the GPU(s) 808 may be used for General-Purpose computing on GPUs (GPGPU). The GPU(s) 808 may include hundreds or thousands of cores that are capable of handling hundreds or thousands of software threads simultaneously. The GPU(s) 808 may generate pixel data for output images in response to rendering commands (e.g., rendering commands from the CPU(s) 806 received via a host interface). The GPU(s) 808 may include graphics memory, such as display memory, for storing pixel data or any other suitable data, such as GPGPU data. The display memory may be included as part of the memory 804. The GPU(s) 808 may include two or more GPUs operating in parallel (e.g., via a link). The link may directly connect the GPUs (e.g., using NVLINK) or may connect the GPUs through a switch (e.g., using NVSwitch). When combined together, each GPU 808 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 806 and/or the GPU(s) 808, the logic unit(s) 820 may be configured to execute at least some of the computer-readable instructions to control one or more components of the computing device 800 to perform one or more of the methods and/or processes described herein. In embodiments, the CPU(s) 806, the GPU(s) 808, and/or the logic unit(s) 820 may discretely or jointly perform any combination of the methods, processes and/or portions thereof. One or more of the logic units 820 may be part of and/or integrated in one or more of the CPU(s) 806 and/or the GPU(s) 808 and/or one or more of the logic units 820 may be discrete components or otherwise external to the CPU(s) 806 and/or the GPU(s) 808. In embodiments, one or more of the logic units 820 may be a coprocessor of one or more of the CPU(s) 806 and/or one or more of the GPU(s) 808.

Examples of the logic unit(s) 820 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Deep Learning Accelerator Clusters (XNNs), Neural Processing Units (NPUs), Neural Network Accelerators (NNAs), Programmable Vision Accelerators (PVAs)—which may include one or more direct memory access (DMA) systems, one or more vision or vector processing units (VPUs), one or more pixel processing engines (PPEs)—e.g., including a 2D array of processing elements that each communicate north, south, cast, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 810 may include one or more receivers, transmitters, and/or transceivers that allow the computing device 800 to communicate with other computing devices via an electronic communication network, included wired and/or wireless communications. The communication interface 810 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 820 and/or communication interface 810 may include one or more data processing units (DPUs) to transmit data received over a network and/or through interconnect system 802 directly to (e.g., a memory of) one or more GPU(s) 808.

The I/O ports 812 may allow the computing device 800 to be logically coupled to other devices including the I/O components 814, the presentation component(s) 818, and/or other components, some of which may be built in to (e.g., integrated in) the computing device 800. Illustrative I/O components 814 include a microphone, mouse, keyboard, joystick, game pad, game controller, satellite dish, scanner, printer, wireless device, etc. The I/O components 814 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 800. The computing device 800 may be include depth cameras, such as stereoscopic camera systems, infrared camera systems, RGB camera systems, touchscreen technology, and combinations of these, for gesture detection and recognition. Additionally, the computing device 800 may include accelerometers or gyroscopes (e.g., as part of an inertia measurement unit (IMU)) that allow detection of motion. In some examples, the output of the accelerometers or gyroscopes may be used by the computing device 800 to render immersive augmented reality or virtual reality.

The power supply 816 may include a hard-wired power supply, a battery power supply, or a combination thereof. The power supply 816 may provide power to the computing device 800 to allow the components of the computing device 800 to operate.

The presentation component(s) 818 may include a display (e.g., a monitor, a touch screen, a television screen, a heads-up-display (HUD), other display types, or a combination thereof), speakers, and/or other presentation components. The presentation component(s) 818 may receive data from other components (e.g., the GPU(s) 808, the CPU(s) 806, DPUs, etc.), and output the data (e.g., as an image, video, sound, etc.).

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 800 of FIG. 8—e.g., each device may include similar components, features, and/or functionality of the computing device(s) 800. In addition, where backend devices (e.g., servers, NAS, etc.) are implemented, the backend devices may be included as part of a data center (such as, but not limited to, those described herein).

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 800 described herein with respect to FIG. 8. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a talking kiosk, a remote control, an appliance, a consumer electronic device, a workstation, an edge device, any combination of these delineated devices, or any other suitable device.

### Example Clauses

In some embodiments, a system may perform operations described with respect to the present disclosure. In some embodiments, the system may include one or more processors to perform operations, where the operations may include generating a first tile image representing a first portion of a path surface based at least on aggregated path surface data representing a top-down view of the path surface, the aggregated path surface data obtained based at least on sensor data associated with the path surface. Further, the operations may include extracting one or more image features included in the first tile image, the one or more image features indicating one or more environmental features associated with the portion of the path surface. Additionally or alternatively, the operations may include generating a first Bird's Eye View (BEV) mask based at least on the one or more image features and a second mask generated based at least on a second tile image representing a second portion of the path surface that includes at least one of the one or more image features.

In some embodiments, the aggregated path surface data may include sensor data of the path surface that may be generated using sensors positioned to collect top-down data relative to the path surface. Additionally or alternatively, the aggregated path surface data comprises at least one of LIDAR intensity point-cloud data, LIDAR depth point-cloud data, or path surface color data.

In some embodiments, the one or more environmental features including one or more of lane markers, curbs, medians, guardrails, barriers, pedestrian crosswalks, stop lines, speed bumps, or parking spaces.

In some embodiments, the operations may additionally include sending the first BEV mask to a system configured to perform one or more operations based at least on the BEV mask representing the path surface.

In some embodiments, the operations may additionally include receiving a sequence of tile images representing portions of the path surface. For individual tile images of the sequence of tile images, the operations may include extracting one or more image features included in the individual tile image, determining one or more locations in the individual tile image of the one or more image features, and generating an updated BEV mask based on the one or more extracted image features and the one or more determined locations.

In some embodiments, the operations may additionally include generating vector representations of the one or more environmental features based on the BEV mask.

In some embodiments, the system that may perform the operations may include at least one of: a control system for an autonomous or semi-autonomous machine, a perception system for an autonomous or semi-autonomous machine, a system for performing one or more simulation operations, a system for performing one or more digital twin operations, a system for performing light transport simulation, a system for performing collaborative content creation for 3D assets, a system for performing one or more deep learning operations, a system implemented using an edge device, a system implemented using a robot, a system for performing one or more generative AI operations, a system for performing operations using one or more large language model (LLMs), a system for performing operations using one or more vision language models (VLMs), a system for performing operations using one or more multi-modal language models (MMLMs), a system for performing operations using one or more vision-language-action (VLA) models, a system for using or deploying one or more inference microservices, a system for performing one or more conversational AI operations, a system for generating synthetic data, a system for presenting at least one of virtual reality content, augmented reality content, or mixed reality content, a system incorporating one or more virtual machines (VMs), a system implemented at least partially in a data center, or a system implemented at least partially using cloud computing resources.

In some embodiments, a method may be performed in accordance with operations described and/or illustrated in the present disclosure. The method may include performing one or more navigation, localization, or control operations for maneuvering a machine based at least on one or more combined predicted locations of one or more environmental features corresponding to an area. In some embodiments, the one or more combined predicted locations being determined by generating a first tile image representing a first portion of a path surface based at least on aggregated path surface data representing a top-down view of the path surface, the aggregated path surface data obtained based at least on sensor data associated with the path surface. The combined prediction locations may additionally be determined by extracting one or more image features included in the first tile image, the one or more image features indicating one or more environmental features associated with the portion of the path surface. Further, by generating a first Bird's Eye View (BEV) mask based at least on the one or more image features and a second BEV mask generated based at least on a second tile image representing a second portion of a path surface that includes at least one of the one or more image features. In addition, the combined prediction locations may additionally include generating vector representations of the one or more environmental features based on the first BEV mask.

In some embodiments, the aggregated path surface data includes sensor data of the path surface generated using sensors positioned to collect top-down data relative to the path surface.

In some embodiments, the one or more environmental features including one or more of lane markers, curbs, medians, guardrails, barriers, pedestrian crosswalks, stop lines, speed bumps, or parking spaces.

In some embodiments, the aggregated path surface data may include at least one of LIDAR intensity point-cloud data, LIDAR depth point-cloud data, or path surface color data.

In some embodiments, the method may additionally include sending the mask to a system configured to perform one or more operations based at least on the BEV mask representing the path surface.

In some embodiments, the method may additionally include receiving a sequence of tile images representing portions of the path surface. In some embodiments, for individual tile images of the sequence of tile images, the method may include extracting one or more image features included in the individual tile image, determining one or more locations in the individual tile image of the one or more image features, and generating an updated BEV mask based on the one or more extracted image features and the one or more determined locations.

Additionally or alternatively, the method may include applying a transformer decoder to the extracted image features and determined locations to predict locations of environmental features in a bird's eye view representation.

In some embodiments, embodiments described in the present disclosure may include a processor including processing circuitry to perform operations. In some embodiments, the operations may include extracting one or more image features included in a first tile image representing a first portion of a path surface, the one or more image features indicating one or more environmental features associated with the portion of the path surface. Further, the operations may include generating a first Bird's Eye View (BEV) mask based at least on the one or more image features and a second BEV mask generated based at least on a second tile image representing a second portion of a path surface that includes at least one of the one or more image features.

In some embodiments, the aggregated path surface data includes sensor data of the path surface generated using sensors positioned to collect top-down data relative to the path surface.

Additionally or alternatively, in some embodiments, the one or more environmental features including one or more of lane markers, curbs, medians, guardrails, barriers, pedestrian crosswalks, stop lines, speed bumps, or parking spaces.

In some embodiments, the first tile image represents a first portion of a path surface based at least on aggregated path surface data representing a top-down view of the path surface, wherein the aggregated path surface data includes at least one of LIDAR intensity point-cloud data, LIDAR depth point-cloud data, or path surface color data.

In some embodiments, the operations being performed by the processor may additionally include sending the mask to a system configured to perform one or more operations based at least on the BEV mask representing the path surface.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A system comprising:
one or more processors to perform operations comprising:
generating a first tile image representing a first portion of a path surface based at least on aggregated path surface data representing a top-down view of the path surface, the aggregated path surface data obtained based at least on sensor data associated with the path surface;
extracting one or more image features included in the first tile image, the one or more image features indicating one or more environmental features associated with the first portion of the path surface; and
generating a first Bird's Eye View (BEV) mask based at least on the one or more image features and a second BEV mask generated based at least on a second tile image representing a second portion of the path surface that includes at least one of the one or more image features.

2. The system of claim 1, wherein the aggregated path surface data includes sensor data of the path surface generated using sensors positioned to collect top-down data relative to the path surface.

3. The system of claim 1, wherein the one or more environmental features including one or more of lane markers, curbs, medians, guardrails, barriers, pedestrian crosswalks, stop lines, speed bumps, or parking spaces.

4. The system of claim 1, wherein the aggregated path surface data comprises at least one of LIDAR intensity point-cloud data, LIDAR depth point-cloud data, or path surface color data.

5. The system of claim 1, the operations further comprising:
sending the first BEV mask to a system configured to perform one or more operations based at least on the BEV mask representing the path surface.

6. The system of claim 1, the operations further comprising:
receiving a sequence of tile images representing portions of the path surface; and
for individual tile images of the sequence of tile images:
extracting one or more image features included in the individual tile image;
determining one or more locations in the individual tile image of the one or more image features; and
generating an updated BEV mask based at least on the one or more extracted image features and the one or more determined locations.

7. The system of claim 1, wherein the operations further comprise:
generating vector representations of the one or more environmental features based at least on the BEV mask.

8. The system of claim 1, wherein the system is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing one or more light transport simulation;
a system for performing collaborative content creation for 3D assets;
a system for performing one or more wireless cellular transmissions using a wireless cellular network;
a system that provides one or more cloud gaming applications;
a system for performing one or more deep learning operations;
a system implemented using an edge device;
a system implemented using a robot;
a system for performing one or more generative AI operations;
a system for performing one or more conversational AI operations;
a system for performing operations using one or more large language models (LLMs);
a system for performing operations using one or more vision language models (VLMs);
a system for performing operations using one or more multi-modal language models (MMLMs);
a system for performing operations using one or more vision-language-action (VLA) models;
a system for performing one or more conversational AI operations;
a system for performing one or more synthetic data generation operations;
a system for presenting at least one of virtual reality content, augmented reality content, or mixed reality content;
systems using or deploying one or more inference microservices;
systems that incorporate deploy one or more machine learning models in a service or microservice along with an OS-level virtualization package (e.g., a container);
a system incorporating one or more virtual machines (VMs);
a system implemented at least partially in a data center; or
a system implemented at least partially using cloud computing resources.

9. A method comprising:
performing one or more navigation, localization, or control operations for maneuvering a machine based at least on one or more combined predicted locations of one or more environmental features corresponding to an area, the one or more combined predicted locations being determined at least by:
generating a first tile image representing a first portion of a path surface based at least on aggregated path surface data representing a top-down view of the path surface, the aggregated path surface data obtained based at least on sensor data associated with the path surface;
extracting one or more image features included in the first tile image, the one or more image features indicating one or more environmental features associated with the first portion of the path surface;
generating a first Bird's Eye View (BEV) mask based at least on the one or more image features and a second BEV mask generated based at least on a second tile image representing a second portion of a path surface that includes at least one of the one or more image features; and
generating vector representations of the one or more environmental features based at least on the first BEV mask.

10. The method of claim 9, wherein the aggregated path surface data includes sensor data of the path surface generated using sensors positioned to collect top-down data relative to the path surface.

11. The method of claim 9, wherein the one or more environmental features including one or more of lane markers, curbs, medians, guardrails, barriers, pedestrian crosswalks, stop lines, speed bumps, or parking spaces.

12. The method of claim 9, wherein the aggregated path surface data comprises at least one of LIDAR intensity point-cloud data, LIDAR depth point-cloud data, or path surface color data.

13. The method of claim 9, further comprising:
sending the mask to a system configured to perform one or more operations based at least on the BEV mask representing the path surface.

14. The method of claim 9, further comprising:
receiving a sequence of tile images representing portions of the path surface; and
for individual tile images of the sequence of tile images:
extracting one or more image features included in the individual tile image;
determining one or more locations in the individual tile image of the one or more image features; and
generating an updated BEV mask based at least on the one or more extracted image features and the one or more determined locations.

15. The method of claim 9, wherein generating the BEV mask comprises:
applying a transformer decoder to the extracted image features and determined locations to predict locations of environmental features in a bird's eye view representation.

16. A processor comprising processing circuitry to perform operations, the operations comprising:
extracting one or more image features included in a first tile image representing a first portion of a path surface, the one or more image features indicating one or more environmental features associated with the first portion of the path surface; and
generating a first mask based at least on the one or more image features and a second mask generated based at least on a second tile image representing a second portion of a path surface that includes at least one of the one or more image features.

17. The processor of claim 16, wherein the aggregated path surface data includes sensor data of the path surface generated using sensors positioned to collect top-down data relative to the path surface.

18. The processor of claim 16, wherein the one or more environmental features including one or more of lane markers, curbs, medians, guardrails, barriers, pedestrian crosswalks, stop lines, speed bumps, or parking spaces.

19. The processor of claim 16, wherein the first tile image represents a first portion of a path surface based at least on aggregated path surface data representing a top-down view of the path surface, wherein the aggregated path surface data includes at least one of LIDAR intensity point-cloud data, LIDAR depth point-cloud data, or path surface color data.

20. The processor of claim 16, the operations further comprising:
sending the mask to a system configured to perform one or more operations based at least on the mask representing the path surface.
